(19) United States
(12) Patent Application Publication
(10) Pub. No.: US 2026/0086276 A1
(43) Pub. Date: Mar. 26, 2026

(54) OPTICAL FILM, POLARIZING PLATE, AND IMAGE DISPLAY DEVICE

(71) Applicant: FUJIFILM Corporation, Tokyo (JP)

(72) Inventor: Hio SAKAI, Minamiashigara-shi (JP)

(73) Assignee: FUJIFILM Corporation, Tokyo (JP)

(21) Appl. No.: 19/408,416

(22) Filed: Dec. 4, 2025

Related U.S. Application Data
(63) Continuation of application No. PCT/JP2024/019362, filed on May 27, 2024.

(30) Foreign Application Priority Data
Jun. 29, 2023 (JP) 2023-107177

(51) Int. Cl. G02B 5/30; C09D 133/26; C09K 19/04; C09K 19/38

(52) U.S. Cl. CPC G02B 5/3016; C09D 133/26; C09K 19/3861; C09K 2019/0448; C09K 2219/03

(57) ABSTRACT

An object of the present invention is to provide an optical film, a polarizing plate, and an image display device, in which a liquid crystal cured layer has excellent aligning properties and adhesiveness between a substrate and an alignment film is favorable. The optical film of the present invention includes a substrate, an alignment film provided on the substrate, and a liquid crystal cured layer provided on the alignment film, in which the alignment film is a photo-alignment film formed of a composition for forming an alignment film, which contains a polymer (I) having a photo-aligned group and two or more different polymerizable groups, a mixed region containing a component derived from the polymer (I) is provided in a surface layer region of the substrate on an alignment film side, and a thickness of the mixed region is more than 100 nm and less than 500 nm.

### CROSS-REFERENCE TO RELATED APPLICATIONS

This application is a Continuation of PCT International Application No. PCT/JP2024/019362 filed on May 27, 2024, which claims priority under 35 U.S.C. § 119(a) to Japanese Patent Application No. 2023-107177 filed on Jun. 29, 2023. The above applications are hereby expressly incorporated by reference, in their entirety, into the present application.

### BACKGROUND OF THE INVENTION

### 1. Field of the Invention

The present invention relates to an optical film, a polarizing plate, and an image display device.

### 2. Description of the Related Art

Optical films such as an optical compensation sheet and a retardation film have been used in various image display devices in order to eliminate image coloration or expand a viewing angle.

A stretched birefringent film has been used as the optical film, but in recent years, it has been proposed to use an optical film having a liquid crystal cured layer instead of the stretched birefringent film.

It has been known that such a liquid crystal cured layer is provided on an alignment film for aligning a liquid crystal compound, and as the alignment film, a photo-alignment film subjected to a photo-alignment treatment instead of a rubbing treatment has been known.

For example, WO2019/225632A discloses a polymer (photo-alignment copolymer) having a repeating unit including a cinnamate group as a photo-aligned group and a repeating unit including a crosslinkable group (for example, an epoxy group, an epoxycyclohexyl group, an oxetanyl group, or a functional group having an ethylenically unsaturated double bond), used as a component forming a photo-alignment film ([claim 1] and [claim 2]), and discloses an optical film including a substrate, a photo-alignment film, and a liquid crystal cured layer in Examples ([0113]).

### SUMMARY OF THE INVENTION

The present inventors have examined the optical film disclosed in WO2019/225632A, and as a result, it has been clarified that aligning properties of the liquid crystal cured layer are favorable, but there is room for improvement in adhesiveness between the substrate and the alignment film.

Therefore, an object of the present invention is to provide an optical film, a polarizing plate, and an image display device, in which a liquid crystal cured layer has excellent aligning properties and adhesiveness between a substrate and an alignment film is favorable.

As a result of intensive studies to achieve the above-described object, the present inventors have found that, in an optical film including a substrate, an alignment film provided on the substrate, and a liquid crystal cured layer provided on the alignment film, by using, as the alignment film, a photo-alignment film formed of a composition for forming an alignment film, which contains a polymer (I) having a photo-aligned group and two or more different polymerizable groups and by providing a mixed region containing a component derived from the polymer (I) in a surface layer region of the substrate on an alignment film side with a predetermined thickness, the liquid crystal cured layer has excellent aligning properties and the adhesiveness between the substrate and the alignment film is favorable, and thus have completed the present invention.

That is, the present inventors have found that the above-described object can be achieved by employing the following configurations.

[1] An optical film comprising:
a substrate;
an alignment film provided on the substrate; and
a liquid crystal cured layer provided on the alignment film,
in which the alignment film is a photo-alignment film formed of a composition for forming an alignment film, which contains a polymer (I) having a photo-aligned group and two or more different polymerizable groups,
a mixed region containing a component derived from the polymer (I) is provided in a surface layer region of the substrate on an alignment film side, and
a thickness of the mixed region is more than 100 nm and less than 500 nm.

[2] The optical film according to [1],
in which the polymer (I) is a copolymer having a repeating unit A represented by Formula (A) described later, a repeating unit B represented by Formula (B) described later, and a repeating unit C represented by Formula (C) described later.

[3] The optical film according to [2],
in which each of a content a of the repeating unit A, a content b of the repeating unit B, and a content c of the repeating unit C with respect to a total mass of the polymer (I), in terms of % by mass, satisfies 5≤a≤30, 20≤b≤45, and 50≤c≤75.

[4] The optical film according to any one of [1] to [3],
in which a content of the polymer (I) is 5% to 30% by mass with respect to a total mass of solid contents of the composition for forming an alignment film.

[5] The optical film according to any one of [1] to [4],
in which the composition for forming an alignment film further contains a polymer (II) which is a polymer other than the polymer (I) and has a repeating unit B represented by Formula (B) described later.

[6] The optical film according to [5],
in which, in a case where, with regard to Hansen solubility parameters in the polymer (I), a dispersion-force term is denoted by δD(I), a polarity term is denoted by δP(I), and a hydrogen-bonding term is denoted by δH(I), and with regard to Hansen solubility parameters in the polymer (II), a dispersion-force term is denoted by δD(II), a polarity term is denoted by δP(II), and a hydrogen-bonding term is denoted by δH(II), Expression (α) described later is satisfied.

[7] The optical film according to [5] or [6],
in which a content of the polymer (I) is 5% to 30% by mass with respect to a total mass of the polymer (I) and the polymer (II).

[8] The optical film according to any one of [1] to [7],
in which the liquid crystal cured layer is a layer obtained by fixing a liquid crystalline state of a smectic phase.

[9] The optical film according to any one of [1] to [8],
in which the thickness of the mixed region is more than 130 nm and less than 200 nm.

The optical film according to any one of [1] to [9],
in which the liquid crystal cured layer is a liquid crystal cured layer obtained by fixing an alignment state of a liquid crystal composition containing a liquid crystal compound,
the liquid crystal compound is a rod-like liquid crystal compound, and
a difference Δn in refractive index between a major axis direction and a minor axis direction of the rod-like liquid crystal compound satisfies Expression (β) described later.

[11] The optical film according to any one of [1] to [10],
in which the liquid crystal cured layer is a liquid crystal cured layer obtained by fixing an alignment state of a liquid crystal composition containing a liquid crystal compound, and
the liquid crystal compound is a compound represented by Formula (III) described later.

[12] The optical film according to [11],
in which Ar in Formula (III) described later represents any aromatic ring selected from the group consisting of groups represented by Formulae (Ar-1) to (Ar-5) described later.

[13] The optical film according to any one of [1] to [12],
in which a thickness-direction retardation of the substrate at a wavelength of 550 nm is more than −10 nm and less than 10 nm.

[14] A polarizing plate comprising:
the optical film according to any one of [1] to [13]; and
a polarizer.

[15] An image display device comprising:
the optical film according to any one of [1] to or the polarizing plate according to [14].

[16] The image display device according to [15],
in which the image display device is a liquid crystal display device.

[17] The image display device according to [15],
in which the image display device is an organic EL display device.

According to the present invention, it is possible to provide an optical film, a polarizing plate, and an image display device, in which a liquid crystal cured layer has excellent aligning properties and adhesiveness between a substrate and an alignment film is favorable.

### BRIEF DESCRIPTION OF THE DRAWINGS

FIG. 1 is a schematic cross-sectional view showing an example of the optical film according to the embodiment of the present invention.

FIG. 2 is a schematic view for describing a depth-direction profile of a component of an alignment film, detected by analyzing a component of a mixed region of a substrate in a depth direction by time-of-flight secondary ion mass spectrometry (TOF-SIMS).

### DESCRIPTION OF THE PREFERRED EMBODIMENTS

Hereinafter, the present invention will be described in detail.

The description of configuration requirements described below may be made based on typical embodiments of the present invention, but the present invention is not limited to such embodiments.

Any numerical range expressed using “to” in the present specification refers to a range including the numerical values before and after the “to” as a lower limit value and an upper limit value, respectively.

In addition, in a range of numerical values described in stages in the present specification, the upper limit value or the lower limit value described in a certain range of numerical values may be replaced with an upper limit value or a lower limit value of the range of numerical values described in other stages. In addition, regarding the numerical range described in the present specification, an upper limit value or a lower limit value described in a numerical value may be replaced with a value described in Examples.

In addition, in the present specification, substances corresponding to respective components may be used alone or in combination of two or more kinds thereof. Here, in a case where two or more kinds of substances are used in combination for each component, the content of the component indicates the total content of the substances used in combination, unless otherwise specified.

In addition, in the present specification, “(meth)acrylate” denotes “acrylate” or “methacrylate”, “(meth)acryl” denotes “acryl” or “methacryl”, and “(meth)acryloyl” denotes “acryloyl” or “methacryloyl”.

In addition, in the present specification, a bonding direction of a divalent group (for example, —O—CO—) described is not particularly limited, and for example, in a case where L² in an “L¹-L²-L³” bond is —O—CO—, and a bonding position on the L¹ side is represented by *1 and a bonding position on the L³ side is represented by *2, L² may be *1-O—CO-*2 or *1-CO—O—*2.

In addition, in the present specification, Re(λ) and Rth(λ) respectively represent an in-plane retardation at a wavelength λ and a thickness-direction retardation at a wavelength 2. Unless otherwise specified, the wavelength λ refers to 550 nm.

In the present invention, Re(λ) and Rth(λ) are values measured at the wavelength of λ in AxoScan (manufactured by Axometrics, Inc.). By inputting an average refractive index ((nx+ny+nz)/3) and a film thickness (d (μm)) in AxoScan,
a slow axis direction (°),

$$R e ( λ ) = R 0 ( λ ) , and Rth ( λ ) = ( ( n x + ny ) / 2 - nz ) \times d$$

are calculated.

Although R0(λ) is displayed as a numerical value calculated by AxoScan, it means Re(λ).

In addition, in the present specification, examples of a substituent (monovalent substituent) include substituents described in the following substituent group A.

In the present specification, “may have a substituent” includes not only an aspect of not having a substituent but also an aspect of having one or more substituents.

### <Substituent Group A>

Examples of the substituent include:
a halogen atom (for example, a fluorine atom, a chlorine atom, or a bromine atom, preferably a chlorine atom or a fluorine atom, and more preferably a fluorine atom);
an alkyl group (a linear, branched, or cyclic alkyl group having preferably 1 to 48 carbon atoms, more preferably 1 to 24 carbon atoms, and particularly preferably 1 to 8 carbon atoms, such as a linear alkyl group having 1 to 6 carbon atoms (for example, a methyl group, an ethyl group, a n-propyl group, a n-butyl group, a n-pentyl group, and a n-hexyl group), a branched alkyl group having 3 to 6 carbon atoms (for example, an isopropyl group, an isobutyl group, a tert-butyl group, a sec-butyl group, a neopentyl group, an isohexyl group, and a 3-methylpentyl group), and a cyclic alkyl group having 3 to 12 carbon atoms (for example, a cyclopropyl group, a cyclopentyl group, a cyclohexyl group, a 1-norbornyl group, and a 1-adamantyl group));
an alkenyl group (an alkenyl group having preferably 2 to 48 carbon atoms and more preferably 2 to 18 carbon atoms, such as a vinyl group, an allyl group, a 1-butenyl group, and a 2-butenyl group);
an alkynyl group (an alkynyl group having preferably 2 to 6 carbon atoms and more preferably 2 to 4 carbon atoms, such as an ethynyl group, a 1-propynyl group, a propargyl group, a 1-butynyl group, and a 2-butynyl group);
an aryl group (an aryl group having preferably 6 to 48 carbon atoms and more preferably 6 to 24 carbon atoms, such as a phenyl group, an oligoaryl group (a naphthyl group or an anthryl group), a phenanthrenyl group, a fluorenyl group, a pyrenyl group, a triphenylenyl group, and a biphenyl group);
a heteroaryl group (a heterocyclic group having preferably 1 to 32 carbon atoms and more preferably 1 to 18 carbon atoms, such as a 2-thienyl group, a 4-pyridyl group, a 2-furyl group, a 2-pyrimidinyl group, a 1-pyridyl group, a 2-benzothiazolyl group, a 1-imidazolyl group, a 1-pyrazolyl group, and a benzotriazol-1-yl group);
an arylalkyl group (an arylalkyl group having preferably 7 to 15 carbon atoms, such as a benzyl group, a phenethyl group, a methylbenzyl group, a phenylpropyl group, a 1-methylphenylethyl group, a phenylbutyl group, a 2-methylphenylpropyl group, a tetrahydronaphthyl group, a naphthylmethyl group, a naphthylethyl group, an indenyl group, a fluorenyl group, an anthracenylmethyl group (an anthrylmethyl group), and a phenanthrenylmethyl group (a phenanthrylmethyl group));
a silyl group (a silyl group having preferably 3 to 38 carbon atoms and more preferably 3 to 18 carbon atoms, such as a trimethylsilyl group, a triethylsilyl group, a tributylsilyl group, a t-butyldimethylsilyl group, and a t-hexyldimethylsilyl group);
a hydroxy group; a cyano group; a nitro group; a morpholino group;
an alkoxy group (an alkoxy group having preferably 1 to 48 carbon atoms and more preferably 1 to 24 carbon atoms, such as a methoxy group, an ethoxy group, a 1-butoxy group, a 2-butoxy group, an isopropoxy group, a t-butoxy group, a dodecyloxy group, and a cycloalkyloxy group (for example, a cyclopentyloxy group or a cyclohexyloxy group));
an aryloxy group (an aryloxy group having preferably 6 to 48 carbon atoms and more preferably 6 to 24 carbon atoms, such as a phenoxy group and a 1-naphthoxy group);
an alkenyloxy group (an alkenyloxy group having preferably 2 to 6 carbon atoms, such as a vinyloxy group, a 1-propenyloxy group, a 2-n-propenyloxy group (an allyloxy group), a 1-n-butenyloxy group, and a prenyloxy group);
a heterocyclic oxy group (a heterocyclic oxy group having preferably 1 to 32 carbon atoms and more preferably 1 to 18 carbon atoms, such as a 1-phenyltetrazol-5-yloxy group and a 2-tetrahydropyranyloxy group);
a silyloxy group (a silyloxy group having preferably 1 to 32 carbon atoms and more preferably 1 to 18 carbon atoms, such as a trimethylsilyloxy group, a t-butyldimethylsilyloxy group, and a diphenylmethylsilyloxy group);
an acyloxy group (an acyloxy group having preferably 2 to 48 carbon atoms and more preferably 2 to 24 carbon atoms, such as an acetoxy group, a pivaloyloxy group, a benzoyloxy group, a dodecanoyloxy group, an acryloyloxy group, and a methacryloyloxy group);
a hydroxyalkyleneoxy group (a hydroxyalkyleneoxy group having preferably 2 to 10 carbon atoms, such as a hydroxyethyleneoxy group);
an alkoxycarbonyloxy group (an alkoxycarbonyloxy group having preferably 2 to 48 carbon atoms and more preferably 2 to 24 carbon atoms, such as an ethoxycarbonyloxy group, a t-butoxycarbonyloxy group, and a cycloalkyloxycarbonyloxy group (for example, a cyclohexyloxycarbonyloxy group));
an aryloxycarbonyloxy group (an aryloxycarbonyloxy group having preferably 7 to 32 carbon atoms and more preferably 7 to 24 carbon atoms, such as a phenoxycarbonyloxy group);
a carbamoyloxy group (a carbamoyloxy group having preferably 1 to 48 carbon atoms and more preferably 1 to 24 carbon atoms, such as an N,N-dimethylcarbamoyloxy group, an N-butylcarbamoyloxy group, an N-phenylcarbamoyloxy group, and an N-ethyl-N-phenylcarbamoyloxy group);
a sulfamoyloxy group (a sulfamoyloxy group having preferably 1 to 32 carbon atoms and more preferably 1 to 24 carbon atoms, such as an N,N-diethylsulfamoyloxy group and an N-propylsulfamoyloxy group);
an alkylsulfonyloxy group (an alkylsulfonyloxy group having preferably 1 to 38 carbon atoms and more preferably 1 to 24 carbon atoms, such as a methylsulfonyloxy group, a hexadecylsulfonyloxy group, and a cyclohexylsulfonyloxy group);
an arylsulfonyloxy group (an arylsulfonyloxy group having preferably 6 to 32 carbon atoms and more preferably 6 to 24 carbon atoms, such as a phenylsulfonyloxy group);
an acyl group (an acyl group having preferably 1 to 48 carbon atoms and more preferably 1 to 24 carbon atoms, such as a formyl group, an acetyl group, an acryloyl group, a methacryloyl group, a pivaloyl group, a benzoyl group, a tetradecanoyl group, and a cyclohexanoyl group);
an alkoxycarbonyl group (an alkoxycarbonyl group having preferably 2 to 48 carbon atoms and more preferably 2 to 24 carbon atoms, such as a methoxycarbonyl group, an ethoxycarbonyl group, an octadecyloxycarbonyl group, a cyclohexyloxycarbonyl group, and a 2,6-di-tert-butyl-4-methylcyclohexyloxycarbonyl group);
an aryloxycarbonyl group (an aryloxycarbonyl group having preferably 7 to 32 carbon atoms and more preferably 7 to 24 carbon atoms, such as a phenoxycarbonyl group);
a carbamoyl group (a carbamoyl group having preferably 1 to 48 carbon atoms and more preferably 1 to 24 carbon atoms, such as a carbamoyl group, an N,N-diethylcarbamoyl group, an N-ethyl-N-octylcarbamoyl group, an N,N-dibutylcarbamoyl group, an N-propylcarbamoyl group, an N-phenylcarbamoyl group, an N-methyl-N-phenylcarbamoyl group, and an N,N-dicyclohexylcarbamoyl group);
an amino group (an amino group having preferably 32 or less carbon atoms and more preferably 24 or less carbon atoms, such as an amino group, a methylamino group, an N,N-dimethylamino group, an N,N-dibutylamino group, a tetradecylamino group, a 2-ethylhexylamino group, and a cyclohexylamino group);
an anilino group (an anilino group having preferably 6 to 32 carbon atoms and more preferably 6 to 24 carbon atoms, such as an anilino group and an N-methylanilino group);
a heterocyclic amino group (a heterocyclic amino group having preferably 1 to 32 carbon atoms and more preferably 1 to 18 carbon atoms, such as a 4-pyridylamino group);
a carboxamide group (a carboxamide group having preferably 2 to 48 carbon atoms and more preferably 2 to 24 carbon atoms, such as an acetamide group, a benzamide group, a tetradecaneamide group, a pivaloylamide group, and a cyclohexaneamide group);
a ureido group (a ureido group having preferably 1 to 32 carbon atoms and more preferably 1 to 24 carbon atoms, such as a ureido group, an N,N-dimethylureido group, and an N-phenylureido group);
an imide group (an imide group having preferably 36 or less carbon atoms and more preferably 24 or less carbon atoms, such as an N-succinimide group and an N-phthalimide group);
an alkoxycarbonylamino group (an alkoxycarbonylamino group having preferably 2 to 48 carbon atoms and more preferably 2 to 24 carbon atoms, such as a methoxycarbonylamino group, an ethoxycarbonylamino group, a t-butoxycarbonylamino group, an octadecyloxycarbonylamino group, and a cyclohexyloxycarbonylamino group);
an aryloxycarbonylamino group (an aryloxycarbonylamino group having preferably 7 to 32 carbon atoms and more preferably 7 to 24 carbon atoms, such as a phenoxycarbonylamino group);
a sulfonamide group (a sulfonamide group having preferably 1 to 48 carbon atoms and more preferably 1 to 24 carbon atoms, such as a methanesulfonamide group, a butanesulfonamide group, a benzenesulfonamide group, a hexadecanesulfonamide group, and a cyclohexanesulfonamide group);
a sulfamoylamino group (a sulfamoylamino group having preferably 1 to 48 carbon atoms and more preferably 1 to 24 carbon atoms, such as an N,N-dipropylsulfamoylamino group and an N-ethyl-N-dodecylsulfamoylamino group);
an azo group (an azo group having preferably 1 to 32 carbon atoms and more preferably 1 to 24 carbon atoms, such as a phenylazo group and a 3-pyrazolylazo group);
an alkylthio group (an alkylthio group having preferably 1 to 48 carbon atoms and more preferably 1 to 24 carbon atoms, such as a methylthio group, an ethylthio group, an octylthio group, and a cyclohexylthio group);
an arylthio group (an arylthio group having preferably 6 to 48 carbon atoms and more preferably 6 to 24 carbon atoms, such as a phenylthio group);
a heterocyclic thio group (a heterocyclic thio group having preferably 1 to 32 carbon atoms and more preferably 1 to 18 carbon atoms, such as a 2-benzothiazolylthio group, a 2-pyridylthio group, and a 1-phenyltetrazolylthio group);
an alkylsulfinyl group (an alkylsulfinyl group having preferably 1 to 32 carbon atoms and more preferably 1 to 24 carbon atoms, such as a dodecanesulfinyl group);
an arylsulfinyl group (an arylsulfinyl group having preferably 6 to 32 carbon atoms and more preferably 6 to 24 carbon atoms, such as a phenylsulfinyl group);
an alkylsulfonyl group (an alkylsulfonyl group having preferably 1 to 48 carbon atoms and more preferably 1 to 24 carbon atoms, such as a methylsulfonyl group, an ethylsulfonyl group, a propylsulfonyl group, a butylsulfonyl group, an isopropylsulfonyl group, a 2-ethylhexylsulfonyl group, a hexadecylsulfonyl group, an octylsulfonyl group, and a cyclohexylsulfonyl group);
an arylsulfonyl group (an arylsulfonyl group having preferably 6 to 48 carbon atoms and more preferably 6 to 24 carbon atoms, such as a phenylsulfonyl group and a 1-naphthylsulfonyl group);
a sulfamoyl group (a sulfamoyl group having preferably 32 or less carbon atoms and more preferably 24 or less carbon atoms, such as a sulfamoyl group, an N, N-dipropylsulfamoyl group, an N-ethyl-N-dodecylsulfamoyl group, an N-ethyl-N-phenylsulfamoyl group, an N-cyclohexylsulfamoyl group, and an N-(2-ethylhexyl) sulfamoyl group);
a phosphonyl group (a phosphonyl group having preferably 1 to 32 carbon atoms and more preferably 1 to 24 carbon atoms, such as a phenoxyphosphonyl group, an octyloxyphosphonyl group, and a phenylphosphonyl group);
a phosphinoylamino group (a phosphinoylamino group having preferably 1 to 32 carbon atoms and more preferably 1 to 24 carbon atoms, such as a diethoxyphosphinoylamino group and a dioctyloxyphosphinoylamino group);
an epoxy group; —NHCOCH₃; —SO₂NHC₂H₄OCH₃; and —NHSO₂CH₃,
in which two or more thereof may be combined.

These substituents may be further substituted with these substituents. In addition, in a case of having two or more of the substituents, the substituents may be the same or different from each other. Furthermore, if possible, these substituents may be bonded to each other to form a ring.

### [Optical Film]

The optical film according to the embodiment of the present invention includes a substrate, an alignment film provided on the substrate, and a liquid crystal cured layer provided on the alignment film.

In addition, in the optical film according to the embodiment of the present invention, the alignment film is a photo-alignment film formed of a composition for forming an alignment film, which contains a polymer (I) having a photo-aligned group and two or more different polymerizable groups.

In addition, in the optical film according to the embodiment of the present invention, a mixed region containing a component derived from the polymer (I) is provided in a surface layer region of the substrate on an alignment film side, and a thickness of the mixed region is more than 100 nm and less than 500 nm.

In the present invention, as described above, by using, as the alignment film, a photo-alignment film formed of a composition for forming an alignment film, which contains a polymer (I) having a photo-aligned group and two or more different polymerizable groups and providing a mixed region containing a component derived from the polymer (I) in a surface layer region of the substrate on an alignment film side with a predetermined thickness (more than 100 nm and less than 500 nm), the liquid crystal cured layer has excellent aligning properties and adhesiveness between the substrate and the alignment film is favorable.

The reason for this is not clear, but the present inventors presume as follows.

That is, it is considered that, by using the composition for forming an alignment film, which contains the polymer (I) having a photo-aligned group and two or more different polymerizable groups, the photo-alignment film to be formed is a high-hardness alignment film by a curing reaction of the plurality of kinds of polymerizable groups, and thus the excellent aligning properties of the liquid crystal cured layer can be maintained.

In addition, it is considered that, by providing the mixed region containing the component derived from the polymer (I) in the surface layer region of the substrate on the alignment film side with the predetermined thickness (more than 100 nm and less than 500 nm), an anchor effect is exhibited, and thus the adhesiveness between the substrate and the alignment film is favorable.

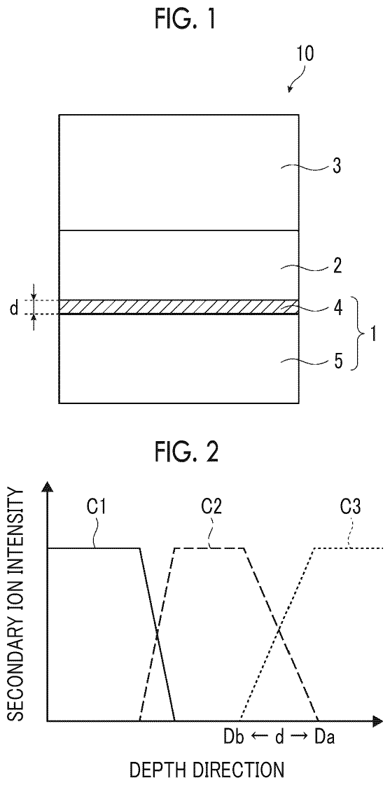

Next, a structure of the optical film according to the embodiment of the present invention will be described with reference to FIG. 1. FIG. 1 is a schematic cross-sectional view showing an example of the optical film.

An optical film 10 shown in FIG. 1 includes a substrate 1, an alignment film 2, and a liquid crystal cured layer 3 in this order.

Here, in the optical film 10, a mixed region 4 containing a component derived from the polymer (I) is provided in a surface layer region of the substrate 1 on an alignment film 2 side, and a thickness d of the mixed region 4 is more than 100 nm and less than 500 nm. A reference numeral 5 represents a substrate region of the substrate 1, which does not contain the component derived from the polymer (I).

In addition, the liquid crystal cured layer 3 may be a laminate of two or more different liquid crystal cured layers. For example, the optical film according to the embodiment of the present invention is used as an optical compensation film of an in-plane-switching (IPS) mode or fringe-field-switching (FFS) mode liquid crystal display device, it is preferable that the optical film is a laminate of a positive A-plate and a positive C-plate.

Hereinafter, various members used for the optical film will be described in detail.

### [Substrate]

The substrate included in the optical film according to the embodiment of the present invention is not particularly limited as long as the substrate has the mixed region containing a component derived from the polymer (I) in a surface layer region on the alignment film side.

As the substrate, a polymer film is preferable for a reason that the mixed region is easily formed.

Examples of a material of the polymer film include cellulose-based polymers; acrylic polymers having an acrylic acid ester polymer such as polymethyl methacrylate and a lactone ring-containing polymer; thermoplastic norbornene-based polymers; polycarbonate-based polymers; polyester-based polymers such as polyethylene terephthalate and polyethylene naphthalate; styrene-based polymers such as polystyrene and an acrylonitrile-styrene copolymer (AS resin); polyolefin-based polymers such as polyethylene, polypropylene, and an ethylene-propylene copolymer; vinyl chloride-based polymers; amide-based polymers such as nylon and aromatic polyamide; imide-based polymers; sulfone-based polymers; polyether sulfone-based polymers; polyether ether ketone-based polymers; polyphenylene sulfide-based polymers; vinylidene chloride-based polymers; vinyl alcohol-based polymers; vinyl butyral-based polymers; arylate-based polymers; polyoxymethylene-based polymers; epoxy-based polymers; and polymers obtained by mixing these polymers.

Among these, a cellulose-based polymer (hereinafter, also referred to as “cellulose acylate”) represented by triacetyl cellulose (TAC) can be preferably used.

In the present invention, from the reason that the aligning properties of the liquid crystal cured layer are more favorable, a thickness-direction retardation of the substrate at a wavelength of 550 nm is preferably more than −10 nm and less than 10 nm.

In addition, in the present invention, a thickness of the substrate (including the thickness of the mixed region) is not particularly limited, but is preferably 1 to 100 μm and more preferably 5 to 50 μm.

### <Mixed Region>

The substrate included in the optical film according to the embodiment of the present invention has a mixed region containing a component derived from the polymer (I) described later in a surface layer region on a side where the alignment film described later is provided.

Here, the mixed region can be formed by adjusting, for example, a type of the substrate, a type of a solvent of the composition for forming an alignment film, which will be described later, and a drying time of a coating film in a case of applying the composition for forming an alignment film described later to the substrate (that is, in a case of forming the alignment film).

Therefore, the “component derived from the polymer (I) described later” is formed by the polymer (I) contained in the composition for forming an alignment film described later permeating the surface layer region of the substrate on the alignment film side; but in a state of the optical film, that is, after the alignment film and the liquid crystal cured layer are formed, at least one of the polymerizable groups of the polymer (I) disappears, and thus the “component derived from the polymer (I) described later” corresponds to a polymer having a photo-aligned group and a residual polymerizable group.

A thickness of the mixed region is not particularly limited as long as it is more than 100 nm and less than 500 nm, but from the reason that the aligning properties of the liquid crystal cured layer are more favorable and the adhesiveness between the substrate and the alignment film is also more favorable, it is preferably more than 130 nm and less than 200 nm.

Here, the thickness of the mixed region corresponds to a depth region in which secondary ions of both components derived from the substrate and derived from the polymer (I) are observed in a case of performing depth analysis of the optical film by a TOF-SIMS method, and can be measured by a method described later.

In the present specification, the thickness of the mixed region means an average thickness of the mixed region, and the average thickness of the mixed region is measured at any five or more positions of the mixed region by the TOF-SIMS method and is obtained by performing an arithmetic average of measured thicknesses.

### <Method of Measuring Thickness of Mixed Region>

The thickness of the mixed region is measured by secondary ion mass spectrometry using TOF-SIMS V (manufactured by ION TOF GmbH) to analyze components of the optical film in a depth direction. In the present specification, the depth direction means a direction toward the substrate side with a surface of the optical film on the liquid crystal cured layer side as a reference.

Specifically, as shown in FIG. 2, a difference between a depth (Da) at which a secondary ion intensity derived from the polymer (I) disappears and a depth (Db) at which a secondary ion intensity derived from the substrate is generated is used for calculating a penetration thickness (d) of the mixed region. In FIG. 2, a reference numeral C1 represents a result of a secondary ion intensity derived from the liquid crystal cured layer, a reference numeral C2 represents a result of the secondary ion intensity derived from the polymer (I), and a reference numeral C3 represents a result of the secondary ion intensity derived from the substrate.

### [Alignment Film]

The alignment film included in the optical film according to the embodiment of the present invention is a photo-alignment film formed of a composition for forming an alignment film, which contains a polymer (I) having a photo-aligned group and two or more different polymerizable groups.

Hereinafter, components of the composition for forming an alignment film and a method of forming the alignment film will be described in detail.

### <Polymer (I)>

As described above, the polymer (I) contained in the composition for forming an alignment film is a polymer having a photo-aligned group and two or more different polymerizable groups.

Here, the photo-aligned group refers to a group having a photo-alignment function in which rearrangement or an anisotropic chemical reaction is induced by irradiation with light having anisotropy (for example, plane-polarized light), and from the viewpoint of excellent alignment uniformity and improved thermal stability and chemical stability, a photo-aligned group in which at least one of dimerization or isomerization is caused by an action of light is preferable.

In addition, the polymerizable group is not particularly limited, but is preferably a radically polymerizable group or a cationically polymerizable group.

In the present invention, from the reason that the photo-aligned group has favorable photo-reactivity and the two different polymerizable groups have favorable curing properties, it is preferable that the polymer (I) is a copolymer (hereinafter, also referred to as “copolymer according to the present invention” for convenience) having a repeating unit A represented by Formula (A) described later, a repeating unit B represented by Formula (B) described later, and a repeating unit C represented by Formula (C) described later.

### (Repeating Unit A)

The repeating unit A included in the copolymer according to the present invention is a repeating unit represented by Formula (A).

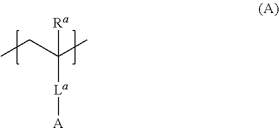

In Formula (A), R^{a} represents a hydrogen atom or a substituent.

In addition, L^{a} represents a divalent linking group.

In addition, A represents any one photo-aligned group selected from the group consisting of a polyene group, a stilbene group, a stilbazole group, a stilbazolium group, a chalcone group, a cinnamoyl group, an aromatic Schiff base, an aromatic hydrazone group, an azobenzene group, an azonaphthalene group, an aromatic heterocyclic azo group, a bisazo group, a formazan group, an azoxybenzene group, a coumarin group, and a maleimide group.

Next, the hydrogen atom or the substituent represented by R^{a} in Formula (A) will be described.

In Formula (A), examples of the substituent represented as one aspect of R^{a} include the substituents described in the above substituent group A; and among these, a halogen atom, a linear, branched, or cyclic alkyl group having 1 to 20 carbon atoms, a linear halogenated alkyl group having 1 to 20 carbon atoms, an alkoxy group having 1 to 20 carbon atoms, an aryl group having 6 to 20 carbon atoms, an aryloxy group having 6 to 20 carbon atoms, a cyano group, or an amino group is preferable.

Next, the divalent linking group represented by L^{a} in Formula (A) will be described.

From the reason that the photo-aligned group is easy to interact with a liquid crystal compound, and thus the aligning properties of the liquid crystal cured layer are further improved, the divalent linking group is preferably a divalent linking group formed by combining at least two or more groups selected from the group consisting of a linear, branched, or cyclic alkylene group having 1 to 18 carbon atoms, which may have a substituent, an arylene group having 6 to 12 carbon atoms, which may have a substituent, an ether group (—O—), a carbonyl group (—C(═O)—), and an imino group (—NH—) which may have a substituent.

Here, examples of the substituent which may be included in the alkylene group, the arylene group, and the imino group include the substituents described in the above substituent group A; and among these, examples thereof include a halogen atom, an alkyl group, an alkoxy group, an aryl group, an aryloxy group, a cyano group, a carboxy group, an alkoxycarbonyl group, and a hydroxyl group.

With regard to the linear, branched, or cyclic alkylene group having 1 to 18 carbon atoms, specific examples of the linear alkylene group include a methylene group, an ethylene group, a propylene group, a butylene group, a pentylene group, a hexylene group, a decylene group, an undecylene group, a dodecylene group, a tridecylene group, a tetradecylene group, a pentadecylene group, a hexadecylene group, a heptadecylene group, and an octadecylene group.

In addition, specific examples of the branched alkylene group include a dimethylmethylene group, a methylethylene group, a 2,2-dimethylpropylene group, and a 2-ethyl-2-methylpropylene group.

In addition, specific examples of the cyclic alkylene group include a cyclopropylene group, a cyclobutylene group, a cyclopentylene group, a cyclohexylene group, a cyclooctylene group, a cyclodecylene group, an adamantane-diyl group, a norbornane-diyl group, and an exo-tetrahydrodicyclopentadiene-diyl group. Among these, a cyclohexylene group is preferable.

Specific examples of the arylene group having 6 to 12 carbon atoms include a phenylene group, a xylylene group, a biphenylene group, a naphthylene group, and a 2,2′-methylenebisphenyl group; and among these, a phenylene group is preferable.

Next, the photo-aligned group represented by A in Formula (A) will be described.

The photo-aligned group is any one photo-aligned group selected from the group consisting of a polyene group, a stilbene group, a stilbazole group, a stilbazolium group, a chalcone group, a cinnamoyl group, an aromatic Schiff base, an aromatic hydrazone group, an azobenzene group, an azonaphthalene group, an aromatic heterocyclic azo group, a bisazo group, a formazan group, an azoxybenzene group, a coumarin group, and a maleimide group.

Among these photo-aligned groups, a cinnamoyl group is preferable, and specifically, a group represented by Formula (a1) is more preferable and a group represented by Formula (a2) is still more preferable.

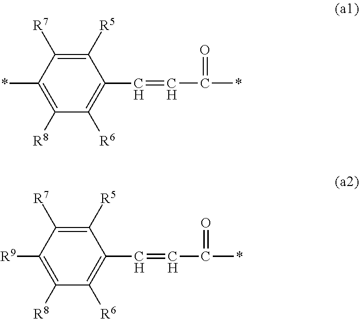

In Formula (a1), one of two *'s represents a bonding position to L^{a}, and the other represents a bonding position to a hydrogen atom or a substituent.

In addition, in Formula (a2), * represents a bonding position to L^{a}.

In addition, R⁵ to R⁸ in Formula (a1) and R⁵ to R⁹ in Formula (a2) each independently represent a hydrogen atom or a substituent, where two adjacent groups may be bonded to each other to form a ring.

Here, from the reason that the photo-aligned group is easy to interact with a liquid crystal compound, and thus the aligning properties of the liquid crystal cured layer are further improved, the substituents represented as one aspect of R⁵ to R⁹ each independently preferably represent a halogen atom, a linear, branched, or cyclic alkyl group having 1 to 20 carbon atoms, a linear halogenated alkyl group having 1 to 20 carbon atoms, an alkoxy group having 1 to 20 carbon atoms, an aryl group having 6 to 20 carbon atoms, an aryloxy group having 6 to 20 carbon atoms, a cyano group, an amino group, or a group represented by Formula (a3).

Furthermore, specific examples of the substituents other than the group represented by Formula (a3) include the same substituents as those described for the substituent represented by one aspect of R^{a} in Formula (A).

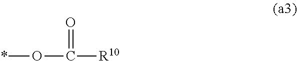

Here, in Formula (a3), * represents a bonding position to the benzene ring in Formula (a2), and R¹⁰ represents a monovalent organic group.

Examples of the monovalent organic group represented by R¹⁰ in Formula (a3) include a linear or cyclic alkyl group having 1 to 20 carbon atoms.

The linear alkyl group is preferably an alkyl group having 1 to 6 carbon atoms; and specific examples thereof include a methyl group, an ethyl group, and a n-propyl group, and among these, a methyl group or an ethyl group is preferable.

The cyclic alkyl group is preferably an alkyl group having 3 to 6 carbon atoms; and specific examples thereof include a cyclopropyl group, a cyclopentyl group, and a cyclohexyl group, and among these, a cyclohexyl group is preferable.

As the monovalent organic group represented by R¹⁰ in Formula (a3), a combination of a plurality of the above-described linear alkyl groups and a plurality of the above-described cyclic alkyl groups bonded directly or through a single bond may be used.

In the present invention, from the reason that the photo-aligned group is easy to interact with a liquid crystal compound, and thus the aligning properties of the liquid crystal cured layer are further improved, it is preferable that at least one of R⁵ to R⁸ in Formula (a1) or R⁵ to R⁹ in Formula (a2) (particularly, R⁹) is the above-described substituent; and from the reason that linearity of the copolymer to be obtained is improved and thus reaction efficiency is improved in a case of being irradiated with polarized light, it is more preferable that the substituent is an electron-donating substituent.

Here, the electron-donating substituent (electron-donating group) is a substituent having a Hammett constant (Hammett's substituent constant op) of 0 or less; and among the above-described substituents, an alkyl group, a halogenated alkyl group, and an alkoxy group are exemplified.

Among these, an alkoxy group is preferable, and from the viewpoint that the aligning properties of the liquid crystal cured layer are further improved, an alkoxy group having 6 to 16 carbon atoms is more preferable and an alkoxy group having 7 to 10 carbon atoms is still more preferable.

Specific examples of the repeating unit A represented by Formula (A) include the following repeating units A-1 to A-160. In the following formulae, Me represents a methyl group.

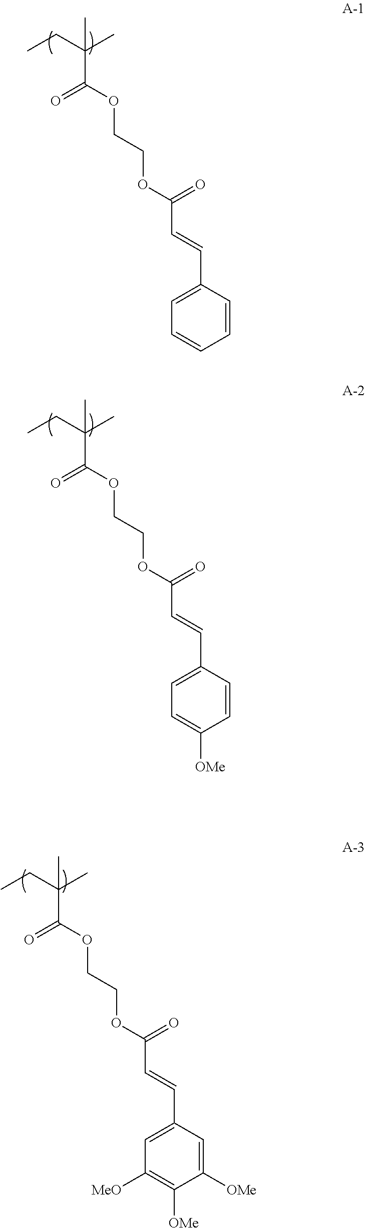

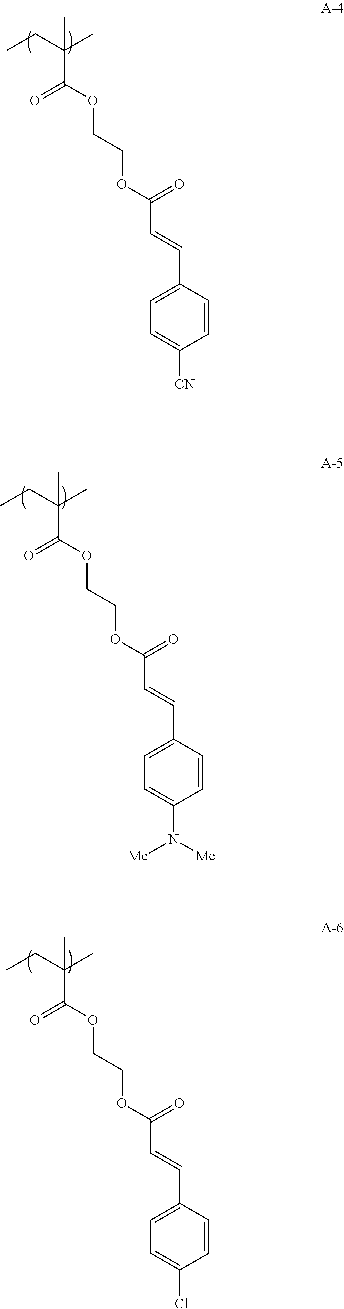

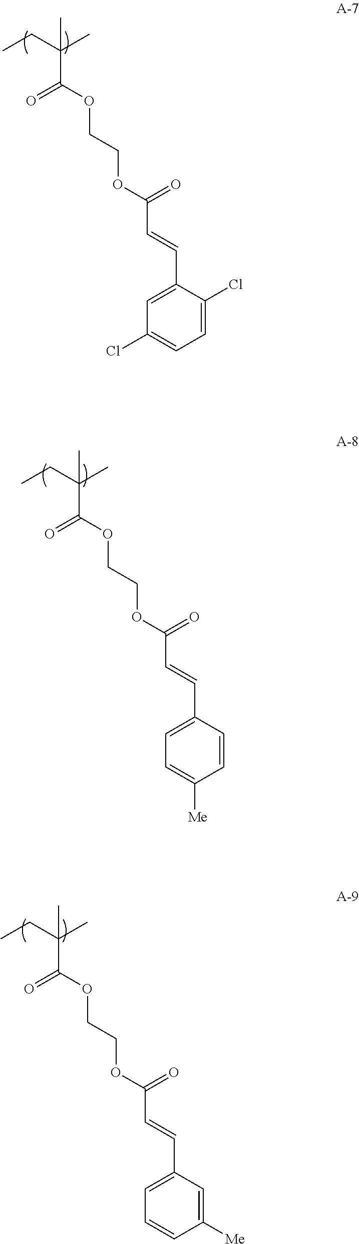

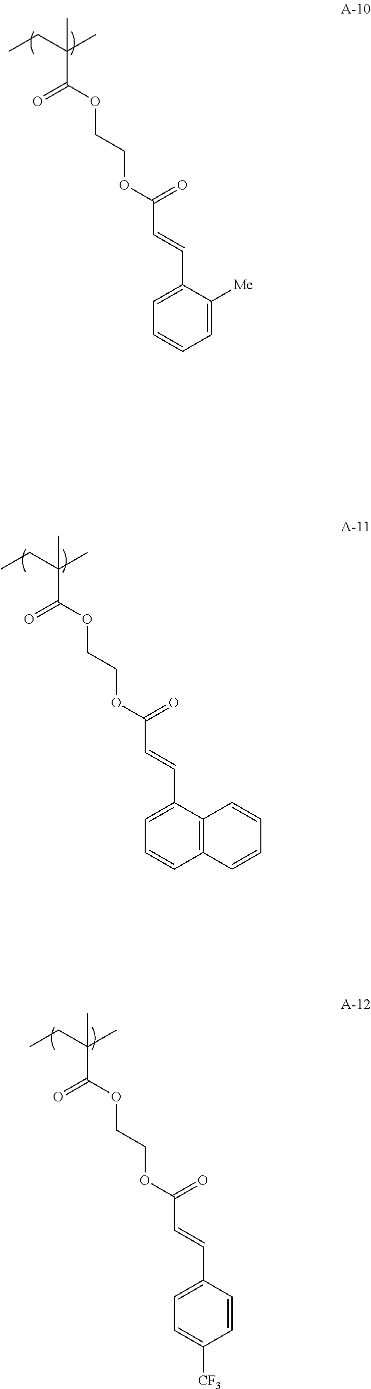

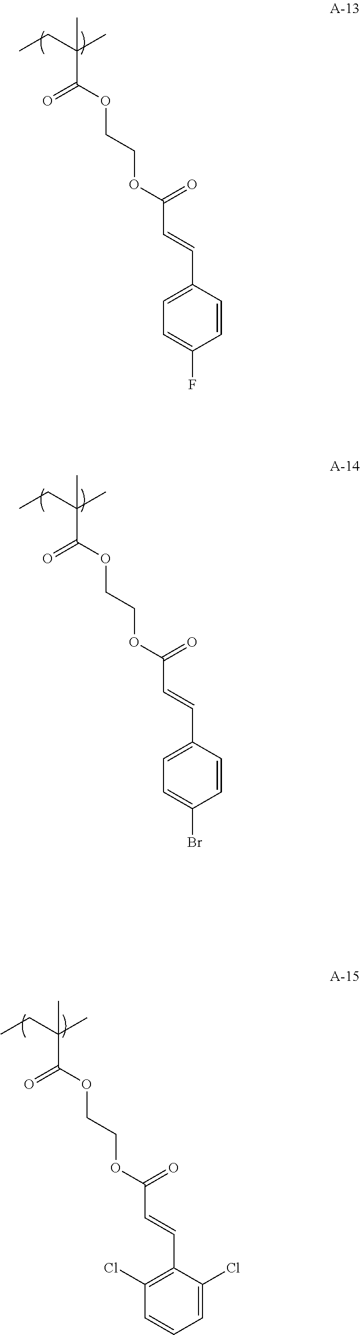

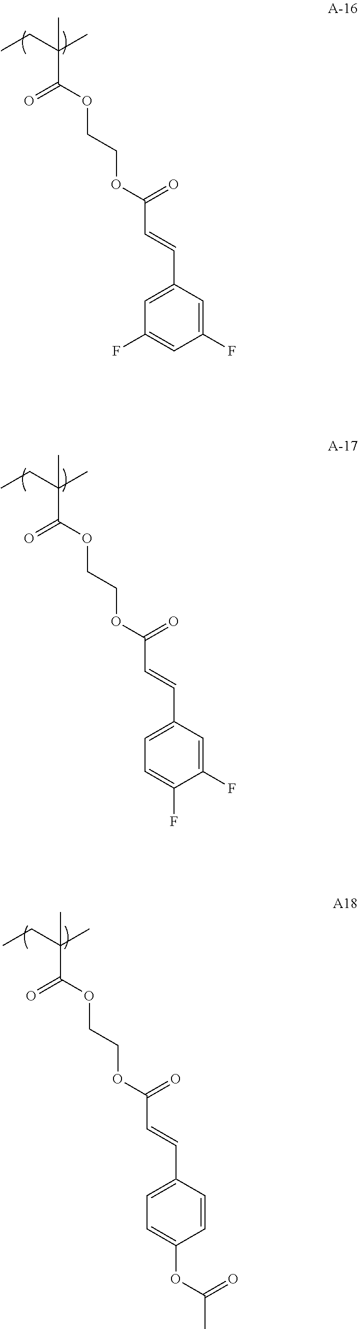

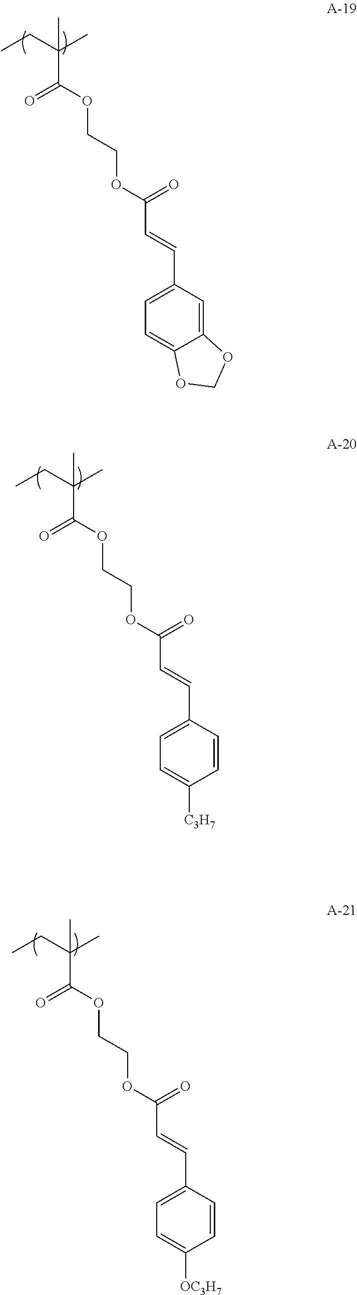

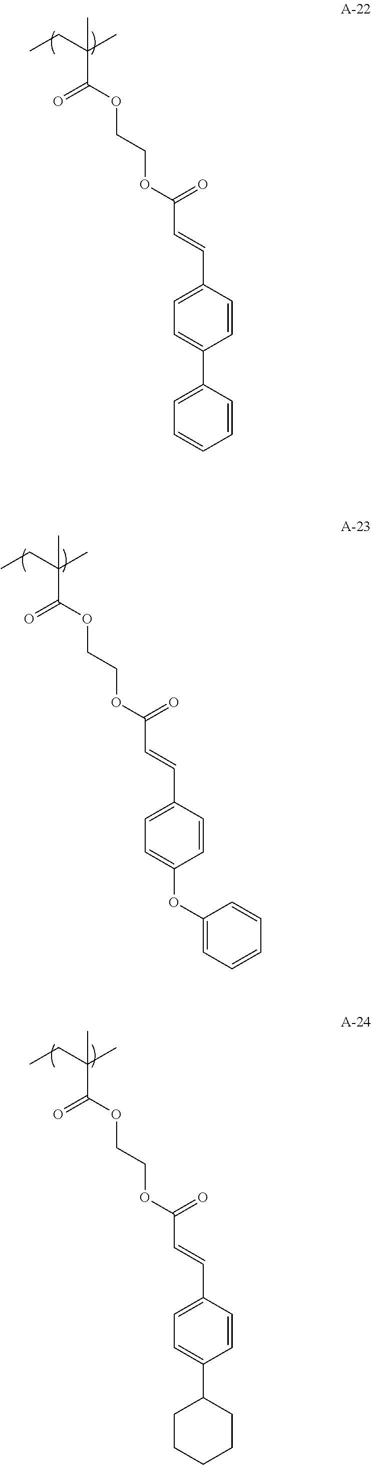

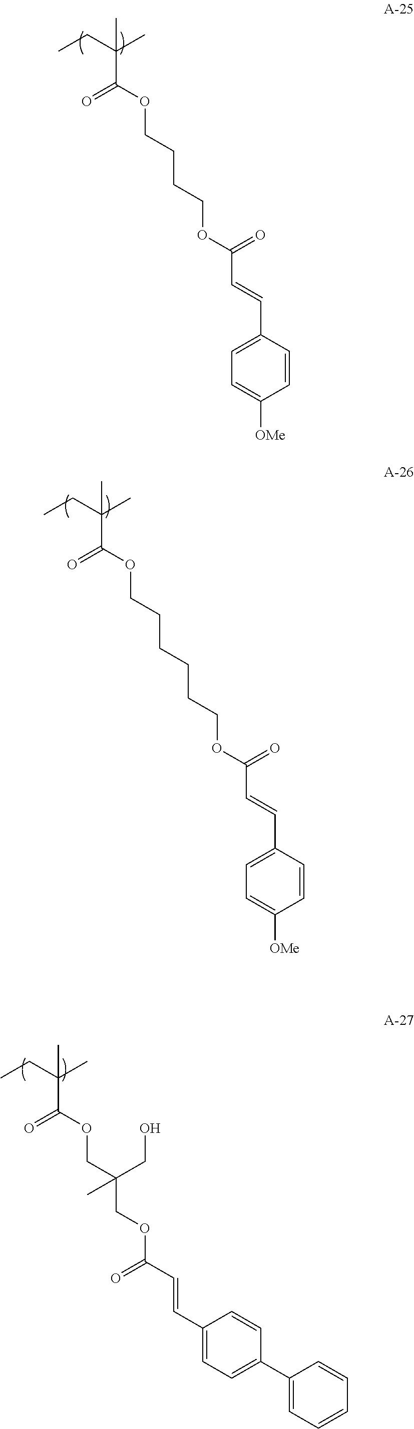

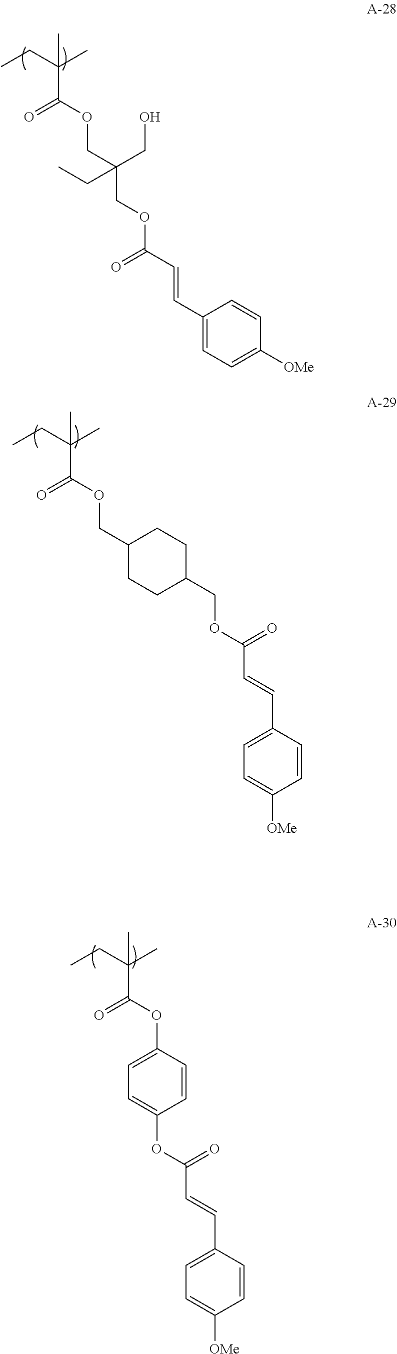

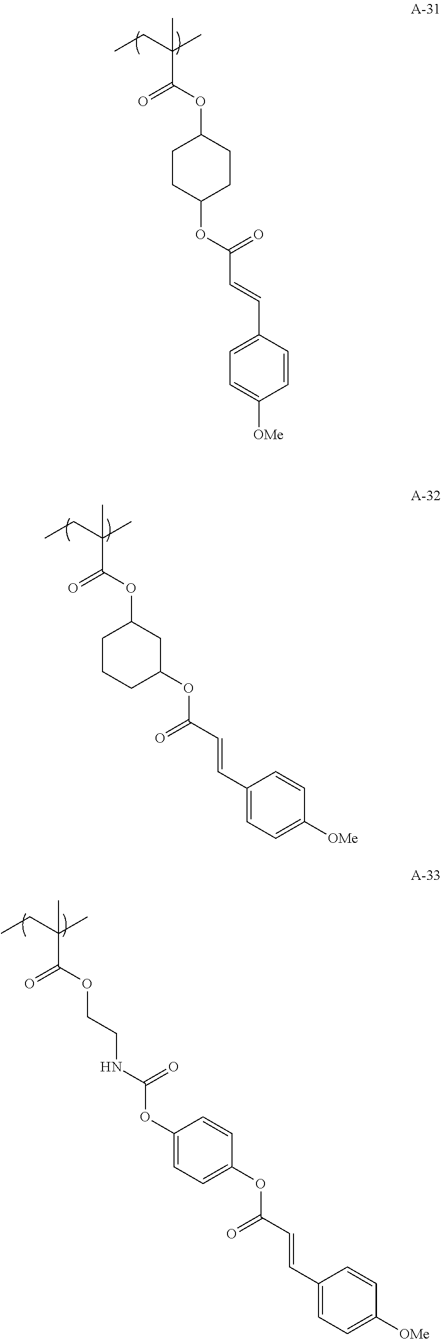

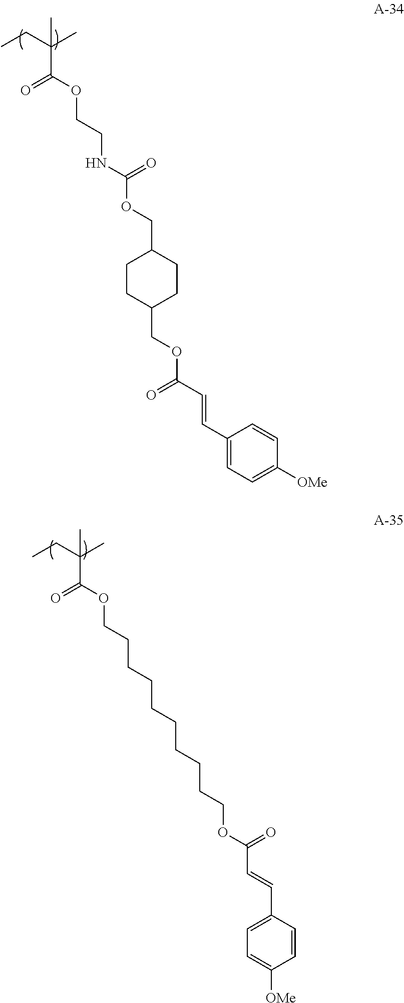

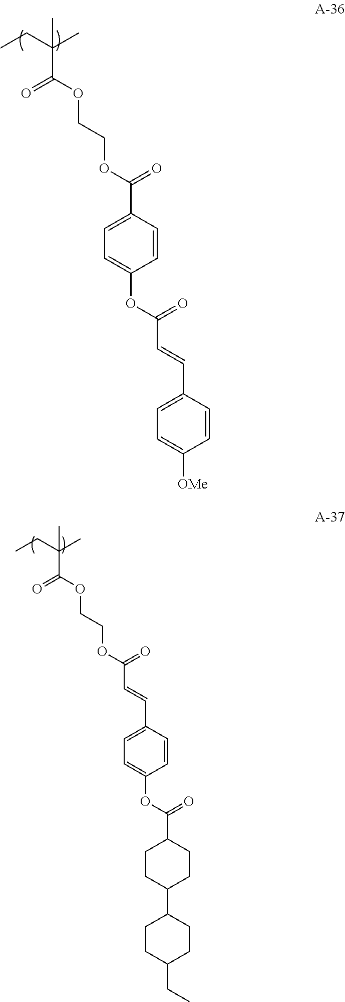

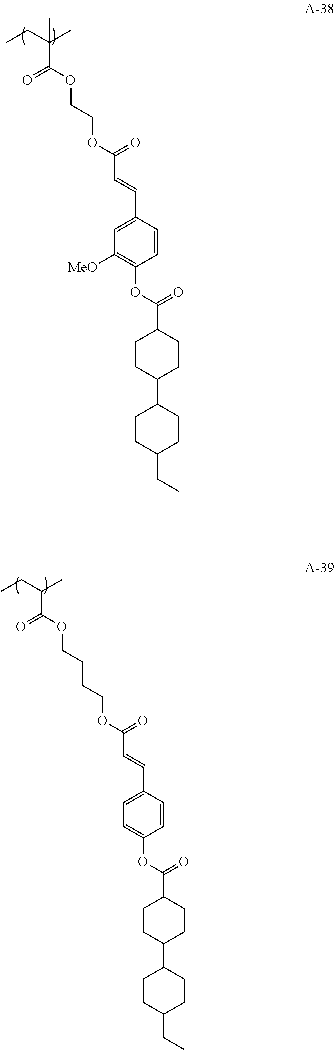

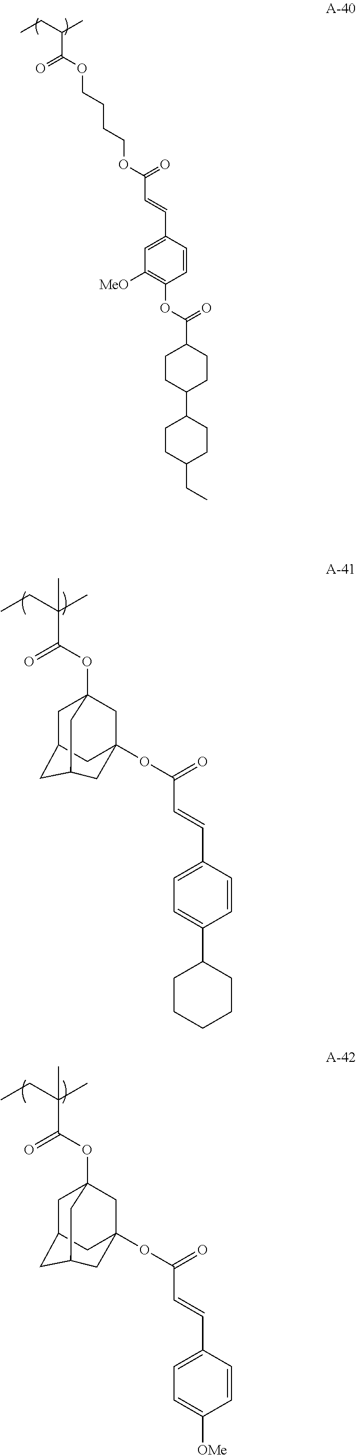

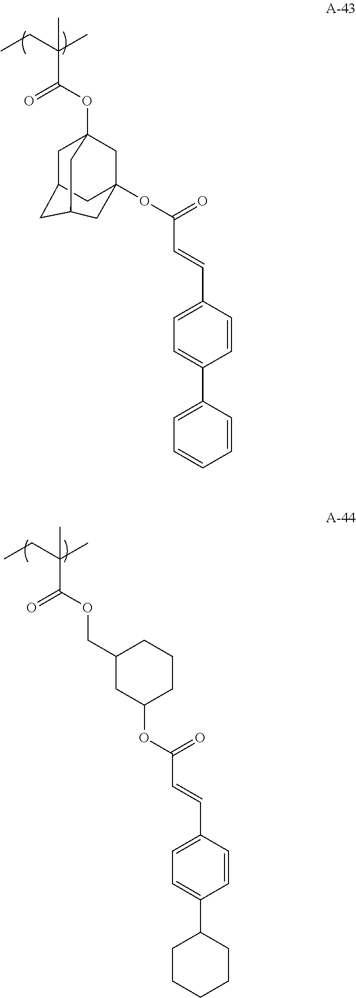

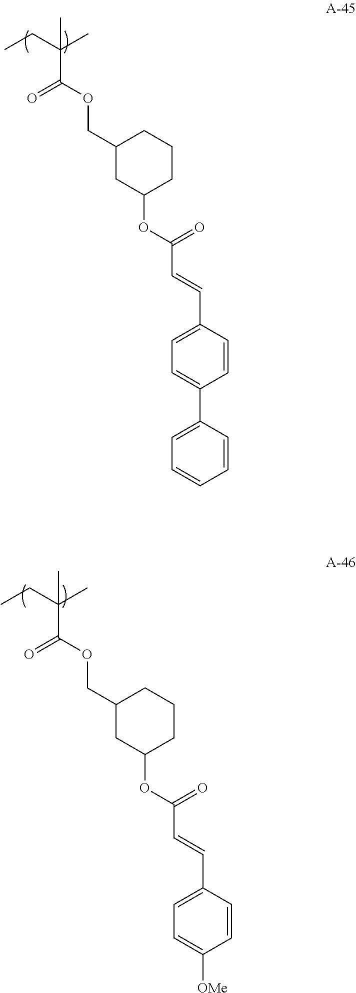

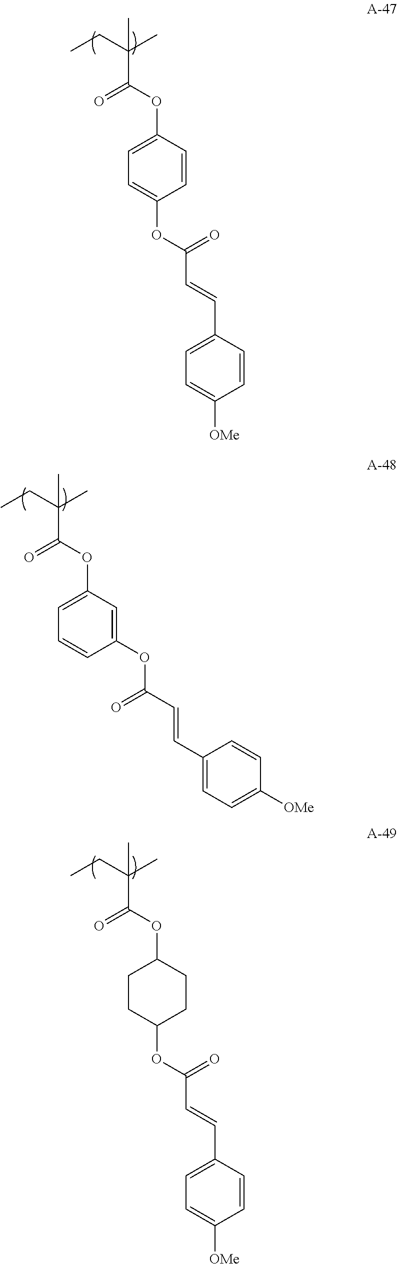

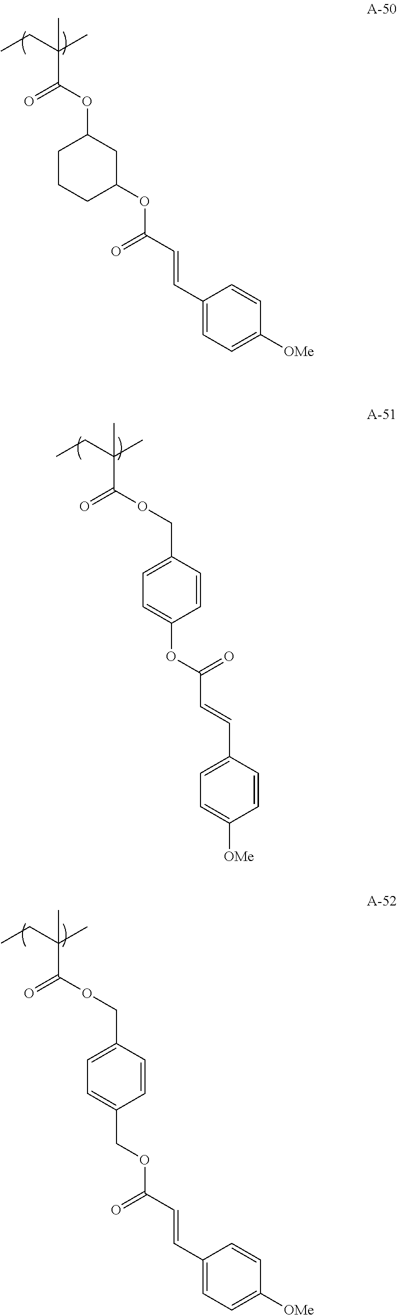

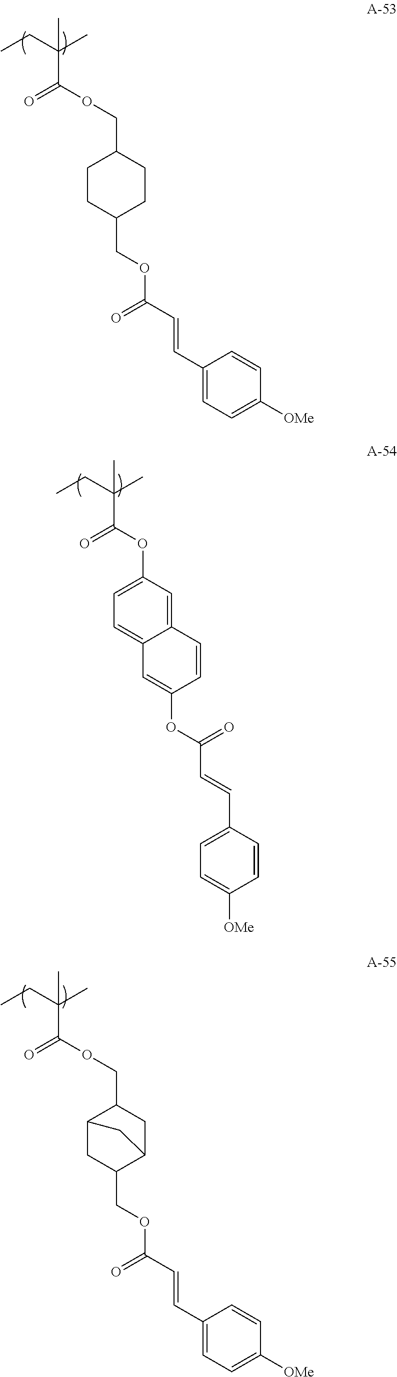

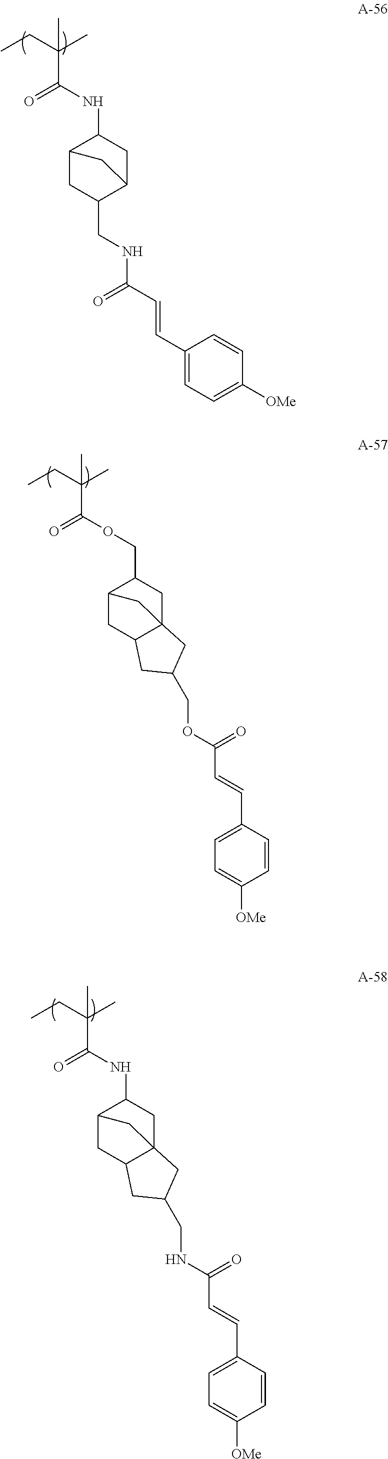

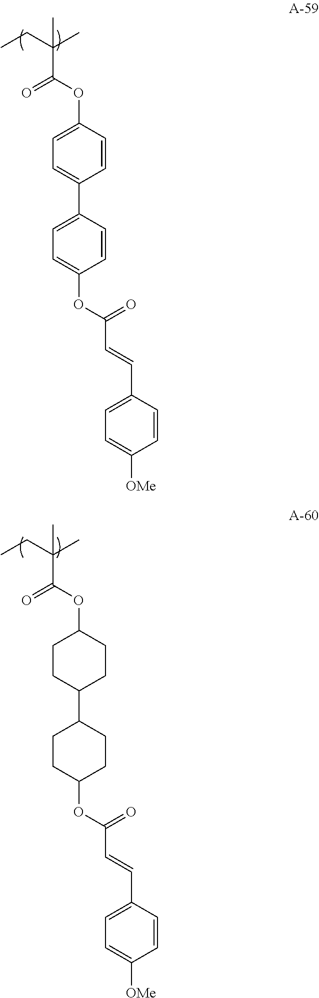

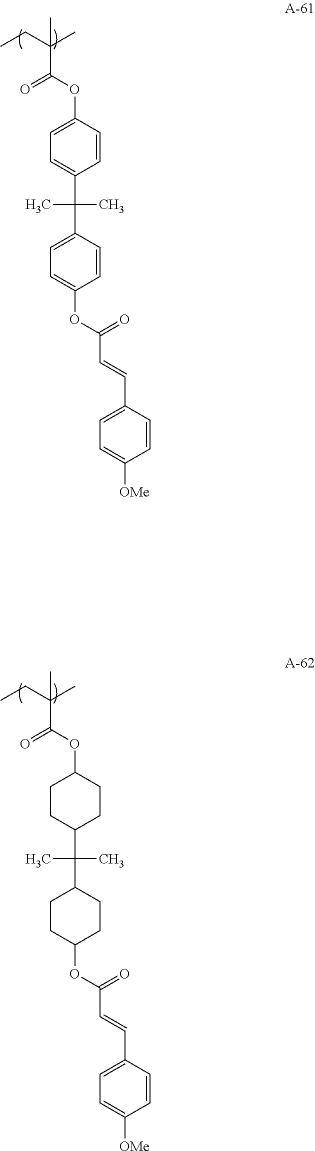

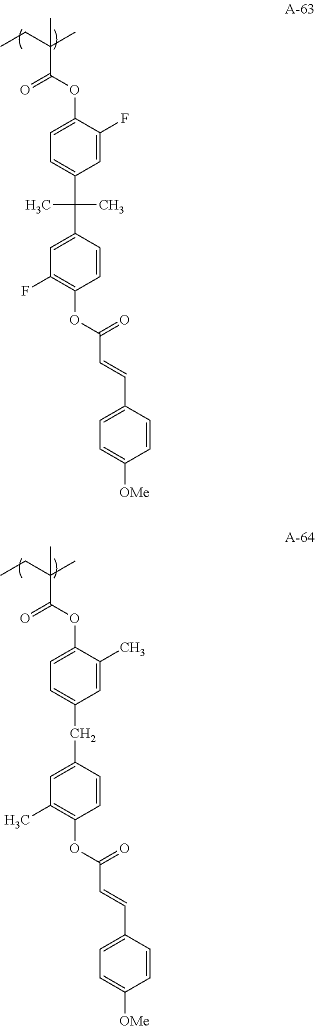

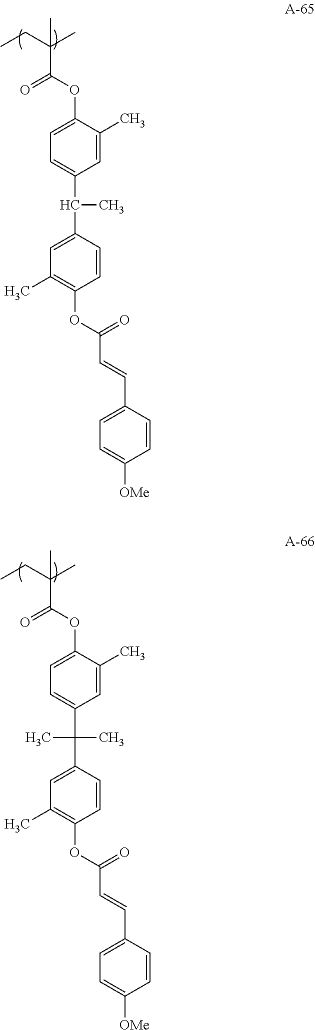

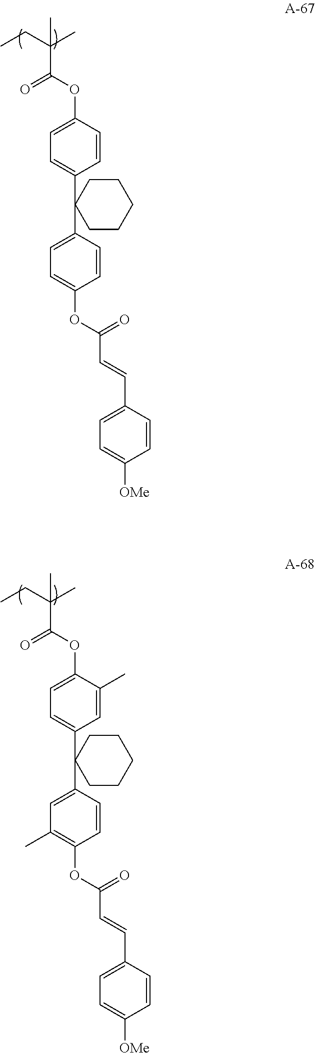

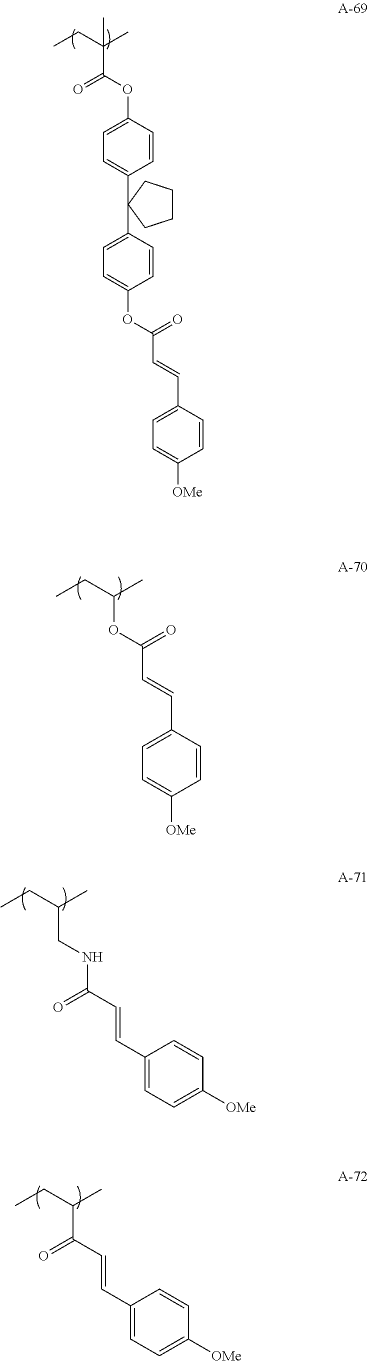

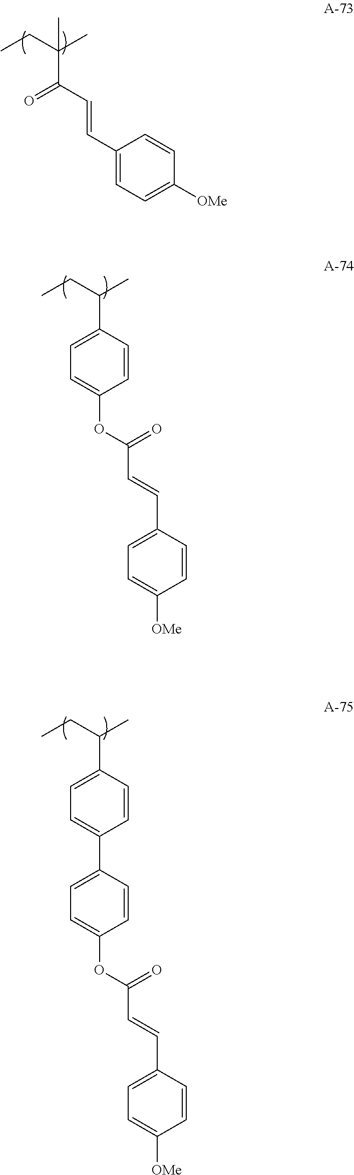

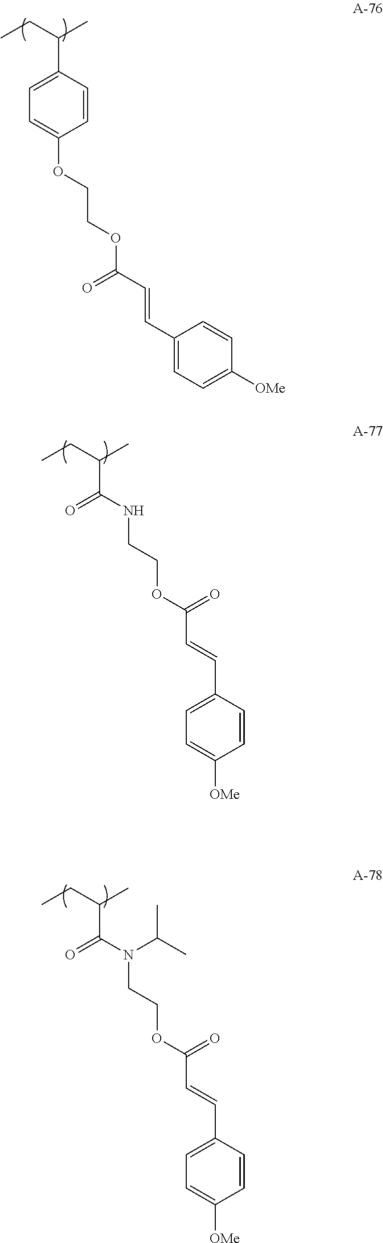

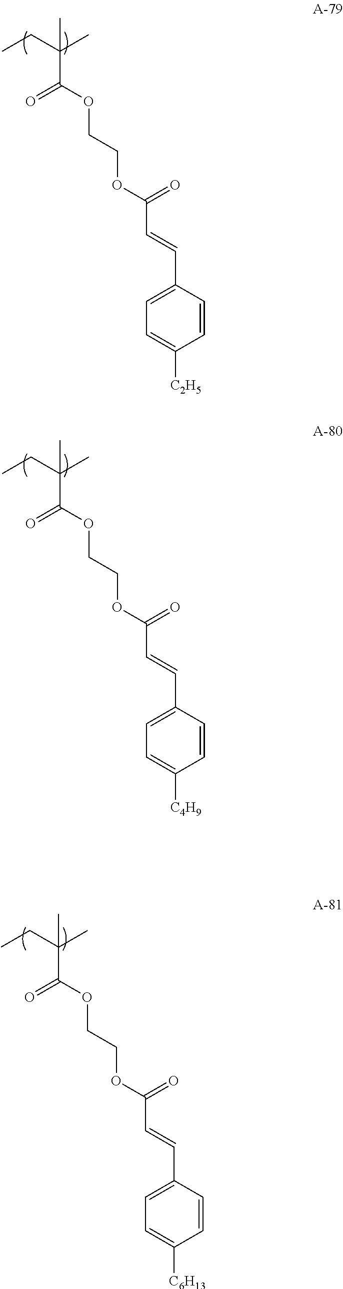

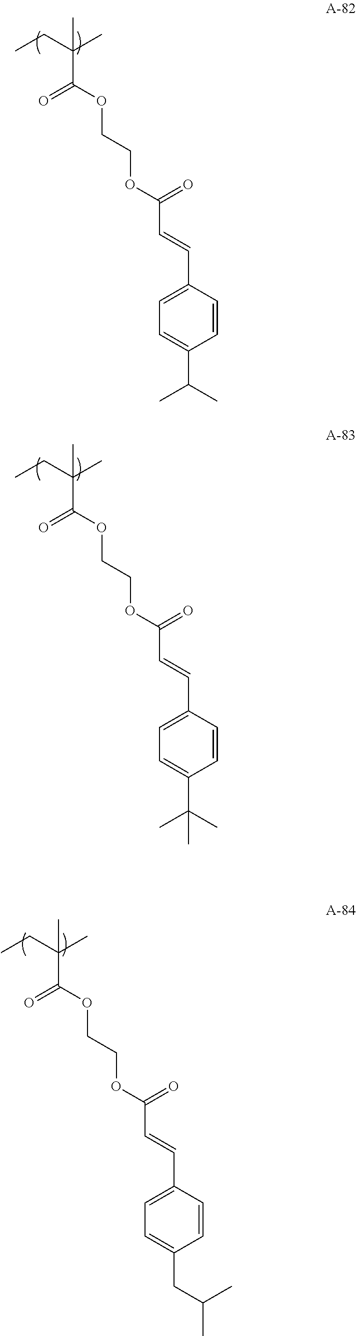

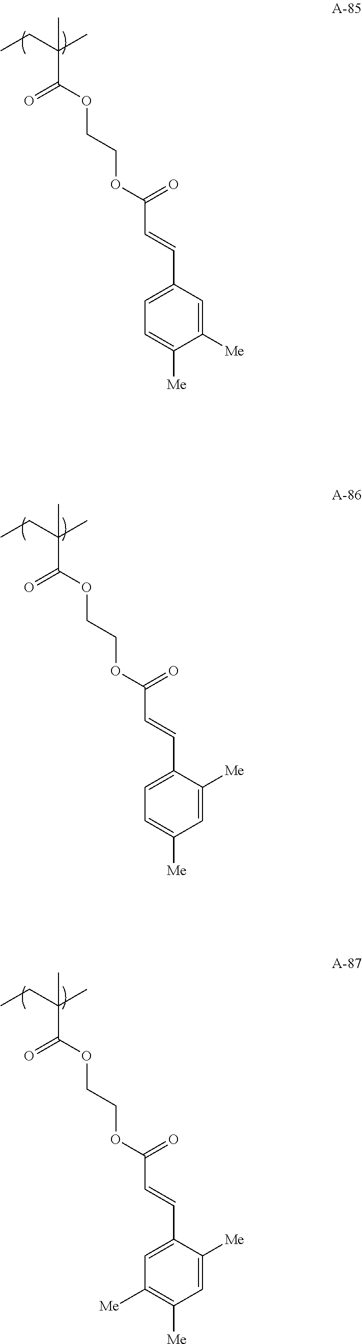

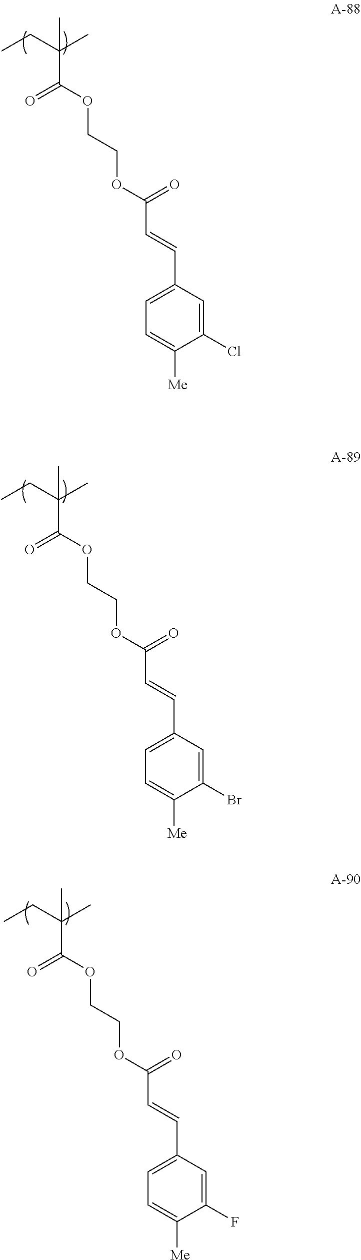

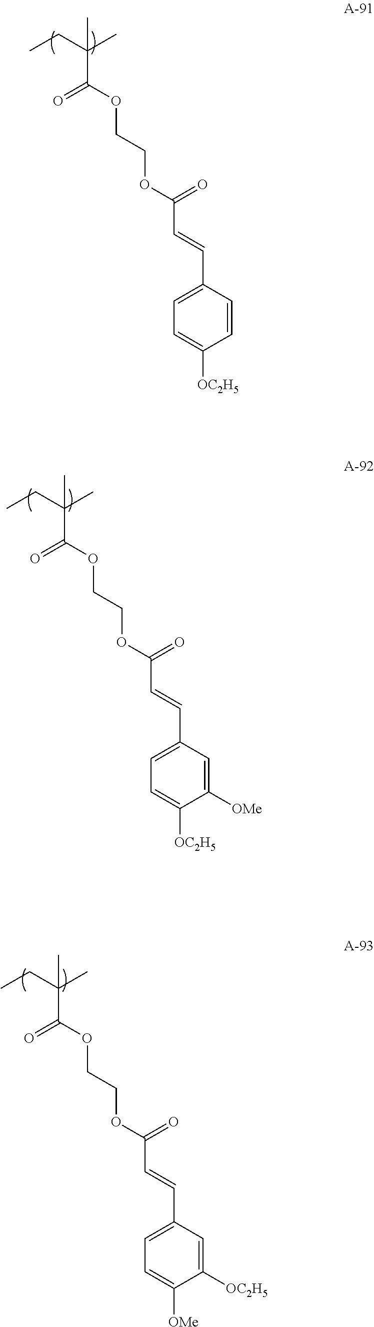

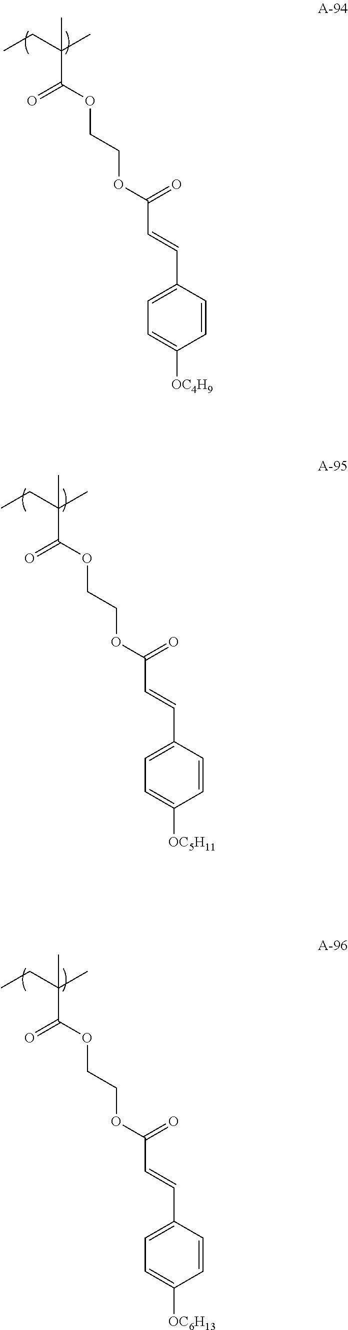

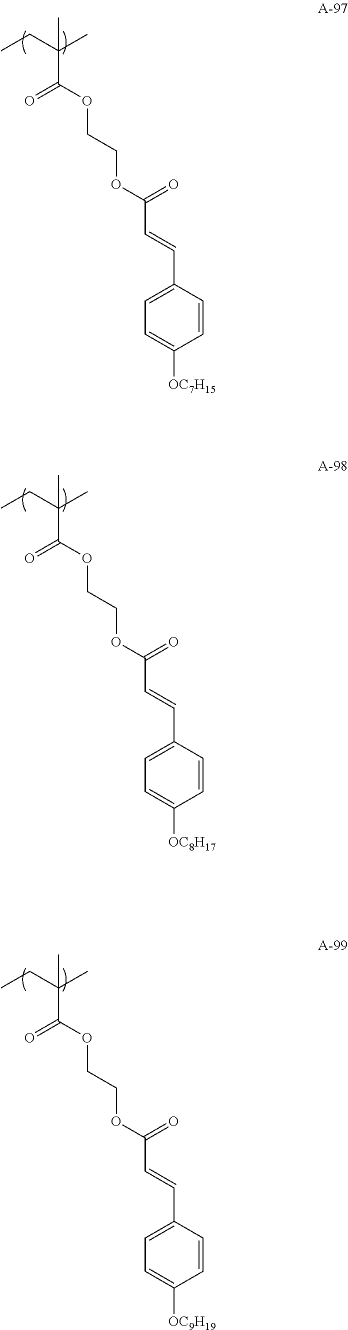

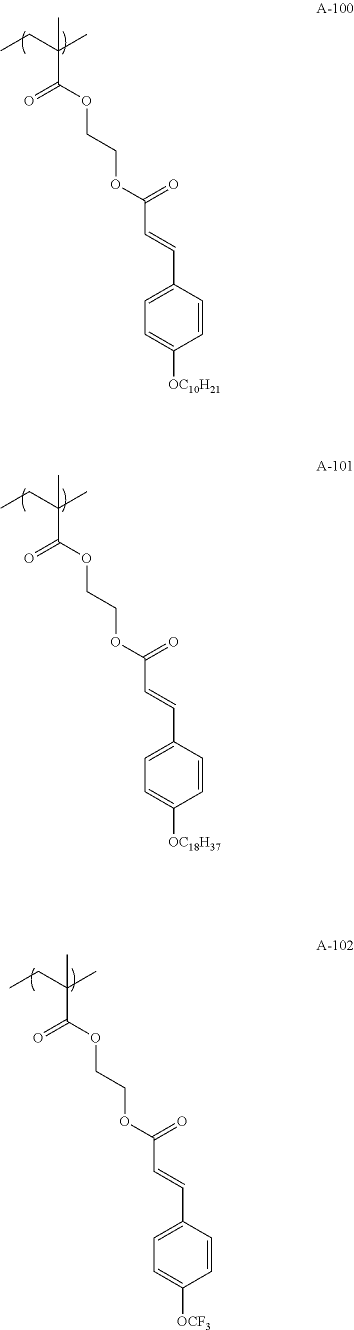

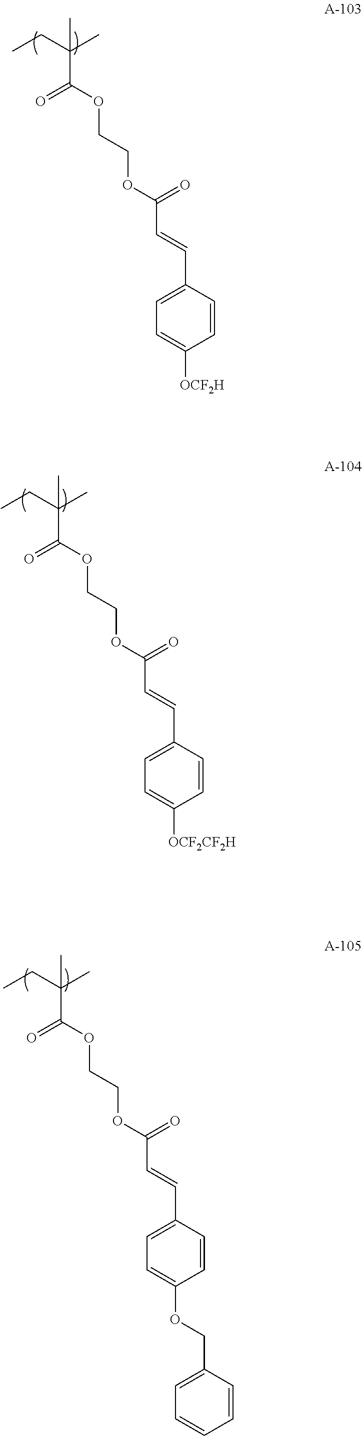

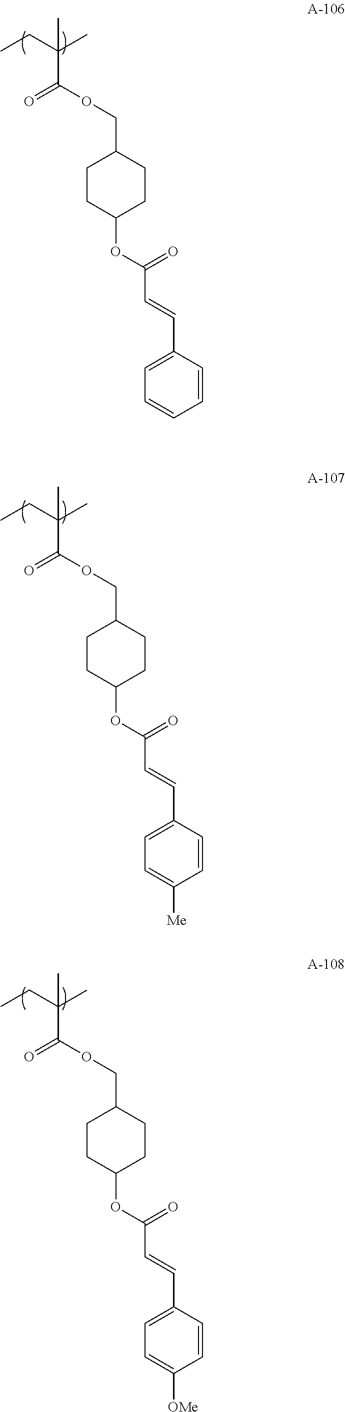

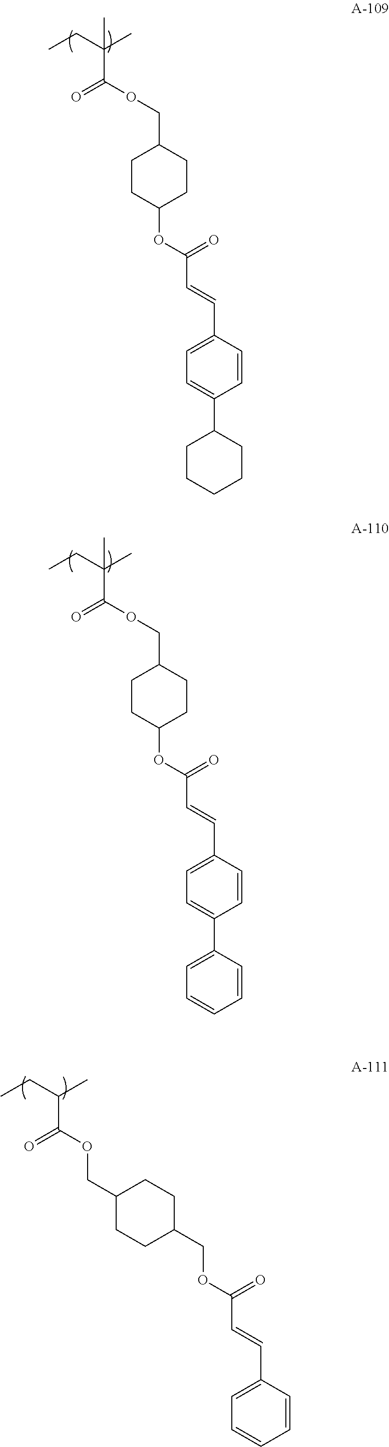

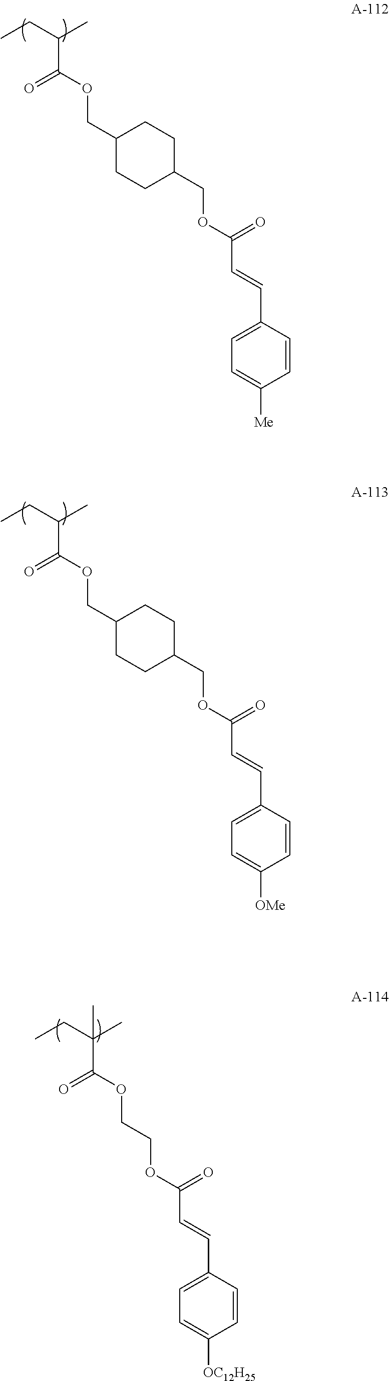

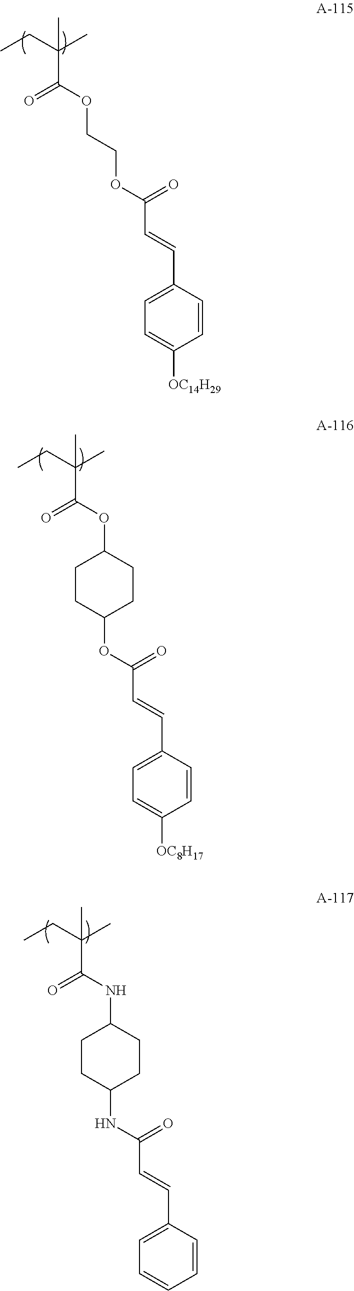

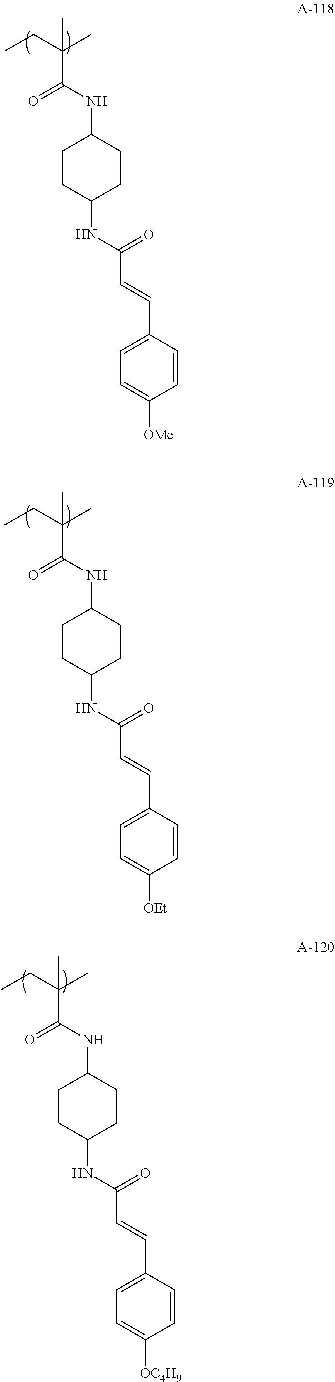

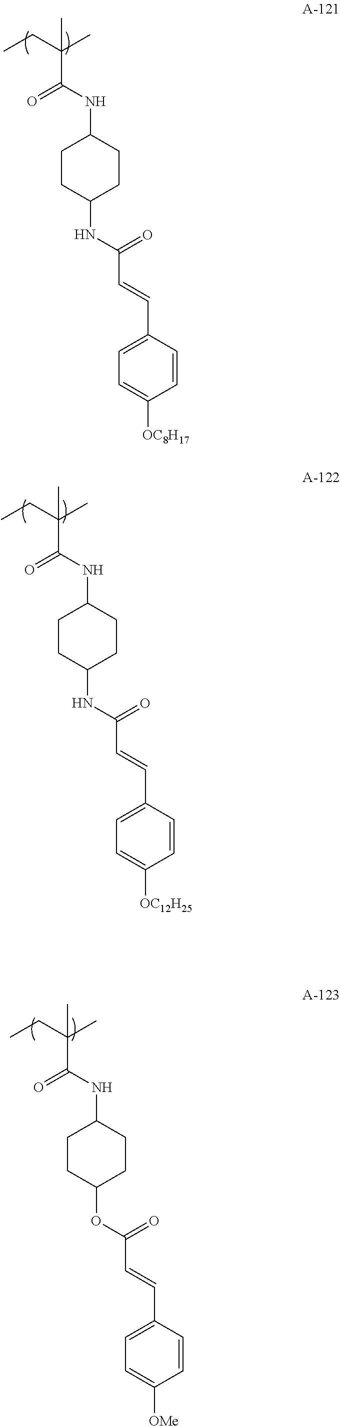

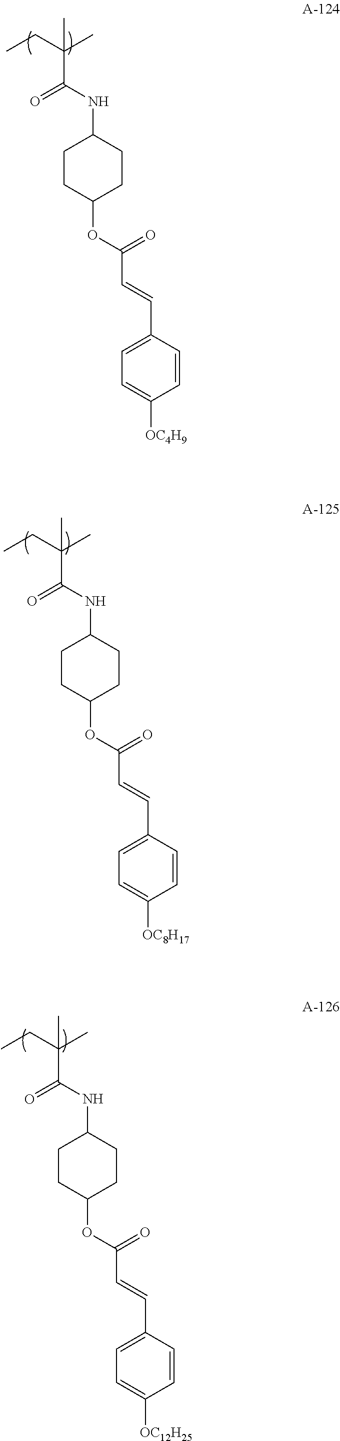

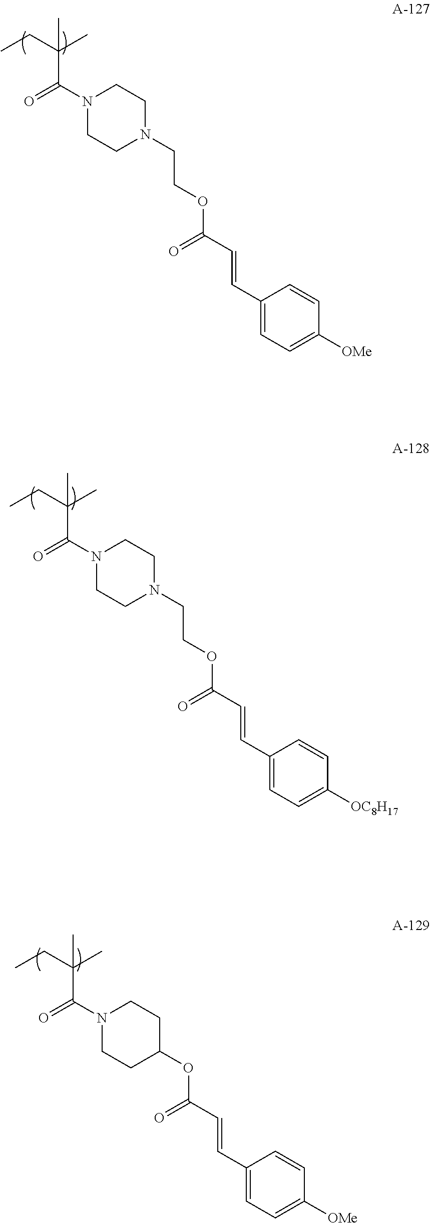

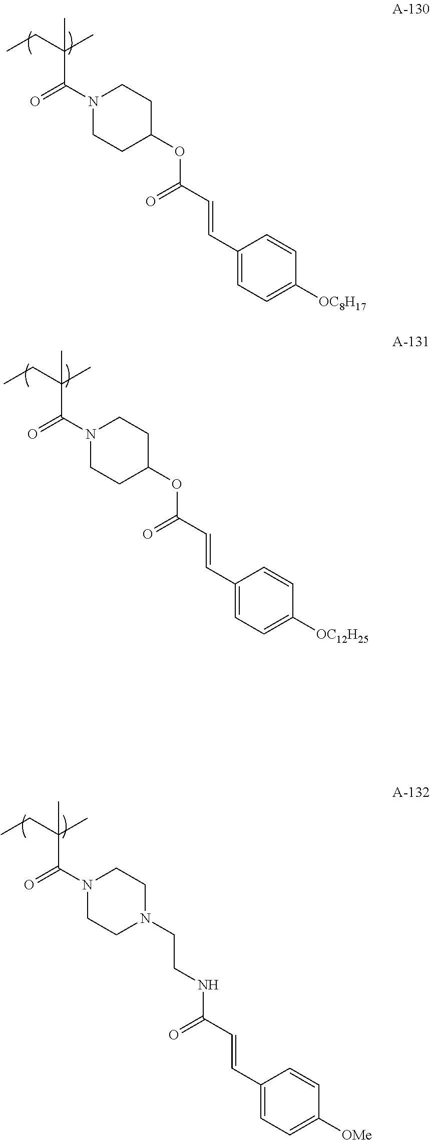

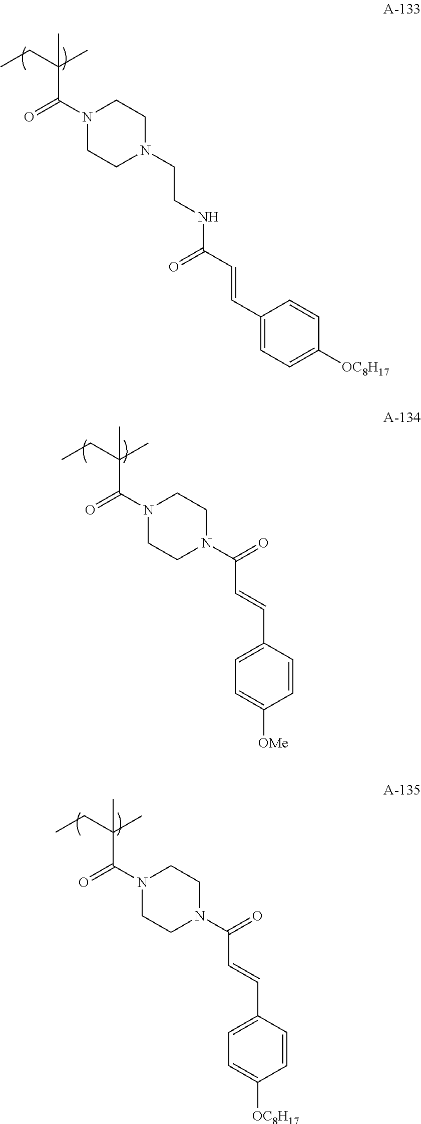

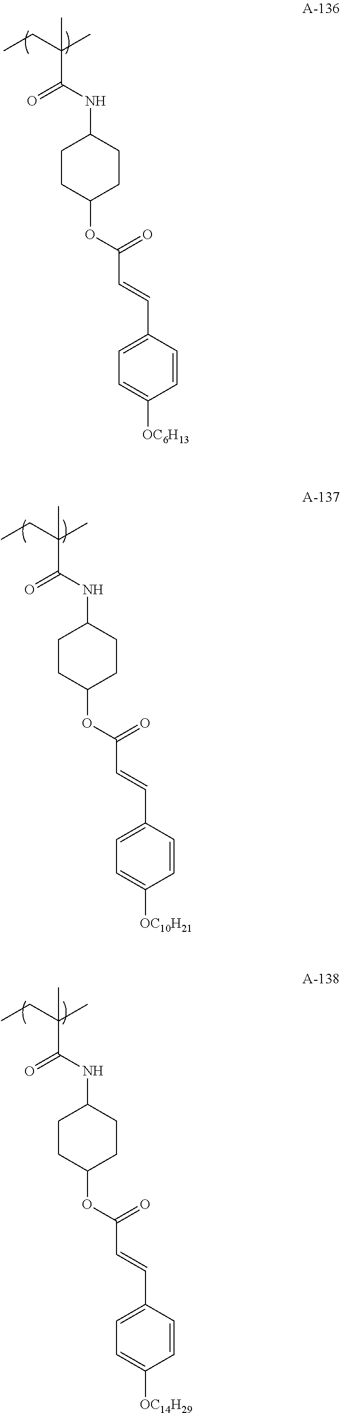

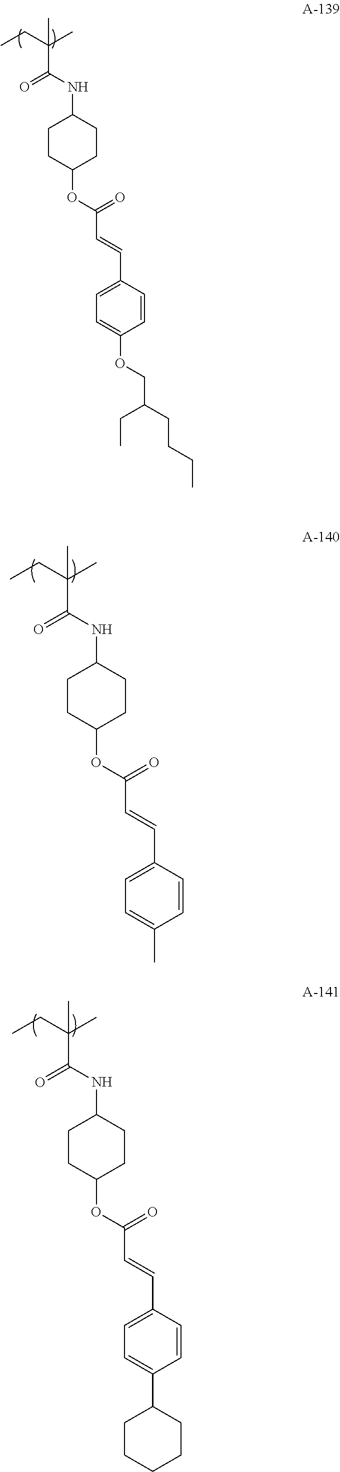

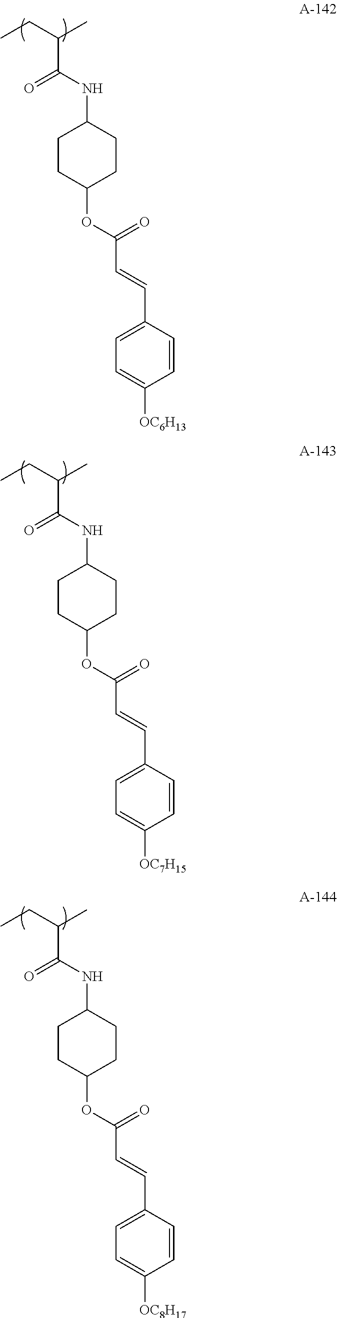

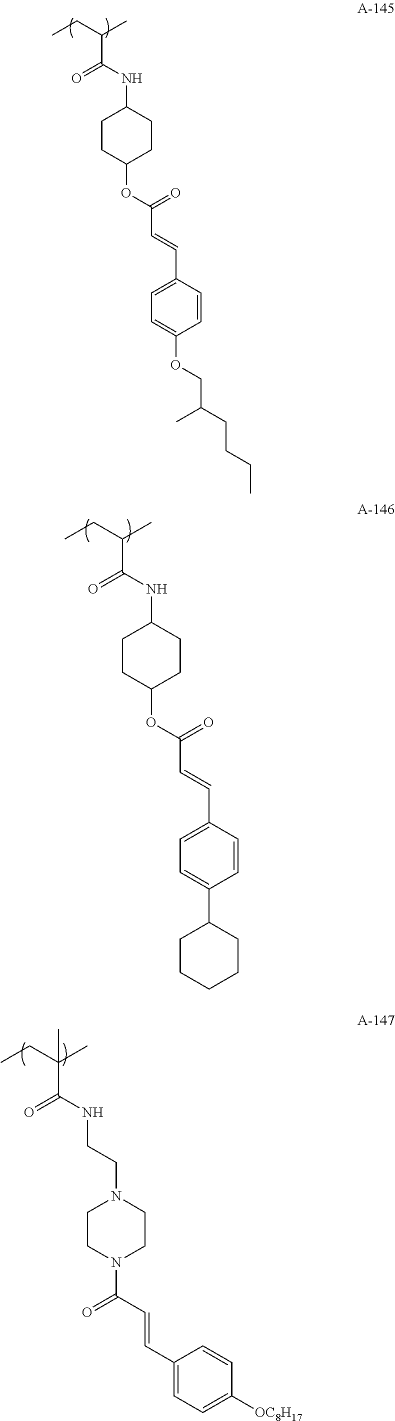

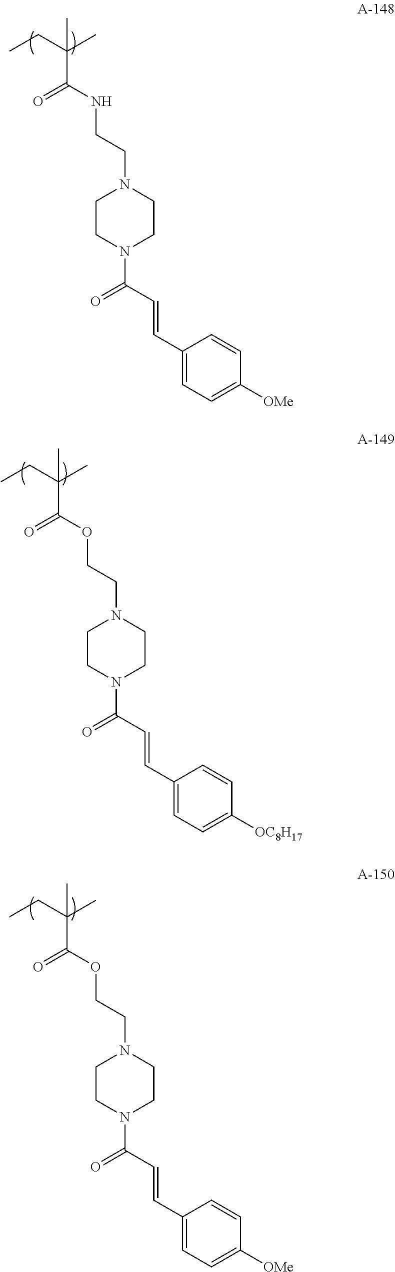

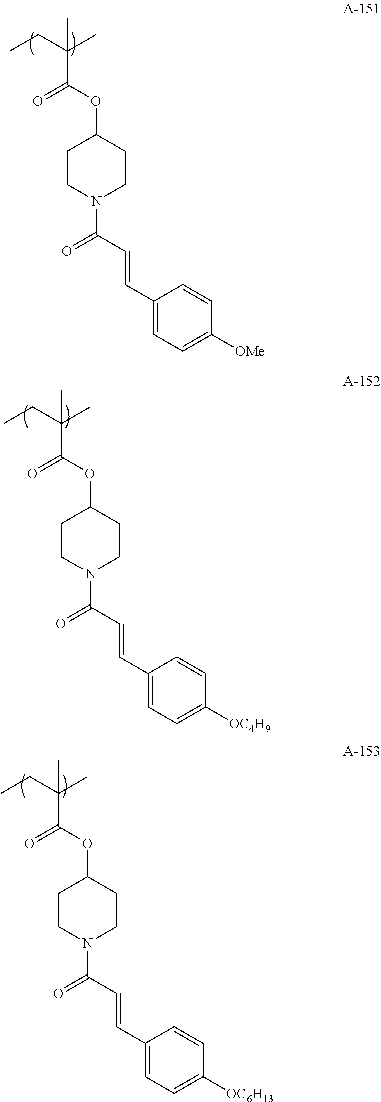

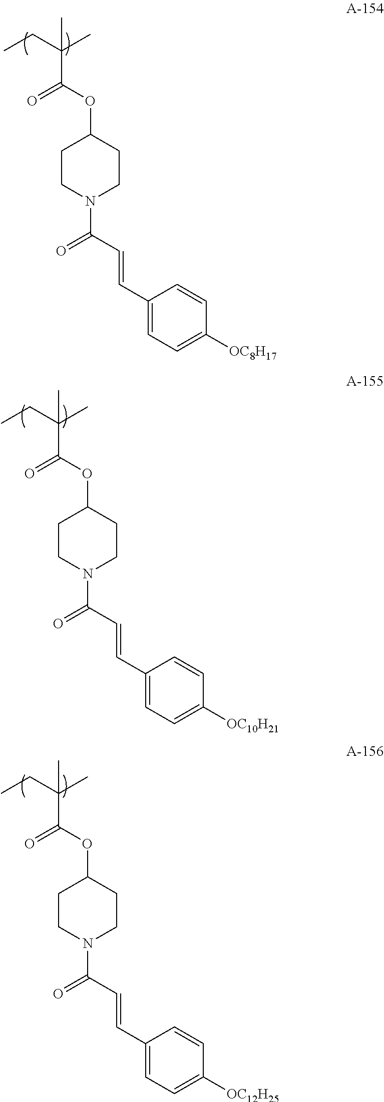

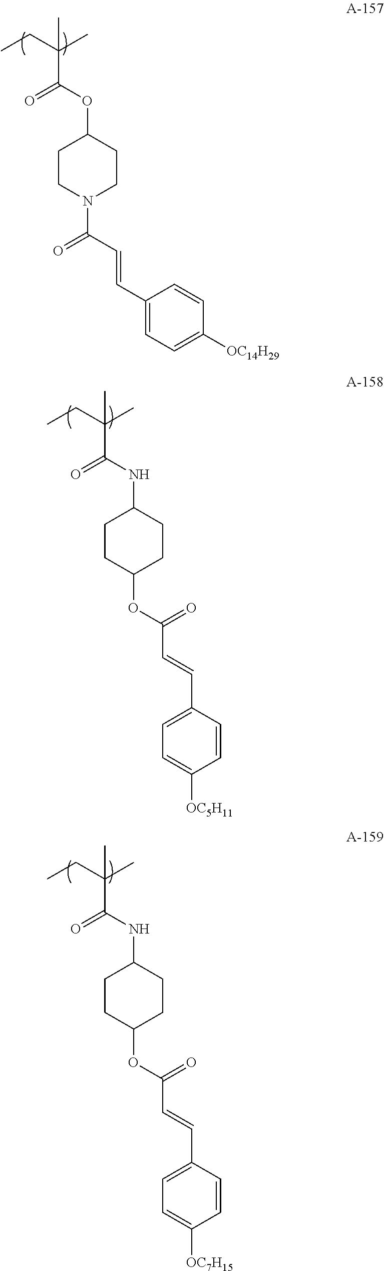

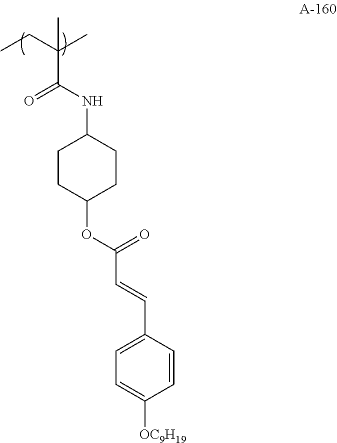

### (Repeating Unit B)

The repeating unit B included in the copolymer according to the present invention is a repeating unit represented by Formula (B).

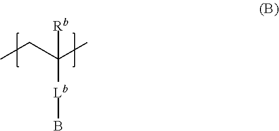

In Formula (B), R^{b} represents a hydrogen atom or a substituent. Examples of the substituent represented by one aspect of R^{b} include the same substituents as those described for the substituent represented by one aspect of R^{a} in Formula (A) above.

In addition, L^{b} represents a divalent linking group. Examples of the divalent linking group represented by L^{b} include the same groups as those described for the divalent linking group represented by L^{a} in Formula (A) above.

In addition, B represents any one polymerizable group represented by Formulae (PG-1) to (PG-3).

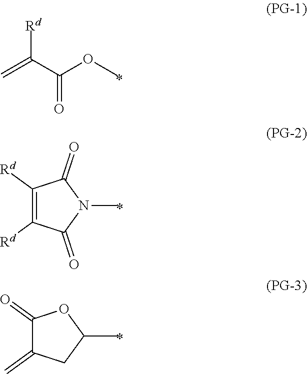

In Formulae (PG-1) to (PG-3), * represents a bonding position to L^{b}.

In Formulae (PG-1) and (PG-2), R^{d} represents a hydrogen atom, a halogen atom, a methyl group, an ethyl group, or a trifluoromethyl group. Here, a plurality of R^{d}'s in Formula (PG-2) may be the same or different from each other.

Among the polymerizable groups represented by Formulae (PG-1) to (PG-3), from the reason that the adhesiveness with the liquid crystal cured layer is favorable, the polymerizable group represented by Formula (PG-1) is preferable, and a (meth)acryloyl group is more preferable.

Specific examples of the repeating unit B represented by Formula (B) include the following repeating units B-1 to B-29.

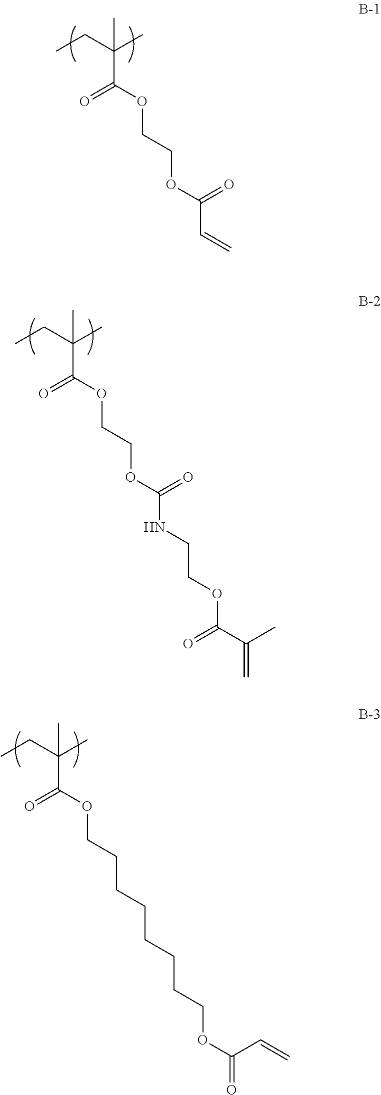

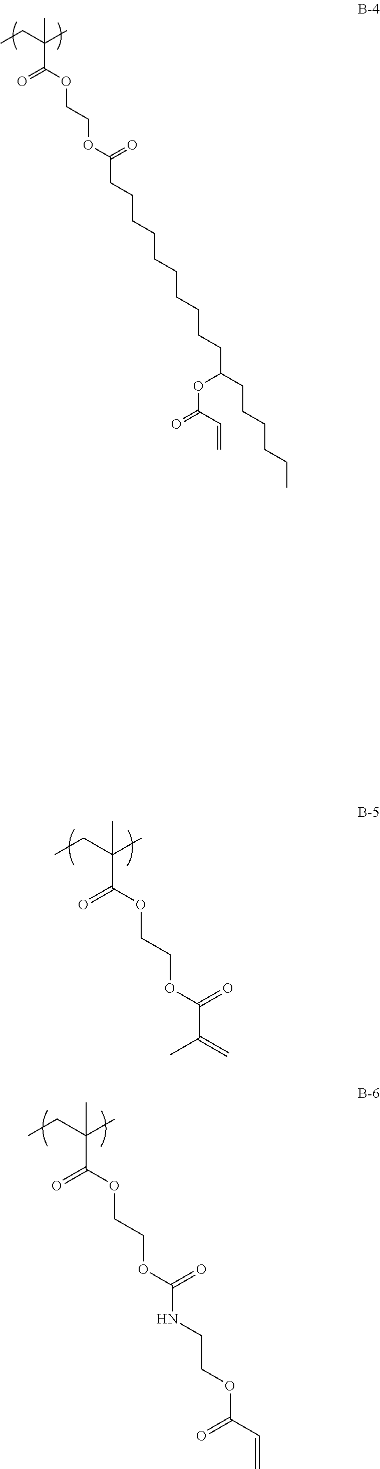

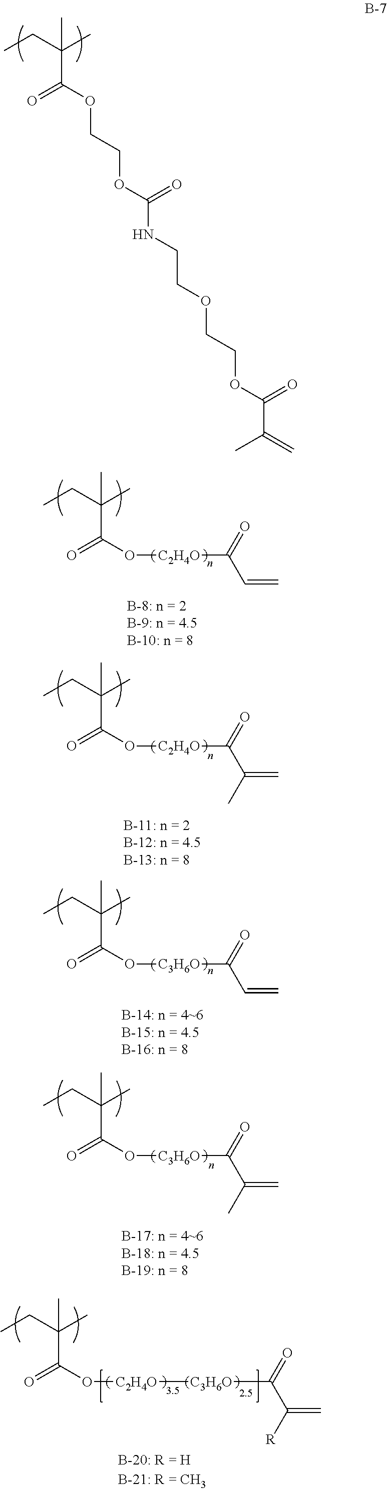

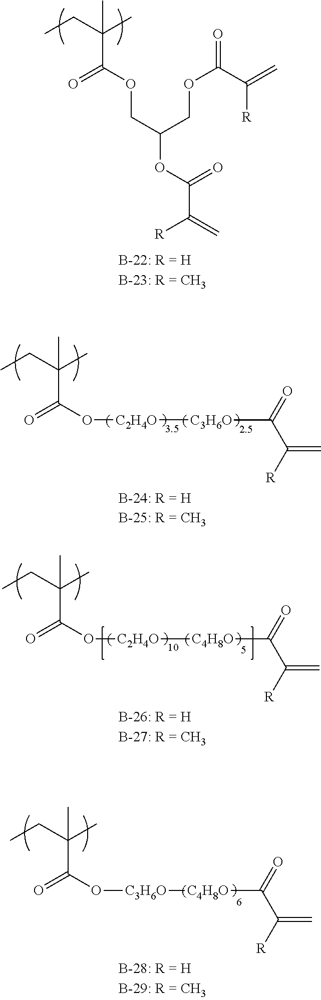

### (Repeating Unit C)

The repeating unit C included in the copolymer according to the present invention is a repeating unit represented by Formula (C).

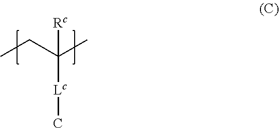

In Formula (C), R^{c} represents a hydrogen atom or a substituent. Examples of the substituent represented by one aspect of R^{c} include the same substituents as those described for the substituent represented by one aspect of R^{a} in Formula (A) above.

In addition, L^{c} represents a divalent linking group. Examples of the divalent linking group represented by L^{c} include the same groups as those described for the divalent linking group represented by L^{a} in Formula (A) above.

In addition, C represents any one polymerizable group represented by Formulae (PG-4) to (PG-9).

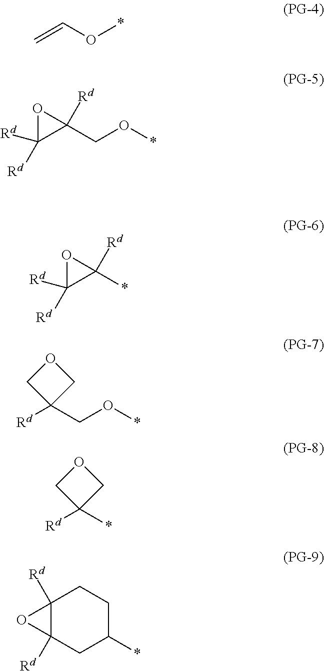

In Formulae (PG-4) to (PG-9), * represents a bonding position to L^{c}.

In Formulae (PG-5) to (PG-9), R^{d} represents a hydrogen atom, a halogen atom, a methyl group, an ethyl group, or a trifluoromethyl group. Here, a plurality of R^{d}'s in Formulae (PG-5), (PG-6), and (PG-9) may be the same or different from each other.

Among the polymerizable groups represented by Formulae (PG-4) to (PG-9), from the reason that relaxation of the photo-alignment film by the composition, particularly an organic solvent in the composition, can be further suppressed in a case of forming the liquid crystal cured layer, the polymerizable group represented by Formula (PG-9) is preferable.

Specific examples of the repeating unit C represented by Formula (C) include the following repeating units C-1 to C-23.

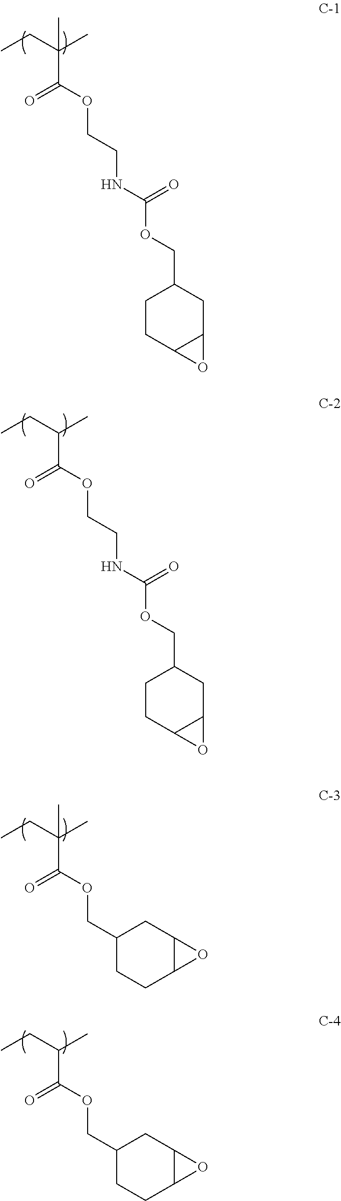

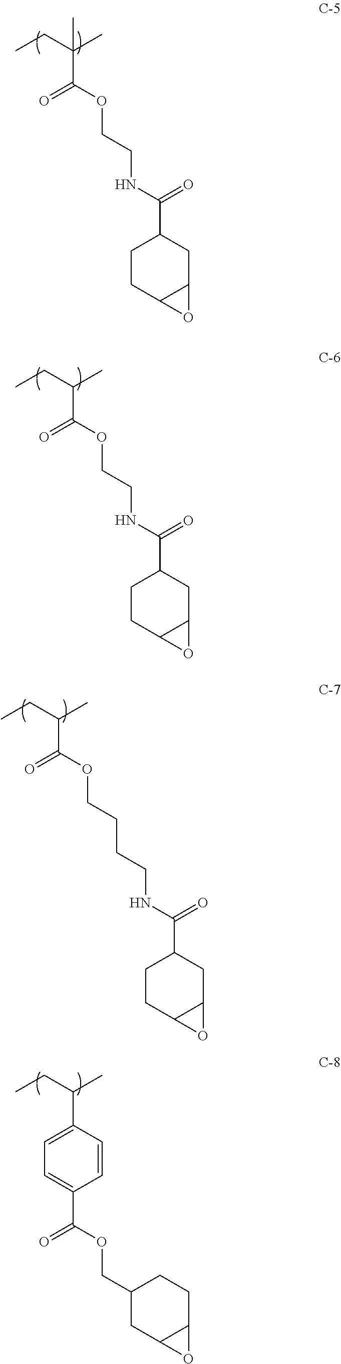

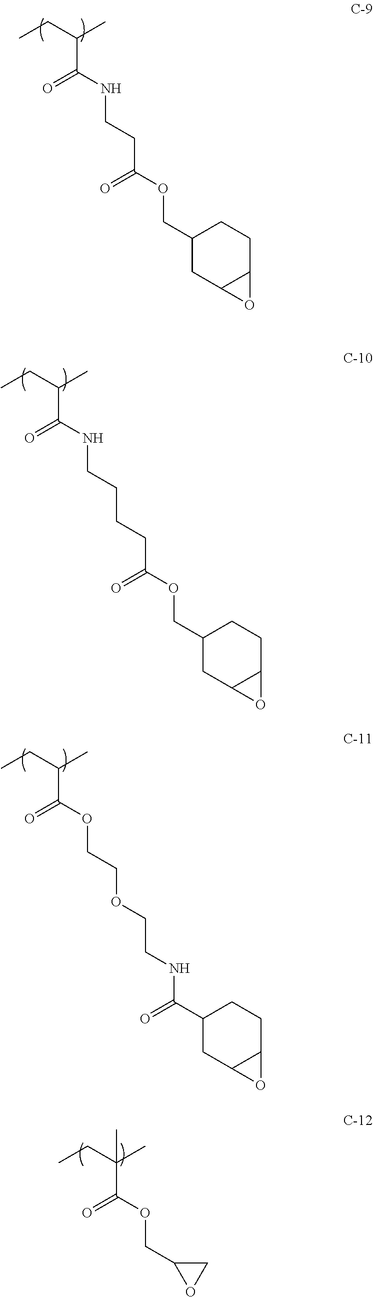

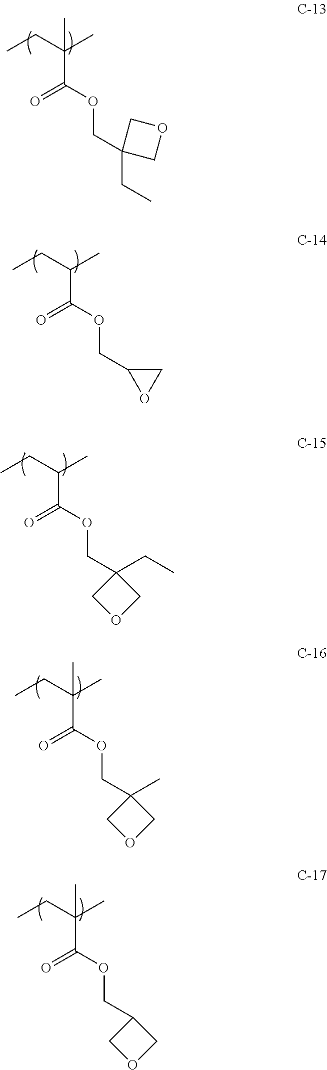

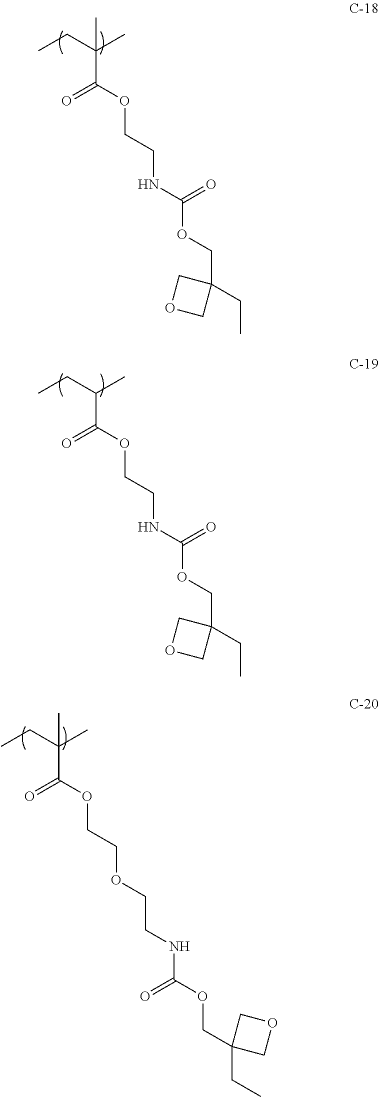

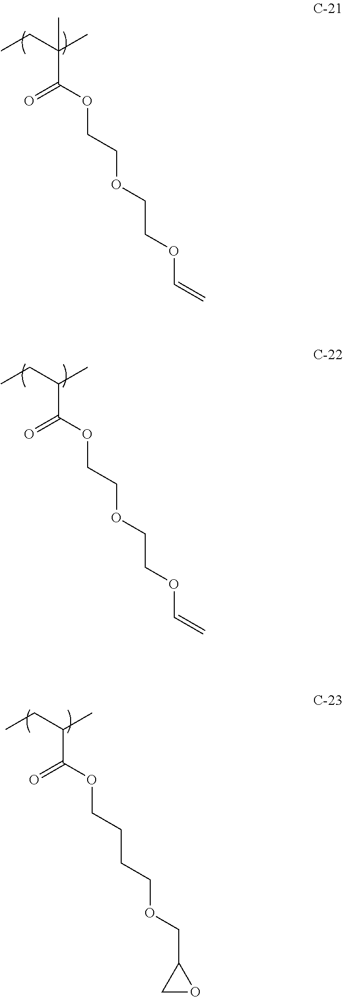

In the copolymer according to the present invention, from the reason that the aligning properties of the liquid crystal cured layer are more favorable and the adhesiveness between the substrate and the alignment film is also more favorable, a content a (% by mass) of the repeating unit A represented by Formula (A), a content b (% by mass) of the repeating unit B represented by Formula (B), and a content c (% by mass) of the repeating unit C represented by Formula (C) are each preferably 5≤a≤30, 20≤b≤45, and 50≤c≤75, and more preferably 7≤a≤22, 23≤b≤38, and 55≤c≤70.

### (Other Repeating Units)

The copolymer according to the present invention may have a repeating unit other than the repeating unit A, the repeating unit B, and the repeating unit C described above, as long as the effect of the invention is not impaired.

Examples of a monomer (radically polymerizable monomer) forming the repeating unit other than the above-described repeating units include an acrylic acid ester compound, a methacrylic acid ester compound, a maleimide compound, an acrylamide compound, acrylonitrile, maleic acid anhydride, a styrene compound, and a vinyl compound.

A method of synthesizing the copolymer according to the present invention is not particularly limited. For example, the copolymer according to the present invention can be synthesized by mixing a monomer forming the above-described repeating unit A, a monomer forming the above-described repeating unit B, a monomer forming the above-described repeating unit C, and a monomer forming a repeating unit other than the above-described repeating units, and then polymerizing the monomers using a radical polymerization initiator in an organic solvent.

From the reason that the aligning properties of the liquid crystal cured layer are more favorable, a weight-average molecular weight (Mw) of the copolymer according to the present invention is preferably 10,000 to 500,000 and more preferably 10,000 to 100,000.

Here, in the present invention, the weight-average molecular weight and the number-average molecular weight are values measured by gel permeation chromatography (GPC) under the following conditions.
Solvent (eluant): Tetrahydrofuran (THF)
Device Name: TOSOH HLC-8320GPC
Column: Three items of TOSOH TSKgel Super HZM-H (4.6 mm×15 cm) are connected and used.
Column Temperature: 40° C.
Sample Concentration: 0.1% by mass
Flow Rate: 1.0 ml/min
Calibration curve: TSK standard polystyrene manufactured by TOSOH Corporation; the calibration curve is based on seven samples with Mw=2,800,000 to 1,050 (Mw/Mn=1.03 to 1.06)

In the present invention, from the reason that the aligning properties of the liquid crystal cured layer are more favorable and the adhesiveness between the substrate and the alignment film is also more favorable, a content of the polymer (I) is preferably 5% to 30% by mass and more preferably 7.5% to 15% by mass with respect to the total mass of solid contents of the composition for forming an alignment film.

### <Polymer (II)>

From the reason that the aligning properties of the liquid crystal cured layer are more favorable, it is preferable that the composition for forming an alignment film further contains a polymer (II) which is a polymer other than the polymer (I) and has the repeating unit B represented by Formula (B) described above.

In a case where the composition for forming an alignment film contains the polymer (II), from the reason that the aligning properties of the liquid crystal cured layer are more favorable, it is preferable that, in a case where, with regard to Hansen solubility parameters in the polymer (I), a dispersion-force term is denoted by δD(I), a polarity term is denoted by δP(I), and a hydrogen-bonding term is denoted by δH(I), and with regard to Hansen solubility parameters in the polymer (II), a dispersion-force term is denoted by δD(II), a polarity term is denoted by δP(II), and a hydrogen-bonding term is denoted by δH(II), Expression (α) is satisfied.

$$\sqrt{( δ D ( I ) - δ {D ( II )}^{2} + {( δ P ( I ) - δ P ( I ) )}^{2} + {( δ H ( I ) - δ H ( II ) )}^{2}} < 0.35 \qquad ( α )$$

Here, the Hansen solubility parameters (HSP) are obtained by dividing the solubility of a substance into three components (a dispersion term δd, a polarity term δp, and a hydrogen-bonding term δh) and representing the components in a three-dimensional space. The dispersion term δd represents an effect of a dispersion force, the polarity term δp represents an effect of a dipole-dipole force, and the hydrogen-bonding term δh represents an effect of a hydrogen bonding force.

In addition, the definition and calculation of the Hansen solubility parameters are described in Hansen Solubility Parameters: A User's Handbook (CRC Press, 2007) by Charles M. Hansen. In addition, by using computer software Hansen Solubility Parameters in Practice (HSPiP), the Hansen solubility parameters can be easily estimated from the chemical structure even for a compound in which a literature value or the like is not known.

In the present invention, the dispersion term δd, the polarity term δp, and the hydrogen-bonding term δh of the liquid crystal compound and the additive are determined by using the HSPiP version 5.1.08 and using the estimated value.

In a case where the composition for forming an alignment film contains the polymer (II), from the reason that the aligning properties of the liquid crystal cured layer are more favorable and the adhesiveness between the substrate and the alignment film is also more favorable, the content of the polymer (I) is preferably 5% to 30% by mass and more preferably 7.5% to 15% by mass with respect to the total mass of the polymer (I) and the polymer (II).

### <Thermal Acid Generator>

The composition for forming an alignment film preferably contains a thermal acid generator.

The thermal acid generator is not particularly limited as long as it can generate an acid by heat, and examples thereof include onium salts such as a sulfonium salt, a benzothiazolium salt, an ammonium salt, and a phosphonium salt.

Specific examples of the thermal acid generator include salts of a cation selected from benzyl (4-hydroxyphenyl)methylsulfonium, (4-acetoxyphenyl)dimethylsulfonium, (4-hydroxyphenyl)dimethylsulfonium, (2-methylbenzyl) (4-hydroxyphenyl)methylsulfonium, (1-naphthylmethyl) (4-hydroxyphenyl)methylsulfonium, or benzyl (4-acetoxyphenyl)methylsulfonium, and an anion selected from hexafluorophosphate, tetrafluoroborate, tris(pentafluoroethyl)trifluorophosphate, tetrakis(pentafluorophenyl) borate, hexafluoroantimonate, p-toluenesulfonate, dodecylbenzenesulfonate, trifluoromethanesulfonate, or perfluorobutanesulfonate.

### <Solvent>

From the viewpoint of workability, the composition for forming an alignment film preferably contains a solvent.

Examples of the solvent include ketones (for example, acetone, 2-butanone, methyl ethyl ketone (MEK), methyl isobutyl ketone, cyclopentanone, and cyclohexanone), ethers (for example, dioxane and tetrahydrofuran), aliphatic hydrocarbons (for example, hexane), alicyclic hydrocarbons (for example, cyclohexane), aromatic hydrocarbons (for example, toluene, xylene, and trimethylbenzene), halogenated carbons (for example, dichloromethane, dichloroethane, dichlorobenzene, and chlorotoluene), esters (for example, methyl acetate, ethyl acetate, and butyl acetate), water, alcohols (for example, ethanol, isopropanol, butanol, and cyclohexanol), cellosolves (for example, methyl cellosolve and ethyl cellosolve), cellosolve acetates, sulfoxides (for example, dimethyl sulfoxide), and amides (for example, dimethylformamide and dimethylacetamide).

The solvent may be used alone or in combination of two or more kinds thereof.

In the present invention, from the reason that it is easy to form the mixed region in the substrate, it is preferable to use a solvent of ketones (particularly, MEK) and a solvent of esters (particularly, butyl acetate) in combination, it is more preferable to use a mixed solvent having a mass ratio (ketones:esters) of 25:75 to 55:45, it is still more preferable to use a mixed solvent having a mass ratio of 30:70 to 50:50, and it is particularly preferable to use a mixed solvent having a mass ratio of 35:65 to 45:55.

### <Method of Producing Alignment Film>

A method for producing the alignment film is not particularly limited, and the alignment film can be produced using the above-described composition for forming an alignment film. For example, the alignment film can be produced by a production method including a coating step of coating a surface of the substrate with the composition for forming an alignment film to form a coating film, a heating step of heating and drying the coating film, and a light irradiating step of irradiating the coating film after drying with polarized light or unpolarized light in an oblique direction with respect to the surface of the coating film.

Hereinafter, each step in the production method will be described in detail.

### (Coating Step)

A coating method in the coating step is not particularly limited and can be appropriately selected depending on the purposes, and examples of the method include spin coating, die coating, gravure coating, flexography, and ink jet printing.

### (Heating Step)

A temperature of the heating step is not particularly limited as long as it is a temperature at which the solvent contained in the coating film can be dried and removed, but is preferably 100° C. to 150° C.

In addition, a time of the heating step is not particularly limited as long as it is a time at which the solvent contained in the coating film can be dried and removed, but is preferably 30 seconds to 5 minutes.

### (Light Irradiating Step)

In the light irradiating step, the polarized light to be applied to the coating film after drying is not particularly limited, and examples thereof include linearly polarized light, circularly polarized light, and elliptically polarized light; and linearly polarized light is preferable.

In addition, the “oblique direction” in which irradiation with unpolarized light is performed is not particularly limited as long as it is a direction inclined at a polar angle θ (0°<θ<90°) with respect to a normal direction of the surface of the coating film. θ can be appropriately selected according to the purpose, and is preferably 20° to 80°.

A wavelength of the polarized light or the unpolarized light is not particularly limited as long as the light is light to which the photo-aligned group is exposed. Examples thereof include ultraviolet rays, near-ultraviolet rays, and visible rays, and near-ultraviolet rays of 250 to 450 nm are preferable.

In addition, examples of a light source for irradiating the coating film after drying with polarized light or unpolarized light include a xenon lamp, a high-pressure mercury lamp, an ultra-high pressure mercury lamp, a light emitting diode (LED) lamp, and a metal halide lamp. By using an interference filter, a color filter, or the like with respect to ultraviolet rays or visible rays obtained from the light source, the wavelength range of the irradiation can be restricted. In addition, linearly polarized light can be obtained by using a polarization filter or a polarization prism with respect to the light from the light source.

An integrated quantity of the polarized light or the unpolarized light is not particularly limited, and is preferably 1 to 300 mJ/cm² and more preferably 5 to 100 mJ/cm².

An illuminance of the polarized light or the unpolarized light is not particularly limited, and is preferably 0.1 to 300 mW/cm² and more preferably 1 to 100 mW/cm².

In the present invention, a thickness of the alignment film is not particularly limited and can be appropriately selected depending on the purpose, but is preferably 200 to 1,000 nm and more preferably 200 to 600 nm.

### [Liquid Crystal Cured Layer]

The liquid crystal cured layer included in the optical film according to the embodiment of the present invention is a liquid crystal cured layer obtained by fixing an alignment state of a liquid crystal composition containing a liquid crystal compound.

### <Liquid Crystal Compound>

The liquid crystal compound can be classified into a rod-like type and a disk-like type according to the shape thereof. Each of the types can further be classified into a low-molecular-weight type and a high-molecular-weight type. The “high-molecular-weight” generally refers to a compound having a degree of polymerization of 100 or more (Polymer Physics-Phase Transition Dynamics, written by Masao Doi, p. 2, published by Iwanami Shoten, 1992).

In the present invention, any liquid crystal compound can be used, and it is preferable to use a rod-like liquid crystal compound or a discotic liquid crystal compound (disk-like liquid crystal compound). A mixture of two or more kinds of the rod-like liquid crystal compounds, a mixture of two or more kinds of the disk-like liquid crystal compounds, or a mixture of the rod-like liquid crystal compound and the disk-like liquid crystal compound may be used.

In addition, from the viewpoint of fixing the alignment state of the liquid crystal composition, the liquid crystal compound preferably has a polymerizable group. Examples of the polymerizable group include an acryloyl group, a methacryloyl group, an epoxy group, and a vinyl group.

By polymerizing such a liquid crystal compound, the alignment of the liquid crystal compound can be fixed. After immobilizing the liquid crystal compound by polymerization, it is no longer necessary to exhibit liquid crystallinity.

As the rod-like liquid crystal compound, for example, rod-like liquid crystal compounds described in claim 1 of JP1999-513019A (JP-H11-513019A) or paragraphs [0026] to [0098] of JP2005-289980A can be preferably used; and as the discotic liquid crystal compounds, for example, discotic liquid crystal compounds described in paragraphs [0020] to [0067] of JP2007-108732A or paragraphs [0013] to [0108] of JP2010-244038A can be preferably used, but the liquid crystal compounds are not limited thereto.

In the present invention, from the reason that the aligning properties of the liquid crystal cured layer are more favorable, it is preferable that the liquid crystal cured layer is a layer obtained by fixing a liquid crystalline state of a smectic phase, that is, a layer obtained by immobilizing the liquid crystal composition containing the above-described liquid crystal compound in an alignment state of a smectic phase.

In the present invention, from the reason that the aligning properties of the liquid crystal cured layer are more favorable, it is preferable that the above-described liquid crystal compound is a rod-like liquid crystal compound and a difference Δn in refractive index between a major axis direction and a minor axis direction satisfies Expression (β).

$$Δ n ( 450 ) / Δ n ( 550 ) < 1. \qquad ( β )$$

In Expression (β), Δn(450) represents a difference in refractive index at 450 nm, and Δn(550) represents a difference in refractive index at 550 nm.

In addition, the major axis direction of the rod-like liquid crystal compound refers to an orientation of the longest axis in the molecule, and the minor axis direction refers to an orientation orthogonal to the major axis direction.

In addition, the difference Δn in refractive index refers to a value obtained by dividing a value (nm) of Re(λ) measured by the above-described method for a liquid crystal cured layer produced using the rod-like liquid crystal compound by a value (nm) of a film thickness of the liquid crystal cured layer. As the liquid crystal cured layer to be measured, that is, the liquid crystal cured layer produced using the rod-like liquid crystal compound, a liquid crystal cured layer produced by the following procedure is used.

That is, a liquid crystal composition L having the following formulation is applied onto a glass substrate including a rubbing-treated polyimide alignment film (SE-150 manufactured by Nissan Chemical Industries, Ltd.) by spin coating.

Next, the coating film is heated and aligned at a temperature at which liquid crystallinity is exhibited, thereby forming a liquid crystal layer.

Next, the liquid crystal layer is cooled from the temperature at which the liquid crystallinity is exhibited to a temperature 40° C. lower than the temperature, and alignment is fixed with ultraviolet irradiation of 1,000 mJ/cm² to produce a liquid crystal cured layer.

Liquid crystal composition L

| | |
|---|---|
| Rod-like liquid crystal compound | 15.00 parts by mass |
| Photopolymerization initiator (IRGACURE 819, manufactured | 0.45 parts by mass |
| by BASF) | |
| Fluorine-containing compound A shown below | 0.12 parts by mass |
| Chloroform | 35.00 parts by mass |

Fluorine-containing compound A

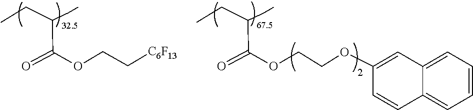

In the present invention, from the reason that the aligning properties of the liquid crystal cured layer are more favorable, it is preferable that the above-described liquid crystal compound is a compound represented by Formula (III).

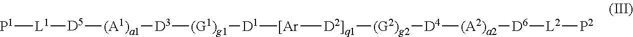

In Formula (III), a1, a2, g1, and g2 each independently represent 0 or 1. Here, at least one of a1 or g1 represents 1 and at least one of a2 or g2 represents 1.

In addition, q1 represents 1 or 2.

In addition, D¹, D², D³, D⁴, D⁵, and D⁶ each independently represent a single bond, —CO—, —O—, —S—, —C(═S)—, —CR¹R²—, —CR³—CR⁴—, —NR⁵—, or a divalent linking group consisting of a combination of two or more of these groups, where R¹ to R⁵ each independently represent a hydrogen atom, a fluorine atom, or an alkyl group having 1 to 12 carbon atoms. Here, in a case where q1 is 2, a plurality of D²'s may be the same or different from each other.

In addition, G¹ and G² each independently represent an aromatic ring having 6 to 20 carbon atoms, which may have a substituent, or a divalent alicyclic hydrocarbon group having 5 to 20 carbon atoms, which may have a substituent, where one or more of —CH₂—'s constituting the alicyclic hydrocarbon group may be replaced with —O—, —S—, or —NH—.

In addition, A¹ and A² each independently represent an aromatic ring having 6 to 20 carbon atoms, which may have a substituent, or a divalent alicyclic hydrocarbon group having 5 to 20 carbon atoms, which may have a substituent, where one or more of —CH₂—'s constituting the alicyclic hydrocarbon group may be replaced with —O—, —S—, or —NH—.

In addition, L¹ and L² each independently represent a single bond or a divalent aliphatic hydrocarbon group having 1 to 20 carbon atoms. Here, one or more of —CH₂—'s constituting the aliphatic hydrocarbon group may be replaced with —O—, —S—, —NH—, —N(Q)-, or —CO—. Q represents a substituent.

In addition, P¹ and P² each independently represent a monovalent organic group, where at least one of P¹ or P² represents a polymerizable group. Here, in a case where Ar is an aromatic ring represented by Formula (Ar-3) described later, at least one of P¹ or P², or P³ or P⁴ in Formula (Ar-3) represents a polymerizable group.

In addition, Ar represents an aromatic ring having 6 to 20 carbon atoms, which may have a substituent, or a divalent alicyclic hydrocarbon group having 5 to 20 carbon atoms, which may have a substituent, where one or more of —CH₂—'s constituting the alicyclic hydrocarbon group may be replaced with —O—, —S—, or —NH—. Here, in a case where q1 is 2, a plurality of Ar's may be the same or different from each other.

In Formula (III), it is preferable that all of a1, a2, g1, and g2 are 1 for the reason that the liquid crystal composition easily exhibits a liquid crystalline state of a smectic phase.

In addition, it is preferable that both a1 and a2 are 0 and both g1 and g2 are 1 for the reason that durability of the liquid crystal cured layer to be formed is improved.

In Formula (III), q1 is preferably 1.

In Formula (III), examples of the divalent linking group represented by one aspect of D¹, D², D³, D⁴, D⁵, and D⁶ include —CO—, —O—, —CO—O—, —C(═S)O—, —CR¹R²—, —CR¹R²—CR¹R²—, —O—CR¹R²—, —CR¹R²—O—CR¹R²—, —CO—O—CR¹R²—, —O—CO—CR¹R²—, —CR¹R²—O—CO—CR¹R²—, —CR¹R²—CO—O—CR¹R²—, —NR⁵—CR¹R²—, and —CO—NR⁵—. R¹, R², and R⁵ each independently represent a hydrogen atom, a fluorine atom, or an alkyl group having 1 to 12 carbon atoms.

Among these, any of —CO—, —O—, or —CO—O— is preferable.

In Formula (III), examples of the aromatic ring having 6 to 20 carbon atoms, represented by one aspect of G¹ and G², include aromatic hydrocarbon rings such as a benzene ring, a naphthalene ring, an anthracene ring, and a phenanthroline ring; and aromatic heterocyclic rings such as a furan ring, a pyrrole ring, a thiophene ring, a pyridine ring, a thiazole ring, and a benzothiazole ring. Among these, a benzene ring (for example, a 1,4-phenyl group) is preferable.

In Formula (III), the divalent alicyclic hydrocarbon group having 5 to 20 carbon atoms, represented by one aspect of G¹ and G², is preferably a 5-membered ring or a 6-membered ring. In addition, the alicyclic hydrocarbon group may be saturated or unsaturated, but a saturated alicyclic hydrocarbon group is preferable. As the divalent alicyclic hydrocarbon group represented by G¹ and G², for example, the description of paragraph of JP2012-21068A can be referred to, the contents of which are incorporated herein by reference.

In the present invention, G¹ and G² in Formula (III) are each preferably a cycloalkane ring for the reason that durability of the liquid crystal cured layer to be formed is improved.

Specific examples of the cycloalkane ring include a cyclohexane ring, a cycloheptane ring, a cyclooctane ring, a cyclododecane ring, and a cyclodocosane ring.

Among these, a cyclohexane ring is preferable, a 1,4-cyclohexylene group is more preferable, and a trans-1,4-cyclohexylene group is still more preferable.

In addition, with regard to G¹ and G² in Formula (III), examples of the substituent which may be included in the aromatic ring having 6 to 20 carbon atoms and the divalent alicyclic hydrocarbon group having 5 to 20 carbon atoms include the substituents described in the above substituent group A; and among these, an alkyl group, an alkoxy group, an alkoxycarbonyl group, an alkylcarbonyloxy group, or a halogen atom is preferable.

In Formula (III), examples of the aromatic ring having 6 to 20 carbon atoms, represented by one aspect of A¹ and A², include the same aromatic rings as those described for G¹ and G² in Formula (III).

In addition, in Formula (III), examples of the divalent alicyclic hydrocarbon group having 5 to 20 carbon atoms, represented by one aspect of A¹ and A², include the same groups as those described for G¹ and G² in Formula (III).

With regard to A¹ and A², examples of the substituent which may be included in the aromatic ring having 6 to 20 carbon atoms and the divalent alicyclic hydrocarbon group having 5 to 20 carbon atoms include the substituents described in the above substituent group A; and among these, an alkyl group, an alkoxy group, an alkoxycarbonyl group, an alkylcarbonyloxy group, or a halogen atom is preferable.

Examples of the divalent aliphatic hydrocarbon group having 1 to 20 carbon atoms, represented by one aspect of L¹ and L² in Formula (III), include a linear or branched alkylene group having 1 to 20 carbon atoms, a linear or branched alkenylene group having 1 to 20 carbon atoms, and a linear or branched alkynylene group having 1 to 20 carbon atoms.

As the linear or branched alkylene group having 1 to 20 carbon atoms, an alkylene group having 1 to 12 carbon atoms is preferable and an alkylene group having 1 to 10 carbon atoms is more preferable; and suitable examples thereof include a methylene group, an ethylene group, a propylene group, a butylene group, a pentylene group, and a hexylene group.

As the linear or branched alkenylene group having 1 to 20 carbon atoms, an alkenylene group having 2 to 10 carbon atoms is preferable and an alkenylene group having 2 to 4 carbon atoms is more preferable; and suitable examples thereof include an ethenylene group.

As the linear or branched alkynylene group having 1 to 20 carbon atoms, an alkynylene group having 2 to 10 carbon atoms is preferable and an alkynylene group having 2 to 4 carbon atoms is more preferable; and suitable examples thereof include an ethynylene group.

As described above, one or more of —CH₂—'s constituting the aliphatic hydrocarbon group may be replaced with —O—, —S—, —NH—, —N(Q)-, or —CO—; and examples of the substituent represented by Q include the substituents described in the above substituent group A. Among these, an alkyl group, an alkoxy group, an alkoxycarbonyl group, an alkylcarbonyloxy group, or a halogen atom is preferable.

In Formula (III), examples of the monovalent organic group represented by P¹ and P² include the substituents described in the above substituent group A; and among these, examples thereof include an alkyl group, an aryl group, a heteroaryl group, an alkoxy group, a cyano group, and a carboxy group.

The alkyl group may be linear, branched, or cyclic, but is preferably linear. The number of carbon atoms in the alkyl group is preferably 1 to 30, more preferably 1 to 20, and still more preferably 1 to 10.

In addition, the aryl group may be monocyclic or polycyclic, but is preferably monocyclic. The number of carbon atoms in the aryl group is preferably 6 to 25 and more preferably 6 to 10.

In addition, the heteroaryl group may be monocyclic or polycyclic. The number of heteroatoms constituting the heteroaryl group is preferably 1 to 3. The heteroatom constituting the heteroaryl group is preferably a nitrogen atom, a sulfur atom, or an oxygen atom. The number of carbon atoms in the heteroaryl group is preferably 6 to 18 and more preferably 6 to 12.

In addition, the alkyl group, the aryl group, and the heteroaryl group may be unsubstituted or may have a substituent. Examples of the substituent include the substituents described in the above substituent group A; and among these, an alkyl group, an alkoxy group, an alkoxycarbonyl group, an alkylcarbonyloxy group, or a halogen atom is preferable.

In Formula (III), the polymerizable group represented by at least one of P¹ or P² is not particularly limited, but is preferably a polymerizable group capable of radical polymerization or cationic polymerization.

A known radically polymerizable group can be used as the radically polymerizable group, and suitable examples thereof include an acryloyloxy group or a methacryloyloxy group. In this case, it is known that the acryloyloxy group generally has a high polymerization rate, and from the viewpoint of improving productivity, the acryloyloxy group is preferable. However, the methacryloyloxy group can also be used as the polymerizable group.

A known cationically polymerizable group can be used as the cationically polymerizable group, and specific examples thereof include an alicyclic ether group, a cyclic acetal group, a cyclic lactone group, a cyclic thioether group, a spiro orthoester group, and a vinyloxy group. Among these, an alicyclic ether group or a vinyloxy group is suitable, and an epoxy group, an oxetanyl group, or a vinyloxy group is particularly preferable.

Examples of a particularly preferred polymerizable group include a polymerizable group represented by any one of Formulae (P-1) to (P-20).

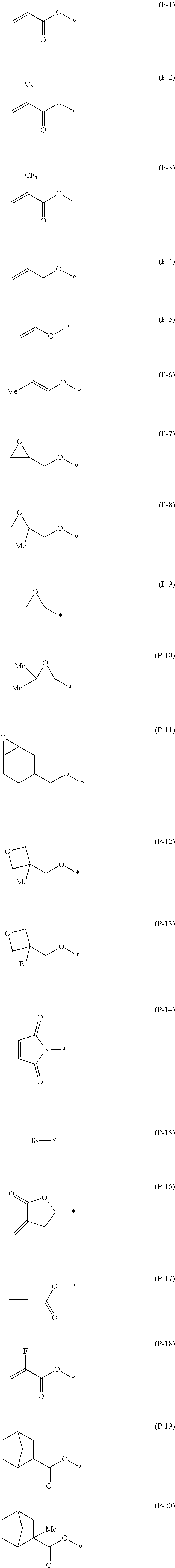

In Formula (III), for the reason that durability of the liquid crystal cured layer to be formed is improved, any of P¹ and P² in Formula (III) is preferably a polymerizable group, and more preferably an acryloyloxy group or a methacryloyloxy group.

On the other hand, in Formula (III), examples of the aromatic ring having 6 to 20 carbon atoms, represented by one aspect of Ar, include the same aromatic rings as those described in G¹ and G² in Formula (III).

In addition, in Formula (III), examples of the divalent alicyclic hydrocarbon group having 5 to 20 carbon atoms, represented by one aspect of Ar, include the same groups as those described for G¹ and G² in Formula (III).

With regard to Ar, examples of the substituent which may be included in the aromatic ring having 6 to 20 carbon atoms and the divalent alicyclic hydrocarbon group having 5 to 20 carbon atoms include the substituents described in the above substituent group A; and among these, an alkyl group, an alkoxy group, an alkoxycarbonyl group, an alkylcarbonyloxy group, or a halogen atom is preferable.

In the present invention, from the reason that the aligning properties of the liquid crystal cured layer are more favorable, it is preferable that the above-described liquid crystal compound is a compound having any aromatic ring selected from the group consisting of groups represented by Formulae (Ar-1) to (Ar-5), and it is more preferable that the above-described liquid crystal compound is represented by Formula (III) described and Ar in Formula (III) represents any aromatic ring selected from the group consisting of groups represented by Formulae (Ar-1) to (Ar-5). In Formulae (Ar-1) to (Ar-5), * represents a bonding position; but in a case where Ar in Formula (III) represents any aromatic ring selected from the group consisting of groups represented by Formulae (Ar-1) to (Ar-5), * represents a bonding position to D¹ or D².

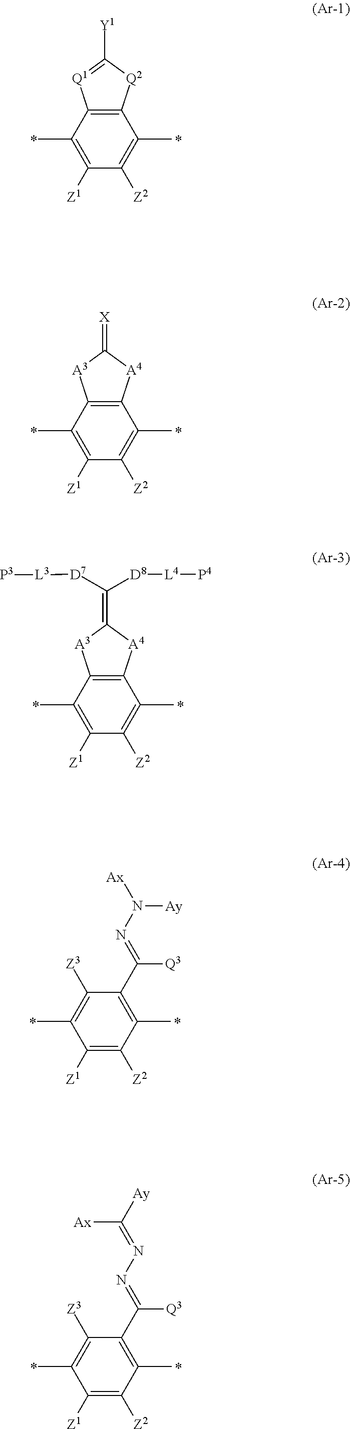

In Formula (Ar-1), Q¹ represents N or CH, Q² represents —S—, —O—, or —N(R⁶)—, where R⁶ represents a hydrogen atom or an alkyl group having 1 to 6 carbon atoms, Y¹ represents an aromatic hydrocarbon group having 6 to 12 carbon atoms, which may have a substituent, an aromatic heterocyclic group having 3 to 12 carbon atoms, which may have a substituent, or an alicyclic hydrocarbon group having 6 to 20 carbon atoms, which may have a substituent, and one or more of —CH₂—'s constituting the alicyclic hydrocarbon group may be replaced with —O—, —S—, or —NH—.

Examples of the alkyl group having 1 to 6 carbon atoms, represented by R⁶, include a methyl group, an ethyl group, a propyl group, an isopropyl group, a n-butyl group, an isobutyl group, a sec-butyl group, a tert-butyl group, a n-pentyl group, and a n-hexyl group.

Examples of the aromatic hydrocarbon group having 6 to 12 carbon atoms, represented by Y¹, include aryl groups such as a phenyl group, a 2,6-diethylphenyl group, and a naphthyl group.

Examples of the aromatic heterocyclic group having 3 to 12 carbon atoms, represented by Y¹, include a heteroaryl group such as a thienyl group, a thiazolyl group, a furyl group, and a pyridyl group; and a group obtained by removing one hydrogen atom from any of an indole ring, a benzofuran ring, a benzothiophene ring, a benzimidazole ring, a benzothiazole ring, or a benzoxazole ring. Among these, as the aromatic heterocyclic group having 3 to 12 carbon atoms, represented by Y¹, a group obtained by removing one hydrogen atom from a benzofuran ring or a benzothiazole ring is preferable.

Examples of the alicyclic hydrocarbon group having 6 to 20 carbon atoms, represented by Y¹, include a cyclohexylene group, a cyclopentylene group, a norbornylene group, and an adamantylene group.

In addition, examples of the substituent which may be included in Y¹ include the substituents described in the above substituent group A; and among these, an alkyl group, an alkoxy group, an alkoxycarbonyl group, an alkylcarbonyloxy group, or a halogen atom is preferable.

In addition, in Formulae (Ar-1) to (Ar-5), Z¹, Z², and Z³ each independently represent a hydrogen atom, a monovalent aliphatic hydrocarbon group having 1 to 20 carbon atoms, a monovalent alicyclic hydrocarbon group having 3 to 20 carbon atoms, a monovalent aromatic hydrocarbon group having 6 to 20 carbon atoms, a monovalent aromatic heterocyclic group having 6 to 20 carbon atoms, a halogen atom, a cyano group, a nitro group, —OR⁷, —NR⁸R⁹, —SR¹⁰, —COOR¹¹, or —COR¹², where R⁷ to R¹² each independently represent a hydrogen atom or an alkyl group having 1 to 6 carbon atoms and Z¹ and Z² may be bonded to each other to form an aromatic ring.

As the monovalent aliphatic hydrocarbon group having 1 to 20 carbon atoms, an alkyl group having 1 to 15 carbon atoms is preferable, an alkyl group having 1 to 8 carbon atoms is more preferable; and specifically, a methyl group, an ethyl group, an isopropyl group, a tert-pentyl group (1,1-dimethylpropyl group), a tert-butyl group, or 1,1-dimethyl-3,3-dimethyl-butyl group is still more preferable and a methyl group, an ethyl group, or a tert-butyl group is particularly preferable.

Examples of the monovalent alicyclic hydrocarbon group having 3 to 20 carbon atoms include monocyclic saturated hydrocarbon groups such as a cyclopropyl group, a cyclobutyl group, a cyclopentyl group, a cyclohexyl group, a cycloheptyl group, a cyclooctyl group, a cyclodecyl group, a methylcyclohexyl group, and an ethylcyclohexyl group; monocyclic unsaturated hydrocarbon groups such as a cyclobutenyl group, a cyclopentenyl group, a cyclohexenyl group, a cycloheptenyl group, a cyclooctenyl group, a cyclodecenyl group, a cyclopentadienyl group, a cyclohexadienyl group, a cyclooctadienyl group, and a cyclodecadiene group; and polycyclic hydrocarbon groups such as a bicyclo[2.2.1]heptyl group, a bicyclo[2.2.2]octyl group, a tricyclo[5.2.1.0^{2,6}]decyl group, a tricyclo[3.3.1.1^{3,7}]decyl group, a tetracyclo[6.2.1.1^{3,6}.0^{2,7}]dodecyl group, and an adamantyl group.

Specific examples of the monovalent aromatic hydrocarbon group having 6 to 20 carbon atoms include a phenyl group, a 2,6-diethylphenyl group, a naphthyl group, and a biphenyl group, and an aryl group having 6 to 12 carbon atoms (particularly, a phenyl group) is preferable.

Specific examples of the monovalent aromatic heterocyclic group having 6 to 20 carbon atoms include a 4-pyridyl group, a 2-furyl group, a 2-thienyl group, a 2-pyrimidinyl group, and a 2-benzothiazolyl group.

Examples of the halogen atom include a fluorine atom, a chlorine atom, a bromine atom, and an iodine atom, and among these, a fluorine atom, a chlorine atom, or a bromine atom is preferable.

On the other hand, specific examples of the alkyl group having 1 to 6 carbon atoms represented by one aspect of R⁷ to R¹⁰ include a methyl group, an ethyl group, a propyl group, an isopropyl group, a n-butyl group, an isobutyl group, a sec-butyl group, a tert-butyl group, a n-pentyl group, and a n-hexyl group.

As described above, Z¹ and Z² may be bonded to each other to form an aromatic ring, and examples of a structure in a case where Z¹ and Z² in Formula (Ar-1) are bonded to each other to form an aromatic ring include a group represented by Formula (Ar-1a). In Formula (Ar-1a), * represents a bonding position to D¹ or D² in Formula (III) described above.

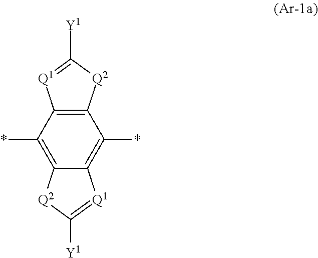

Here, in Formula (Ar-1a), examples of Q¹, Q², and Y¹ include the same as those described in Formula (Ar-1) above.

In addition, in Formulae (Ar-2) and (Ar-3), A³ and A⁴ each independently represent a group selected from the group consisting of —O—, —N(R¹³)—, —S—, and —CO—, and R¹³ represents a hydrogen atom or a substituent.

Examples of the substituent represented by R¹³ include the substituents described in the above substituent group A; and among these, an alkyl group, an alkoxy group, an alkoxycarbonyl group, an alkylcarbonyloxy group, or a halogen atom is preferable.

In addition, in Formula (Ar-2), X represents a non-metal atom of Group 14 to Group 16. Here, a hydrogen atom or a substituent may be bonded to the non-metal atom.

In addition, examples of the non-metal atom of Groups 14 to 16, represented by X, include an oxygen atom, a sulfur atom, a nitrogen atom to which a hydrogen atom or a substituent is bonded [═N—R^{N1}, R^{N1} represents a hydrogen atom or a substituent], and a carbon atom to which a hydrogen atom or a substituent is bonded [═C—(R^{C1})₂, R^{C1} represents a hydrogen atom or a substituent].

Examples of the substituent include the substituents described in the above substituent group A; and among these, examples thereof include an alkyl group, an alkoxy group, an alkyl-substituted alkoxy group, a cyclic alkyl group, an aryl group (for example, a phenyl group, a naphthyl group, or the like), a cyano group, an amino group, a nitro group, an alkylcarbonyl group, a sulfo group, and a hydroxyl group.

In addition, in Formula (Ar-3), D⁷ and D⁸ each independently represent a single bond, —CO—, —O—, —S—, —C(═S)—, —CR¹R²—, —CR³═CR⁴—, —NR⁵—, or a divalent linking group consisting of a combination of two or more of these groups, where R¹ to R⁵ each independently represent a hydrogen atom, a fluorine atom, or an alkyl group having 1 to 12 carbon atoms.

Here, specific examples of the divalent linking group include the same groups as those described for D¹, D², D³, D⁴, D⁵, and D⁶ in Formula (III) above.

In addition, in Formula (Ar-3), L³ and L⁴ each independently represent a single bond or a divalent aliphatic hydrocarbon group having 1 to 20 carbon atoms. Here, one or more of —CH₂—'s constituting the aliphatic hydrocarbon group may be replaced with —O—, —S—, —NH—, —N(Q)-, or —CO—. Q represents a substituent. Examples of the substituent include the substituents described in the above substituent group A; and among these, an alkyl group, an alkoxy group, an alkoxycarbonyl group, an alkylcarbonyloxy group, or a halogen atom is preferable.

Here, examples of the aliphatic hydrocarbon group include the same groups as those described for L¹ and L² in Formula (III) above.

In addition, in Formula (Ar-3), P³ and P⁴ each independently represent a monovalent organic group, where at least one of P³ or P⁴ represents a polymerizable group.

Examples of the monovalent organic group include the same groups as those described for P¹ and P² in Formula (III) above.

In addition, examples of the polymerizable group include the same groups as those described for P¹ and P² in Formula (III) above.

In addition, in Formulae (Ar-4) and (Ar-5), Ax represents an organic group having 2 to 30 carbon atoms, which has at least one aromatic ring selected from the group consisting of an aromatic hydrocarbon ring and an aromatic heterocyclic ring.

In addition, in Formulae (Ar-4) and (Ar-5), Ay represents a hydrogen atom, an alkyl group having 1 to 12 carbon atoms, which may have a substituent, or an organic group having 2 to 30 carbon atoms which has at least one aromatic ring selected from the group consisting of an aromatic hydrocarbon ring and an aromatic heterocyclic ring.

Here, the aromatic rings in Ax and Ay may have a substituent, and Ax and Ay may be bonded to each other to form a ring.

In addition, Q³ represents a hydrogen atom or an alkyl group having 1 to 6 carbon atoms, which may have a substituent.

Examples of Ax and Ay include those described in paragraphs to of WO2014/010325A.

In addition, specific examples of the alkyl group having 1 to 20 carbon atoms, represented by Q³, include a methyl group, an ethyl group, a propyl group, an isopropyl group, a n-butyl group, an isobutyl group, a sec-butyl group, a tert-butyl group, a n-pentyl group, and a n-hexyl group; and examples of the substituent include the substituents described in the above substituent group A. Among these, an alkyl group, an alkoxy group, an alkoxycarbonyl group, an alkylcarbonyloxy group, or a halogen atom is preferable.

Examples of the compound represented by Formula (III) include polymerizable compounds described in paragraphs to of JP2019-139222A, polymerizable compounds described in paragraphs to of WO2019/160014A, polymerizable compounds described in paragraph of WO2019/160016A, compounds (1-1) to (1-19) represented by the following formulae; and compounds (2-1) to (2-5) represented by the following formulae. A group adjacent to an acryloyloxy group in a structure of the compound (1-14) represents a propylene group (a group obtained by substituting a methyl group with an ethylene group), and the compound (1-14) represents a mixture of regioisomers in which the positions of the methyl groups are different.

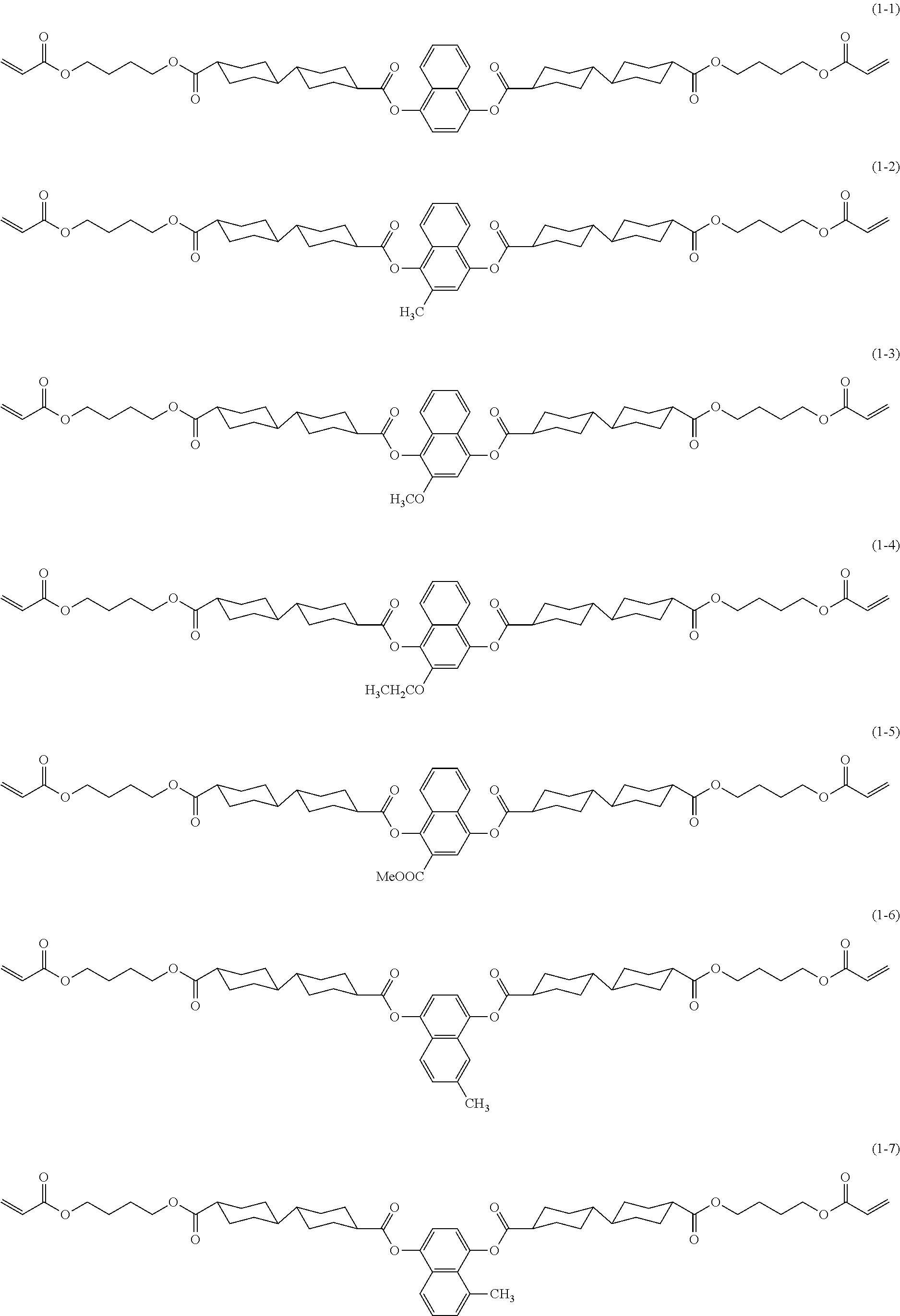

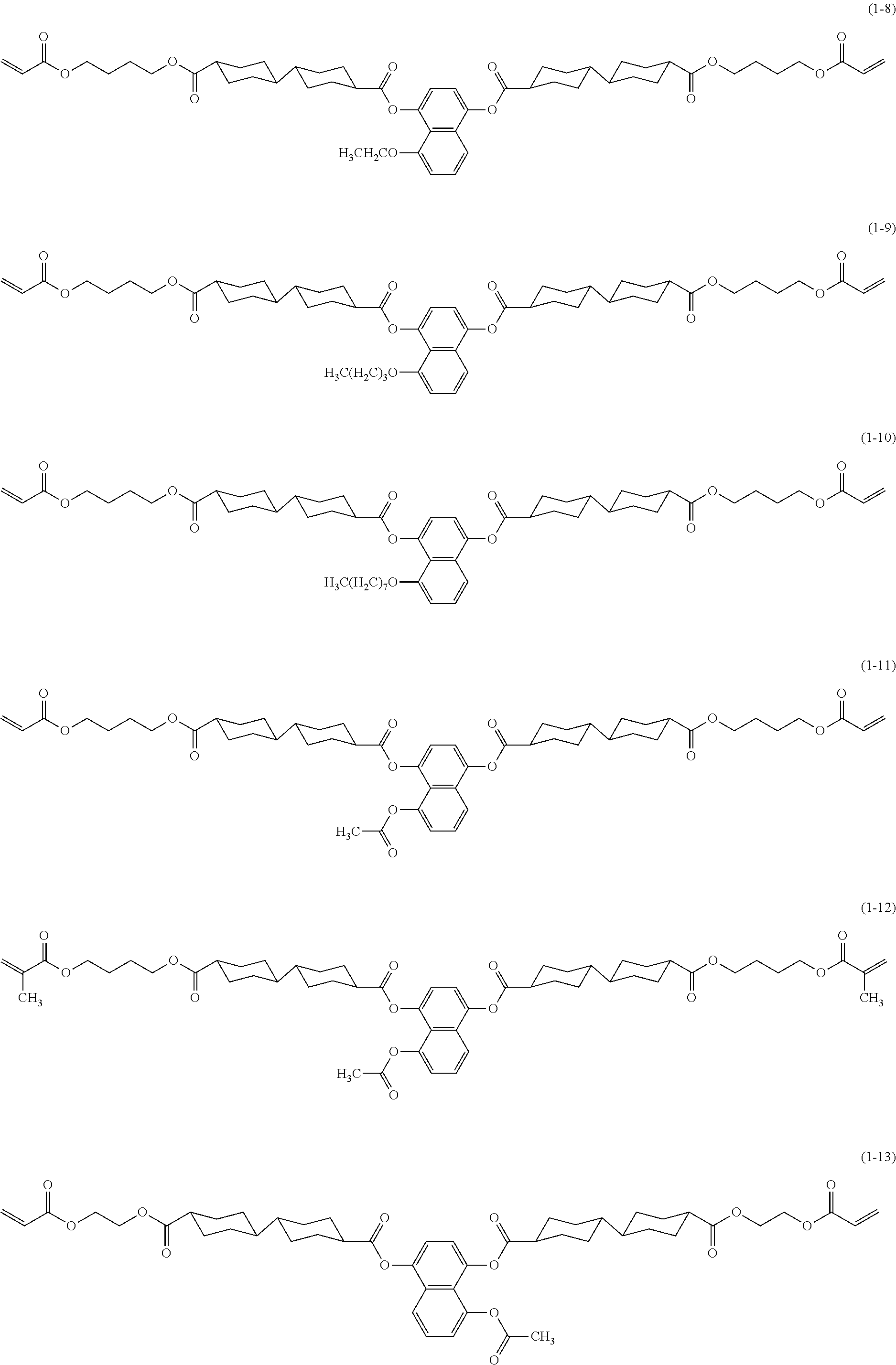

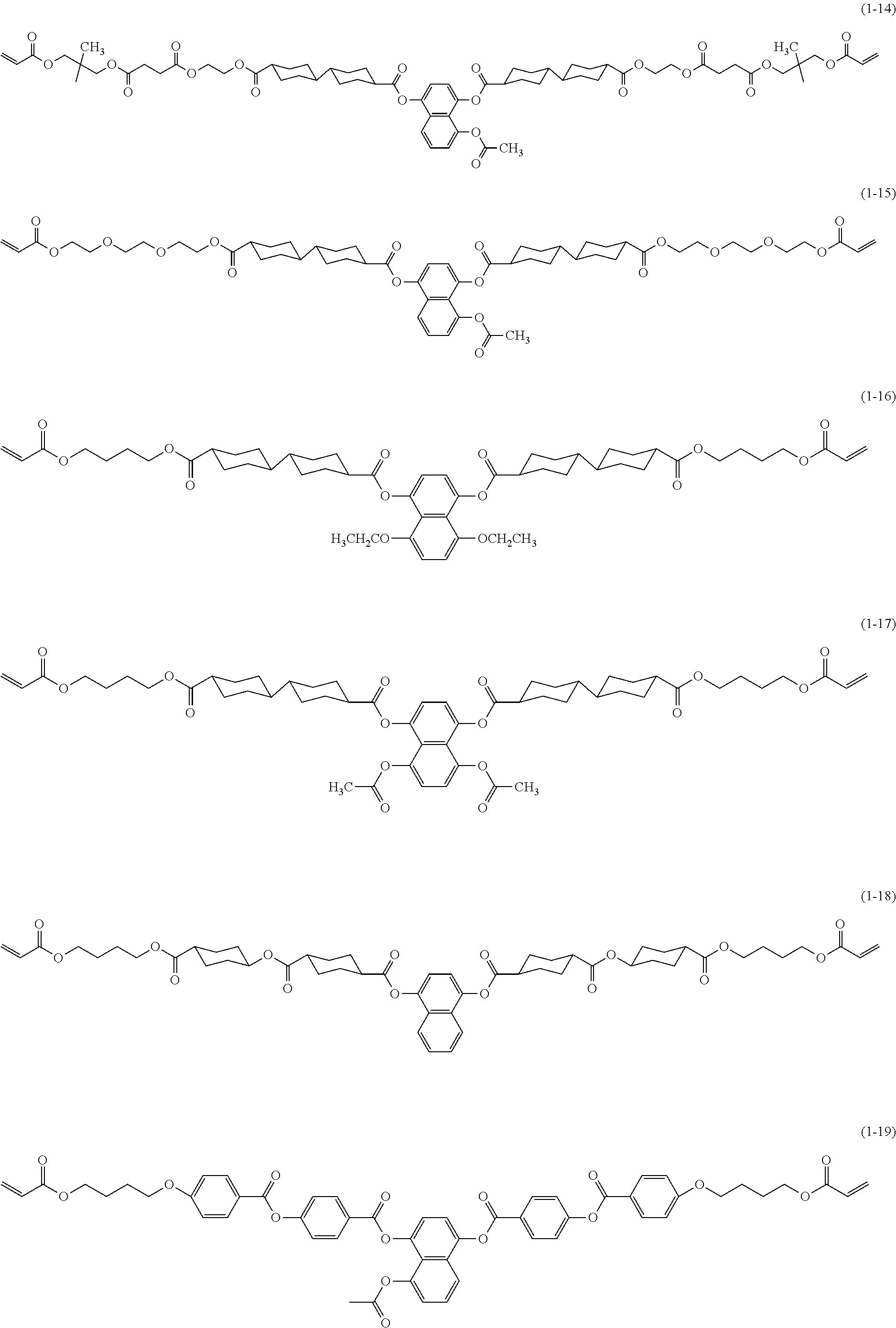

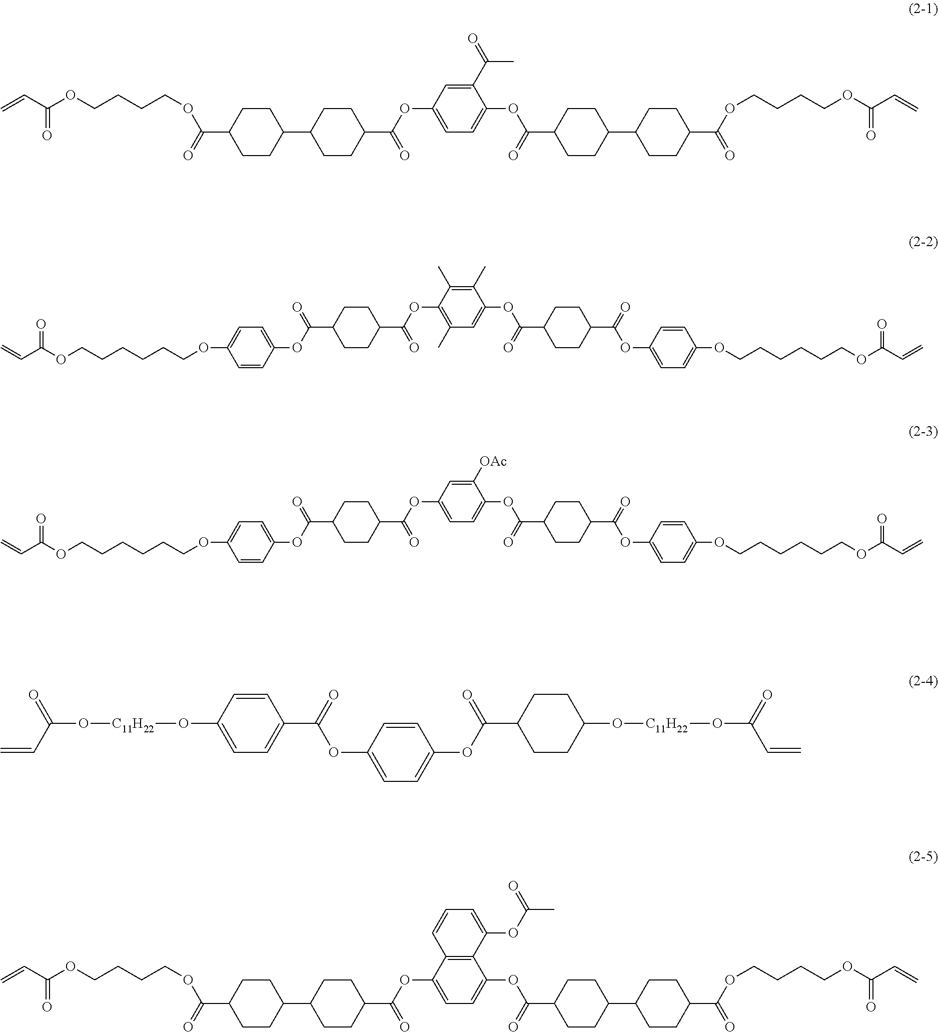

In addition, examples of the compound represented by Formula (III) include a compound represented by General Formula (1) described in JP2010-084032A (particularly, a compound described in paragraphs [0067] to [0073]), a compound represented by General Formula (II) described in JP2016-053709A (particularly, a compound described in paragraphs [0036] to [0043]), a compound represented by General Formula (1) described in JP2016-081035A (particularly, a compound described in paragraphs [0043] to [0055]), and a compound described in paragraphs [0025] to [0056] of WO2021/060427A.

### <Other Polymerizable Compounds>

From the viewpoint of alignment temperature and solubility, it is preferable that the liquid crystal composition contains a polymerizable compound having one or more polymerizable groups, in addition to the above-described liquid crystal compound.

Here, the polymerizable group included in the other polymerizable compounds is not particularly limited; and suitable examples thereof include the polymerizable groups represented by any of Formulae (P-1) to (P-20) described above.

As the other polymerizable compounds, from the reason that the durability of the liquid crystal cured layer to be formed is more improved, other polymerizable compounds having two to four polymerizable groups are preferable, and other polymerizable compounds having two polymerizable groups are more preferable.

Examples of the other polymerizable compounds include compounds represented by Formulae (M1), (M2), and (M3) described in paragraphs to of JP2014-077068A, which have liquid crystallinity, and more specifically, specific examples described in paragraphs to of the same publication.

### <Polymerization Initiator>

The liquid crystal composition preferably contains a polymerization initiator.

The polymerization initiator to be used is preferably a photopolymerization initiator capable of initiating a polymerization reaction by irradiation with ultraviolet rays.

Examples of the photopolymerization initiator include α-carbonyl compounds (described in U.S. Pat. Nos. 2,367,661A and 2,367,670A), acyloin ethers (described in U.S. Pat. No. 2,448,828A), α-hydrocarbon-substituted aromatic acyloin compounds (described in U.S. Pat. No. 2,722,512A), polynuclear quinone compounds (described in U.S. Pat. Nos. 3,046,127A and 2,951,758A), combinations of triarylimidazole dimer and p-aminophenyl ketone (described in U.S. Pat. No. 3,549,367A), acridine and phenazine compounds (described in JP1985-105667A (JP-S60-105667A) and U.S. Pat. No. 4,239,850A), oxadiazole compounds (described in U.S. Pat. No. 4,212,970A), and acyl phosphine oxide compounds (described in JP1988-40799B (JP-S63-40799B), JP1993-29234B (JP-H05-29234B), JP1998-95788A (JP-H10-95788A), and JP1998-29997A (JP-H10-29997A)).

In addition, in the present invention, it is also preferable that the polymerization initiator is an oxime-type polymerization initiator; and specific examples of the polymerization initiator include initiators described in paragraphs [0049] to [0052] of WO2017/170443A.

### <Solvent>

From the viewpoint of workability or the like to form the liquid crystal cured layer, the liquid crystal composition preferably contains a solvent.

Specific examples of the solvent include ketones (for example, acetone, 2-butanone, methyl ethyl ketone, methyl isobutyl ketone, cyclohexanone, cyclopentanone, and the like), ethers (for example, dioxane, tetrahydrofuran, and the like), aliphatic hydrocarbons (for example, hexane and the like), alicyclic hydrocarbons (for example, cyclohexane and the like), aromatic hydrocarbons (for example, toluene, xylene, trimethylbenzene, and the like), halogenated carbons (for example, dichloromethane, dichloroethane, dichlorobenzene, chlorotoluene, and the like), esters (for example, methyl acetate, ethyl acetate, butyl acetate, and the like), water, alcohols (for example, ethanol, isopropanol, butanol, cyclohexanol, and the like), cellosolves (for example, methyl cellosolve, ethyl cellosolve, and the like), cellosolve acetates, sulfoxides (for example, dimethyl sulfoxide and the like), and amides (for example, dimethyl formamide, dimethyl acetamide, and the like), and these solvents may be used alone or in a combination of two or more kinds thereof.

### <Leveling Agent>

From the viewpoint of easily controlling alignment, the liquid crystal composition preferably contains a leveling agent.

The leveling agent is preferably a fluorine-based leveling agent or a silicon-based leveling agent for a reason that it has a high leveling effect with respect to the addition amount, and the leveling agent is more preferably a fluorine-based leveling agent from the viewpoint that it is less likely to cause bleeding (bloom or bleed).

Specific examples of the leveling agent include compounds described in paragraphs [0079] to [0102] of JP2007-069471A, a compound represented by General Formula (I) described in JP2013-047204A (in particular, compounds described in paragraphs [0020] to [0032]), a compound represented by General Formula (I) described in JP2012-211306A (in particular, compounds described in paragraphs [0022] to [0029]), a liquid crystal alignment accelerator represented by General Formula (I) described in JP2002-129162A (in particular, compounds described in paragraphs [0076] to [0078] and [0082] to [0084]), and compounds represented by General Formulae (I), (II), and (III) described in JP2005-099248A (in particular, compounds described in paragraphs [0092] to [0096]). The leveling agent may also function as an alignment control agent described later.

### <Alignment Control Agent>

The liquid crystal composition can contain an alignment control agent as necessary.

With the alignment control agent, in addition to the homogeneous alignment, various alignment states such as homeotropic alignment (vertical alignment), tilt alignment, hybrid alignment, and cholesteric alignment can be formed, and specific alignment states can be controlled and achieved more uniformly and more accurately.

As an alignment control agent which accelerates the homogeneous alignment, for example, a low-molecular-weight alignment control agent or a high-molecular-weight alignment control agent can be used.

With regard to the low-molecular-weight alignment control agent, reference can be made to the description in, for example, paragraphs to [0009] of [0083] of JP2002-20363A, paragraphs [0111] to [0120] of JP2006-106662A, and paragraphs [0021] to [0029] of JP2012-211306A, the contents of which are incorporated herein by reference.

In addition, with regard to the high-molecular-weight alignment control agent, reference can be made to the description in, for example, paragraphs [0021] to [0057] of JP2004-198511A and paragraphs [0121] to [0167] of JP2006-106662A, the contents of which are incorporated herein by reference.

In addition, examples of the alignment control agent which forms or accelerates the homeotropic alignment include a boronic acid compound and an onium salt compound, and specifically, reference can be made to compounds described in paragraphs [0023] to [0032] of JP2008-225281A, paragraphs [0052] to [0058] of JP2012-208397A, paragraphs [0024] to [0055] of JP2008-026730A, paragraphs [0043] to [0055] of JP2016-193869A, and the like, the contents of which are incorporated herein by reference.

On the other hand, the cholesteric alignment can be achieved by adding a chiral agent to the polymerizable liquid crystal composition, and it is possible to control the direction of revolution of the cholesteric alignment by its chiral direction.

Incidentally, it is possible to control a pitch of the cholesteric alignment in accordance with an alignment regulating force of the chiral agent.

In a case where an alignment control agent is contained, a content thereof is preferably 0.01% to 10% by mass, and more preferably 0.05% to 5% by mass with respect to the total solid content mass of the composition. In a case where the content is within the range, it is possible to obtain a cured product which has no precipitation or phase separation, alignment defects, or the like, and is uniform and highly transparent while achieving a desired alignment state.

### <Other Components>

The liquid crystal composition may contain components other than the above-described components; and examples thereof include a surfactant, a tilt angle control agent, an alignment assistant, a plasticizer, and a crosslinking agent.

### <Method of Producing Liquid Crystal Cured Layer>

Examples of a method of forming the liquid crystal cured layer include a method of using the above-described liquid crystal composition to obtain a desired alignment state, and then fixing an alignment state by polymerization.

Here, conditions for setting the desired alignment state are not particularly limited; but it is preferable to perform a heat treatment, and it is more preferable to perform a cooling treatment after the heat treatment. From the viewpoint of manufacturing suitability, a heating temperature in the heat treatment is preferably 10° C. to 250° C., more preferably 50° C. to 200° C., and still more preferably 70° C. to 150° C. In addition, a heating time in the heat treatment is preferably 1 to 300 seconds and more preferably 1 to 60 seconds. In addition, a temperature in the cooling treatment after the heat treatment is not particularly limited as long as it is lower than the heating temperature in the heat treatment, but is preferably room temperature (23° C.) to 80° C.

In addition, conditions for the above-described polymerization are not particularly limited, but ultraviolet rays are preferably used in the polymerization by light irradiation. An irradiation amount is preferably 10 mJ/cm² to 50 J/cm², more preferably 20 mJ/cm² to 5 J/cm², still more preferably 30 mJ/cm² to 3 J/cm², and particularly preferably 50 to 1,000 mJ/cm². In order to promote the polymerization reaction, the treatment may be performed under heating conditions.

The liquid crystal cured layer can be formed on any support or alignment film in the optical film described later, or a polarizer in the polarizing plate described later.

The alignment state of the liquid crystal compound in the liquid crystal cured layer may be any of horizontal alignment, vertical alignment, tilt alignment, and twist alignment; and it is preferable that the liquid crystal compound is immobilized in a state of being horizontally aligned with respect to the main surface of the liquid crystal cured layer.

In the present specification, the “horizontal alignment” means that a main surface of the liquid crystal cured layer (or in a case where the liquid crystal cured layer is formed on a member such as a support and an alignment film, a surface of the member) and a major axis direction of the liquid crystal compound are parallel to each other. It is not required for both the main surface of the liquid crystal cured layer and the major axis direction of the liquid crystal compound to be strictly parallel; and in the present specification, the expression means that both the main surface of the liquid crystal cured layer and the major axis direction of the liquid crystal compound are aligned at an angle formed by the major axis direction of the liquid crystal compound and the main surface of the liquid crystal cured layer of less than 10°.

In the liquid crystal cured layer, the angle formed by the major axis direction of the liquid crystal compound and the main surface of the liquid crystal cured layer is preferably 0 to 5°, more preferably 0 to 3°, and still more preferably 0 to 2°.

The liquid crystal cured layer is preferably an optically anisotropic layer, more preferably a positive A-plate or a positive C-plate, and still more preferably a positive A-plate.

Here, the positive A-plate and the positive C-plate are defined as follows.

The positive A-plate satisfies a relationship of Expression (A1) and the positive C-plate satisfies a relationship of Expression (C1), assuming that a refractive index in a film in-plane slow axis direction (in a direction in which an in-plane refractive index is maximum) is defined as nx, a refractive index in an in-plane direction orthogonal to the in-plane slow axis is defined as ny, and a refractive index in a thickness direction is defined as nz. The positive A-plate has an Rth showing a positive value and the positive C-plate has an Rth showing a negative value.

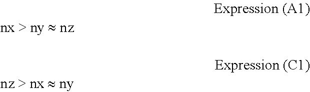

The symbol “≈” encompasses not only a case where both sides are completely the same as each other but also a case where the both sides are substantially the same as each other.

With regard to the positive A-plate, the expression “substantially the same” means that, for example, a case where (ny−nz)×d (in which d is a thickness of a film) is −10 to 10 nm and preferably −5 to 5 nm is also included in “ny≈nz”; and a case where (nx-nz)×d is −10 to 10 nm and preferably −5 to 5 nm is also included in “nx≈nz”. In addition, in the positive C-plate, for example, a case where (nx−ny)×d (in which d is a thickness of a film) is 0 to 10 nm, and preferably 0 to 5 nm is also included in “nx≈ny”.

In a case where the liquid crystal cured layer is the positive A-plate, from the viewpoint that the retardation layer functions as a λ/4 plate, Re(550) is preferably 100 to 180 nm, more preferably 120 to 160 nm, still more preferably 130 to 150 nm, and particularly preferably 130 to 145 nm.

Here, the “λ/4 plate” is a plate having a λ/4 function, specifically, a plate having a function of converting linearly polarized light having a specific wavelength into circularly polarized light (or converting circularly polarized light into linearly polarized light).

In the present invention, a thickness of the liquid crystal cured layer is not particularly limited, but is preferably 0.1 to 10 μm and more preferably 0.5 to 5 μm.

### [Polarizing Plate]

The polarizing plate according to the embodiment of the present invention includes the above-described optical film according to the embodiment of the present invention, and a polarizer.

In addition, in a case where the above-described liquid crystal cured layer is a λ/4 plate (positive A-plate), the polarizing plate according to the embodiment of the present invention can be used as a circularly polarizing plate.

In addition, in the polarizing plate according to the embodiment of the present invention, in a case where the above-described liquid crystal cured layer is a λ/4 plate (positive A-plate), an angle between a slow axis of the λ/4 plate and an absorption axis of the polarizer, which will be described later, is preferably 30° to 60°, more preferably 40° to 50°, still more preferably 42° to 48°, and particularly preferably 45°

Here, the “slow axis” of the λ/4 plate means a direction in which a refractive index in the plane of the λ/4 plate is maximum, and the “absorption axis” of the polarizer means a direction in which an absorbance is highest.

In addition, the polarizing plate according to the embodiment of the present invention can also be used as an optical compensation film for the IPS mode or FFS mode liquid crystal display device.

In a case where the polarizing plate according to the embodiment of the present invention is used as an optical compensation film for the IPS mode or FFS mode liquid crystal display device, the above-described liquid crystal cured layer can be used as at least one plate of a laminate of a positive A-plate and a positive C-plate, and it is preferably a positive A-plate. In this case, it is preferable that the angle between the slow axis of the positive A-plate and the absorption axis of the polarizer described later is orthogonal or parallel, and specifically, the angle between the slow axis of the positive A-plate and the absorption axis of the polarizer described later is more preferably 0° to 5° or 85° to 95°.

In addition, in a case where the polarizing plate according to the embodiment of the present invention has a laminate of the polarizer, the positive C-plate, and the positive A-plate in this order, the angle between the slow axis of the positive A-plate and the absorption axis of the polarizer is still more preferably parallel to each other.

Similarly, in a case where the polarizing plate according to the embodiment of the present invention has a laminate of the polarizer, the positive A-plate, and the positive C-plate in this order, the angle between the slow axis of the positive A-plate and the absorption axis of the polarizer is still more preferably orthogonal to each other.

In a case where the polarizing plate according to the embodiment of the present invention is used in a liquid crystal display device described later, it is preferable that the angle formed by the slow axis of the liquid crystal cured layer and the absorption axis of the polarizer described later is parallel or orthogonal to each other.

In the present specification, the term “parallel” does not require that both the angle formed by the slow axis of the liquid crystal cured layer and the absorption axis of the polarizer are strictly parallel, but means that an angle between one and the other is less than 10°. In addition, in the present specification, the term “orthogonal” does not require that both the angle formed by the slow axis of the liquid crystal cured layer and the absorption axis of the polarizer are strictly orthogonal, but means that an angle between one and the other is more than 80° and less than 100°.

### [Polarizer]

The polarizer included in the polarizing plate according to the embodiment of the present invention is not particularly limited as long as the polarizer is a member having a function of converting light into specific linearly polarized light, and a known absorptive type polarizer and reflective type polarizer in the related art can be used.

An iodine-based polarizer, a dye-based polarizer using a dichroic dye, a polyene-based polarizer, or the like is used as the absorptive type polarizer. The iodine-based polarizer and the dye-based polarizer include a coating type polarizer and a stretching type polarizer, and any one of these polarizers can be applied. However, a polarizer which is produced by allowing polyvinyl alcohol to adsorb iodine or a dichroic dye and performing stretching is preferable.

In addition, examples of a method of obtaining a polarizer by performing stretching and dyeing in a state of a laminated film in which a polyvinyl alcohol layer is formed on a substrate include methods disclosed in JP5048120B, JP5143918B, JP4691205B, JP4751481B, and JP4751486B, and known technologies related to these polarizers can be preferably used.

A polarizer in which thin films having different birefringence are laminated, a wire grid type polarizer, a polarizer in which a cholesteric liquid crystal having a selective reflection range and a ¼ wavelength plate are combined, or the like is used as the reflective type polarizer.

Among these, from the viewpoint of more excellent adhesiveness, a polarizer containing a polyvinyl alcohol-based resin (polymer including —CH₂—CHOH— as a repeating unit; in particular, at least one selected from the group consisting of polyvinyl alcohol and an ethylene-vinyl alcohol copolymer) is preferable.

In the present invention, a thickness of the polarizer is not particularly limited, but is preferably 3 μm to 60 μm, more preferably 5 μm to 30 μm, and still more preferably 5 μm to 15 μm.

### [Pressure Sensitive Adhesive Layer]

The polarizing plate according to the embodiment of the present invention may include a pressure sensitive adhesive layer arranged between the liquid crystal cured layer in the optical film according to the embodiment of the present invention and the polarizer.

The pressure sensitive adhesive layer used for lamination of the liquid crystal cured layer and the polarizer is, for example, a substance in which a ratio (tan δ=G″/G′) of a loss elastic modulus G″ to a storage elastic modulus G′ is 0.001 to 1.5, where G′ and G″ are measured with a dynamic viscoelasticity measurement. Such a substance includes a so-called pressure sensitive adhesive or easily creepable substance. Examples of the pressure sensitive adhesive which can be used in the present invention include a polyvinyl alcohol-based pressure sensitive adhesive, but the pressure sensitive adhesive is not limited thereto.

### [Image Display Device]

The image display device according to the embodiment of the present invention is an image display device including the optical film according to the embodiment of the present invention or the polarizing plate according to the embodiment of the present invention.

A display element used in the image display device is not particularly limited, and examples thereof include a liquid crystal cell, an organic electroluminescent (hereinafter, simply referred to as “EL”) display panel, and a plasma display panel. Among these, a liquid crystal cell or an organic EL display panel is preferable, and a liquid crystal cell is more preferable.

That is, as the image display device, a liquid crystal display device using a liquid crystal cell as the display element or an organic EL display device using an organic EL display panel as the display element is preferable, and the liquid crystal display device is more preferable.

### [Liquid Crystal Display Device]

A liquid crystal display device as an example of the image display device is a liquid crystal display device including the above-described polarizing plate and a liquid crystal cell.

Among polarizing plates provided on both sides of the liquid crystal cell, it is preferable that the above-described polarizing plate is used as a polarizing plate on the front side, and it is more preferable that the above-described polarizing plate is used as polarizing plates on the front and rear sides.

Hereinafter, the liquid crystal cell constituting the liquid crystal display device will be described in detail.

### <Liquid Crystal Cell>

It is preferable that the liquid crystal cell used in the liquid crystal display device is in a vertical alignment (VA) mode, an optically compensated bend (OCB) mode, an in-plane-switching (IPS) mode, a fringe-field-switching (FFS) mode, or a twisted nematic (TN) mode, but is not limited thereto.

In the liquid crystal cell in a TN mode, rod-like liquid crystalline molecules are substantially horizontally aligned at the time of no voltage application and further twisted and aligned at 60° to 120°. The liquid crystal cell in a TN mode is most frequently used as a color TFT liquid crystal display device and is described in a plurality of documents.

In the liquid crystal cell in a VA mode, rod-like liquid crystalline molecules are substantially vertically aligned at the time of no voltage application. The concept of the liquid crystal cell in a VA mode includes (1) a liquid crystal cell in a VA mode in a narrow sense where rod-like liquid crystalline molecules are aligned substantially vertically at the time of no voltage application and substantially horizontally at the time of voltage application (described in JP1990-176625A (JP-H2-176625A)), (2) a liquid crystal cell (in an MVA mode) (SID97, described in Digest of tech. Papers (proceedings) 28 (1997) 845) in which the VA mode is formed to have multi-domain in order to expand the viewing angle, (3) a liquid crystal cell in a mode (n-ASM mode) in which rod-like liquid crystalline molecules are substantially vertically aligned at the time of no voltage application and twistedly multi-domain aligned at the time of voltage application (described in proceedings of Japanese Liquid Crystal Conference, pp. 58 to 59 (1998)), and (4) a liquid crystal cell in a SURVIVAL mode (presented at LCD International 98). In addition, the liquid crystal cell in the VA mode may be any of a patterned vertical alignment (PVA) type, an optical alignment type, or a polymer-sustained alignment (PSA) type. The details of these modes are described in JP2006-215326A and JP2008-538819A.

In an IPS mode liquid crystal cell, rod-like liquid crystal molecules are substantially aligned parallel to a substrate and application of an electric field parallel to a surface of the substrate causes the liquid crystal molecules to respond planarly. In the IPS mode, black display is carried out in a state where no electric field is applied, and absorption axes of a pair of upper and lower polarizing plates are orthogonal to each other. A method of reducing light leakage during black display in an oblique direction and improve the viewing angle using an optical compensation sheet is disclosed in JP1998-54982A (JP-H10-54982A), JP1999-202323A (JP-H11-202323A), JP1997-292522A (JP-H9-292522A), JP1999-133408A (JP-H11-133408A), JP1999-305217A (JP-H11-305217A), JP1998-307291A (JP-H10-307291A), and the like.

### [Organic EL Display Device]

Examples of the organic EL display device which is an example of the image display device include an aspect which includes, from a viewing side, a polarizer, a λ/4 plate consisting of the above-described liquid crystal cured layer (positive A-plate), and an organic EL display panel in this order.

In addition, the organic EL display panel is a display panel formed of an organic EL element obtained by sandwiching an organic light emitting layer (organic electroluminescence layer) between electrodes (between a cathode and an anode). The configuration of the organic EL display panel is not particularly limited, and a known configuration is employed.

### EXAMPLES

Hereinafter, the present invention will be described in more detail with reference to Examples. The materials, amounts used, proportions, treatment contents, treatment procedures, and the like shown in the following examples can be modified as appropriate in the range of not departing from the spirit of the present invention. Therefore, the scope of the present invention should not be construed as being limited to Examples.

### Example 1

### [Production of Substrate 1]

### <Preparation of Core Layer Cellulose Acylate Dope 1>

The following composition was put into a mixing tank and stirred to dissolve the respective components, thereby preparing a core layer cellulose acylate dope 1.

Core layer cellulose acylate dope 1

| | |
|---|---|
| Cellulose acetate having acetyl substitution degree of 2.88 | 100 parts by mass |
| Polyester shown below | 12 parts by mass |
| Durability improver shown below | 4 parts by mass |
| Methylene chloride (first solvent) | 430 parts by mass |
| Methanol (second solvent) | 64 parts by mass |

Polyester (number-average molecular weight: 800) 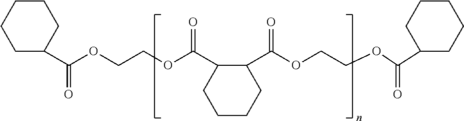
Durability improver

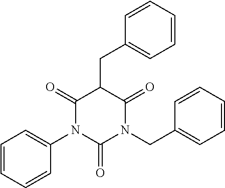 [SMILES: O=C1C(Cc2ccccc2)C(=O)N(c2ccccc2)C(=O)N1Cc1ccccc1]

### <Preparation of Outer Layer Cellulose Acylate Dope 1>

10 parts by mass of the following matting agent dispersion liquid 1 was added to 90 parts by mass of the above-described core layer cellulose acylate dope 1, thereby preparing an outer layer cellulose acylate dope 1.

Matting agent dispersion liquid 1

| | |
|---|---|
| Silica particles having an average particle | 2 parts by mass |
| diameter of 20 nm (AEROSIL R972, | |
| manufactured by Nippon Aerosil Co., Ltd.) | |
| Methylene chloride (first solvent) | 76 parts by mass |
| Methanol (second solvent) | 11 parts by mass |
| Core layer cellulose acylate dope 1 | 1 part by mass |

### <Production of Substrate 1>

The above-described core layer cellulose acylate dope 1 and the above-described outer layer cellulose acylate dope 1 were filtered using a filter paper with an average pore diameter of 34 μm and a sintered metal filter with an average pore diameter of 10 μm. Thereafter, the above-described core layer cellulose acylate dope 1 and the outer layer cellulose acylate dopes 1 on both sides thereof were cast simultaneously on a drum at 20° C. from a casting port in three layers, using a band casting machine.

Subsequently, a film was peeled off from the drum in a state in which a solvent content of the film on the drum was approximately 20% by mass. Both ends of the obtained film in a width direction were fixed with tenter clips, and the film was dried while being stretched 1.1 times in the width direction in a state in which the solvent content of the film was 3% to 15% by mass.

Thereafter, the obtained film was further dried while being transported between rolls of a heat treatment device, thereby producing a cellulose acylate film 1 having a film thickness of 40 μm, which was used as a substrate 1. As a result of measuring a phase difference of the substrate 1, Re=1 nm and Rth=−5 nm were obtained.

### [Production of Liquid Crystal Cured Layer 1]

### <Preparation of Composition 1 for Forming Alignment Film>

A composition 1 for forming an alignment film, having the following formulation, was prepared.

Composition 1 for forming alignment film

| | |
|---|---|
| Copolymer C1 (corresponding to polymer (I)) | 90 parts by mass |
| Copolymer C2 (corresponding to polymer (II)) | 10 parts by mass |
| Thermal acid generator D1 shown below | 3.57 parts by mass |
| Stabilizer DIPEA shown below | 0.36 parts by mass |
| Butyl acetate | 714 parts by mass |
| Methyl ethyl ketone | 476 parts by mass |

Copolymer C1 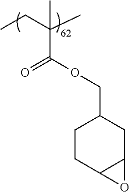 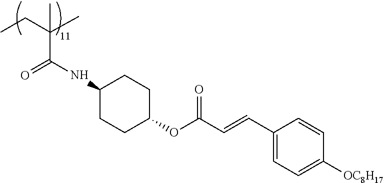 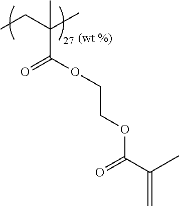
Copolymer C2 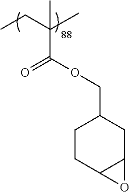 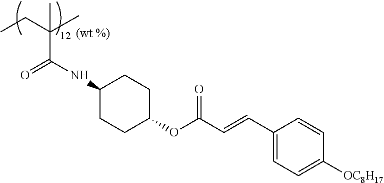
Thermal acid generator D1 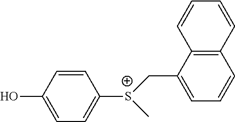 [SMILES: C[S+](Cc1cccc2ccccc12)c1ccc(O)cc1] 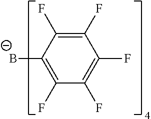
Stabilizer DIPEA

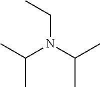

### <Preparation of Liquid Crystal Composition 1>

A liquid crystal composition 1 for forming a liquid crystal cured layer, having the following formulation, was prepared.

Liquid crystal composition 1

| | |
|---|---|
| Liquid crystal compound R1 shown below | 27.00 parts by mass |
| Liquid crystal compound R2 shown below | 20.00 parts by mass |
| Liquid crystal compound R3 shown below | 20.00 parts by mass |
| Liquid crystal compound R4 shown below | 16.50 parts by mass |
| Liquid crystal compound R5 shown below | 16.50 parts by mass |
| Liquid crystal compound R6 shown below | 15.00 parts by mass |
| Additive M1 shown below | 3.00 parts by mass |
| Polymerization initiator S1 shown below | 0.50 parts by mass |
| Leveling agent P1 shown below | 0.09 parts by mass |
| Cyclopentanone | 179.67 parts by mass |
| Methyl ethyl ketone | 53.67 parts by mass |

Liquid crystal compound R1 [Δn(450)/Δn(550): 0.58] 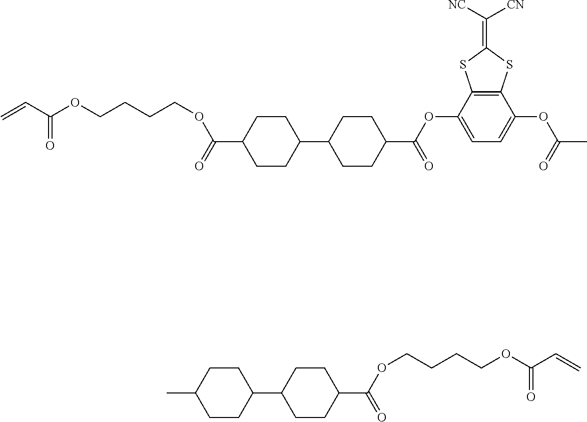
Liquid crystal compound R2 (in the following formula, t-Bu represents a tert-butyl group) [Δn(450)/Δn(550): 0.68] 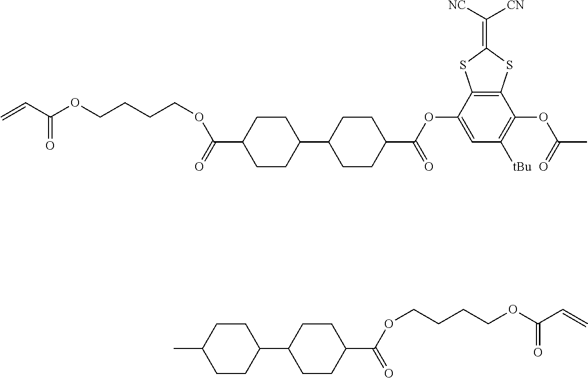
Liquid crystal compound R3 [in the following formula, a group adjacent to an acryloyloxy group represents a propylene group (a group in which a methyl group is substituted with an ethylene group)] [Δn(450)/Δn(550): 0.80] 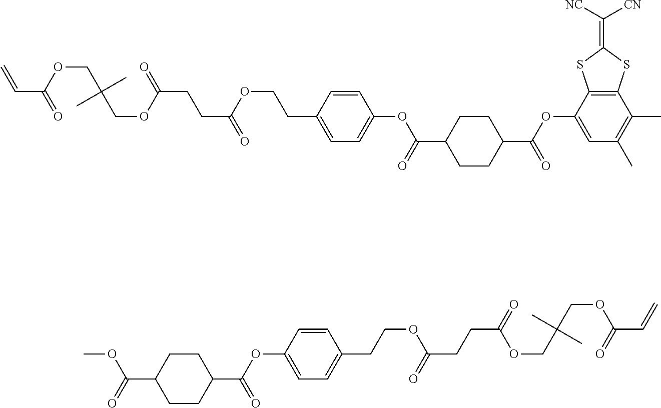
Liquid crystal compound R4 [Δn(450)/Δn(550): 1.03] 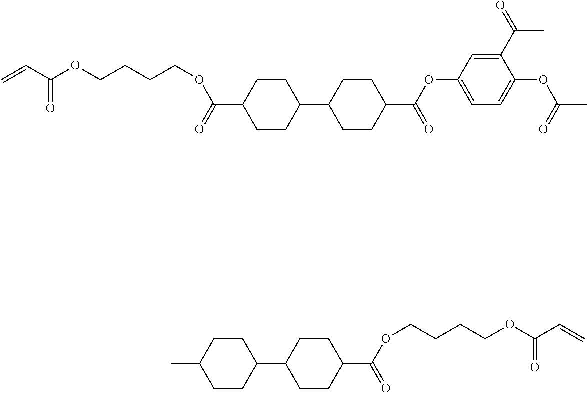
Liquid crystal compound R5 [Δn(450)/Δn(550): 1.02] 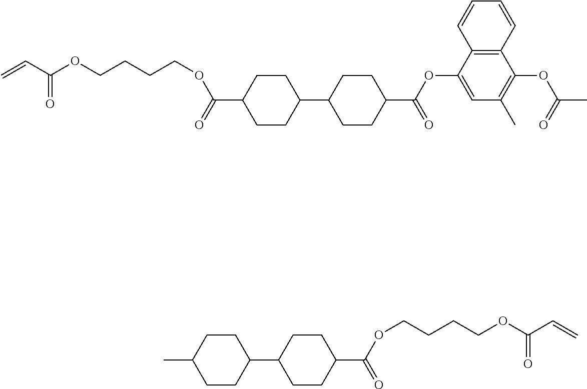
Liquid crystal compound R6 [ΔAn(450)/Δn(550): 1.03] 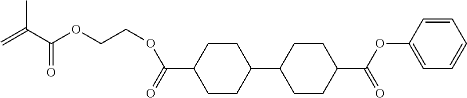 [SMILES: C=C(C)C(=O)OCCOC(=O)C1CCC(C2CCC(C(=O)Oc3ccccc3)CC2)CC1]
Additive M1 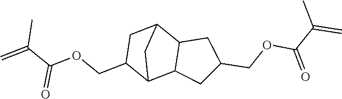 [SMILES: C=C(C)C(=O)OCC1CC2C3CC(COC(=O)C(=C)C)C(C3)C2C1]
Polymerization initiator S1

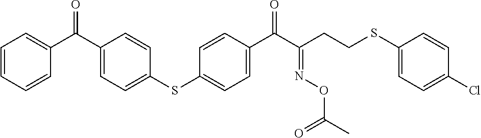 [SMILES: CC(=O)O/N=C(\CCSc1ccc(Cl)cc1)C(=O)c1ccc(Sc2ccc(C(=O)c3ccccc3)cc2)cc1]

Leveling agent P1 [the numerical value in the following formula indicates the content (% by mass) of each repeating unit with respect to all repeating units in the leveling agent P1]

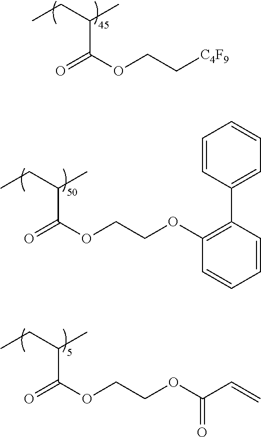

### <Production of Liquid Crystal Cured Layer 1>

The composition 1 for forming an alignment film prepared in advance was continuously applied onto one surface of the produced substrate 1 with a bar coater. After the application, the solvent was removed by drying in a heating zone at 120° C. for 1 minute to form a 0.3 μm-thick photoisomerization composition layer. Subsequently, an alignment film was formed through irradiation with polarized ultraviolet rays (10 mJ/cm², using an ultra-high pressure mercury lamp) while winding a mirror-treated backup roll.

Next, the liquid crystal composition 1 prepared in advance was applied onto the alignment film formed in a long shape with a bar coater to form a composition layer. In addition, a temperature of the coating chamber was set to 23° C. The formed composition layer was heated to 120° C. in a heating zone, and then cooled to 60° C. Thereafter, the alignment was fixed by carrying out ultraviolet irradiation (300 mJ/cm², using an ultra-high pressure mercury lamp) in a nitrogen atmosphere (oxygen concentration: 100 ppm) while maintaining the temperature, thereby forming a liquid crystal cured layer 1 having a thickness of 2.2 μm to produce an optical film.

As a result of measuring a phase difference of the obtained liquid crystal cured layer 1, an in-plane retardation Re1(550) was 121 nm, and Re1(450)/Re1(550) was 0.69.

As a result of performing X-ray diffraction measurement on the obtained liquid crystal cured layer 1 under the following device and conditions, diffracted light derived from the order of the smectic phase was confirmed.

### (Device and Conditions)

X-ray diffractometer: ATXG (for thin film structure evaluation, manufactured by Rigaku Corporation)

Cu X-ray source: 50 kV·300 mA

Soller slit: 0.45°

### Examples 2 to 8

An optical film was produced by the same method as in Example 1, except that the kind and blending amount of the copolymer contained in the composition 1 for forming an alignment film were changed to those shown in Table 1.

### Example 9

An optical film was produced by the same method as in Example 1, except that a liquid crystal composition in which the liquid crystal compounds R1 and R3 to R6 were not blended and the blending amount of the liquid crystal compound R2 was changed to 100 parts by mass was used instead of the liquid crystal composition 1.

### Examples 10 and 11

An optical film was produced by the same method as in Example 1, except that the blending amount of the solvent contained in the composition 1 for forming an alignment film was changed to that shown in Table 1.

### Example 12

An optical film was produced by the same method as in Example 1, except that a liquid crystal composition in which the liquid crystal compounds R1 to R6 were not blended and 100 parts by mass of the following liquid crystal compound R7 was blended was used instead of the liquid crystal composition 1.

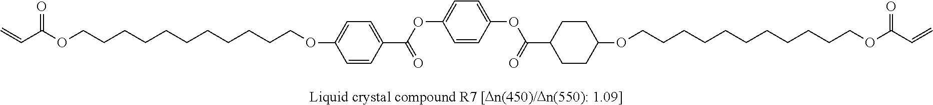 [SMILES: C=CC(=O)OCCCCCCCCCCCOc1ccc(C(=O)Oc2ccc(OC(=O)C3CCC(OCCCCCCCCCCCOC(=O)C=C)CC3)cc2)cc1]

### Example 13

An optical film was produced by the same method as in Example 1, except that a TAC film TG60 (manufactured by FUJIFILM Corporation) was used instead of the substrate 1.

### Example 14

An optical film was produced by the same method as in Example 1, except that a liquid crystal composition in which the liquid crystal compounds R1 to R6 were not blended and 100 parts by mass of the following liquid crystal compound R8 was blended was used instead of the liquid crystal composition 1.

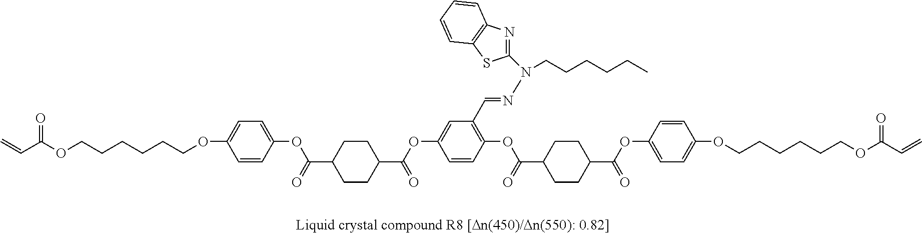 [SMILES: C=CC(=O)OCCCCCCOc1ccc(OC(=O)C2CCC(C(=O)Oc3ccc(OC(=O)C4CCC(C(=O)Oc5ccc(OCCCCCCOC(=O)C=C)cc5)CC4)c(/C=N/N(CCCCCC)c4nc5ccccc5s4)c3)CC2)cc1]

### Comparative Example 1

An optical film was produced by the same method as in Example 1, except that a TAC film TG60 (manufactured by FUJIFILM Corporation) was used instead of the substrate 1, and the blending amount of the solvent and the kind and blending amount of the copolymer contained in the composition 1 for forming an alignment film were changed to those shown in Table 1.

### Comparative Examples 2 and 3

An optical film was produced by the same method as in Example 1, except that the same film as in Comparative Example 1 of JP2014-164169A was used instead of the substrate 1, and the blending amount of the solvent and the kind and blending amount of the copolymer contained in the composition 1 for forming an alignment film were changed to those shown in Table 1.

### [Mixed Region]

A thickness of the mixed region was measured by the above-described method. The results are shown in Table 1.

### [Evaluation]

Aligning properties and adhesiveness were evaluated as follows. The results are shown in Table 1.

### [Aligning Properties]

The aligning properties were measured by installing a LED light source, a lower polarizing plate, a sample (optical film), and an upper polarizing plate in this order on a table such that each surface was horizontal. In this case, the sample and the upper polarizing plate were rotatable. Light emitted from the light source and transmitted through the lower polarizing plate, the sample, and the upper polarizing plate in this order was measured for brightness from a vertical direction using a brightness meter (BM-5A (manufactured by TOPCON Corporation)).

In the measurement, first, the upper polarizing plate was rotated in a state in which the sample was not present, and was adjusted to a position where the brightness was the darkest (crossed Nicols state). The produced optical film was inserted between the polarizing plates, and the brightness at a minimum was measured by rotating the sample under the crossed Nicols state. Next, the brightness at a maximum was measured by rotating the sample in a parallel Nicols arrangement of two polarizing plates consisting of the upper polarizing plate and the lower polarizing plate.

In order to remove contribution of brightness leakage caused by the upper polarizing plate and the lower polarizing plate, a value obtained by the following expression defined as the aligning properties of the optically anisotropic layer.

$$Aligning properties = ( 1 / ( Minimum brightness under crossed Nicols state at \\ time of sample placement ) / ( Maximum brightness \\ under parallel Nicols state at time of sample \\ placement ) - ( Minimum brightness under crossed Nicols state in which \\ sample was not present ) / ( Maximum brightness under \\ parallel Nicols state in state in which sample was not present ) )$$

### (Evaluation Standard)

A: the above-described aligning properties were 200,000 or more.

B: the above-described aligning properties were 100,000 or more and less than 200,000.

C: the above-described aligning properties were less than 100,000.

### [Adhesiveness]

A tape was attached to the liquid crystal cured layer side of the produced optical film and peeled off. At any five locations on the peeled optical film, component analysis of the outermost 5 nm layer was carried out by TOF-SIMS method, and the results were evaluated according to the following standard.

### (Evaluation Standard)

A: no detection of secondary ion component derived from substrate

B: detection of secondary ion component derived from substrate at one position

C: detection of secondary ion component derived from substrate at two or more positions

TABLE 1

| | | | | Composition for forming alignment film | | | | | | | | | | | |
|---|---|---|---|---|---|---|---|---|---|---|---|---|---|---|---|
| | | | | Solvent | | | | Copolymer | | | | Thick- | | | |
| | | | | | Addi- | | Addi- | | Addi- | | Addi- | ness | Value | Evaluation | |
| | Substrate | | | | tion | | tion | | tion | | tion | of | of | Align- | Ad- |
| | | Re | Rth | | amount | | amount | | amount | | amount | mixed | Expres- | ing | he- |
| | | (550) | (550) | | (part by | | (part by | | (part by | | (part by | region | sion | prop- | sive- |
| | Type | (nm) | (nm) | Type | mass) | Type | mass) | Type | mass) | Type | mass) | (nm) | (α) | erties | ness |
| Example 1 | Substrate 1 | 1 | −5 | Butyl | 714 | MEK | 476 | C1 | 90 | C2 | 10 | 150 | 0.30 | A | A |
| | | | | acetate | | | | | | | | | | | |
| Example 2 | Substrate 1 | 1 | −5 | Butyl | 714 | MEK | 476 | C4 | 90 | C2 | 10 | 150 | 0.30 | B | A |
| | | | | acetate | | | | | | | | | | | |
| Example 3 | Substrate 1 | 1 | −5 | Butyl | 714 | MEK | 476 | C5 | 90 | C2 | 10 | 150 | 0.30 | A | B |
| | | | | acetate | | | | | | | | | | | |
| Example 4 | Substrate 1 | 1 | −5 | Butyl | 714 | MEK | 476 | C6 | 90 | C2 | 10 | 150 | 0.30 | B | A |
| | | | | acetate | | | | | | | | | | | |
| Example 5 | | 1 | −5 | Butyl | 714 | MEK | 476 | C1 | 100 | — | — | 150 | — | B | A |
| | | | | acetate | | | | | | | | | | | |
| Example 6 | Substrate 1 | 1 | −5 | Butyl | 714 | MEK | 476 | C1 | 90 | C3 | 10 | 150 | 0.39 | B | A |
| | | | | acetate | | | | | | | | | | | |
| Example 7 | Substrate 1 | 1 | −5 | Butyl | 714 | MEK | 476 | C1 | 97 | C2 | 3 | 150 | 0.30 | A | B |
| | | | | acetate | | | | | | | | | | | |
| Example 8 | Substrate 1 | 1 | −5 | Butyl | 714 | MEK | 476 | C1 | 60 | C2 | 40 | 150 | 0.30 | B | A |
| | | | | acetate | | | | | | | | | | | |
| Example 9 | Substrate 1 | 1 | −5 | Butyl | 714 | MEK | 476 | C1 | 90 | C2 | 10 | 150 | 0.30 | B | A |
| | | | | acetate | | | | | | | | | | | |
| Example 10 | Substrate 1 | 1 | −5 | Butyl | 833 | MEK | 357 | C1 | 90 | C2 | 10 | 120 | 0.30 | A | B |
| | | | | acetate | | | | | | | | | | | |
| Example 11 | Substrate 1 | 1 | −5 | Butyl | 595 | MEK | 595 | C1 | 90 | C2 | 10 | 220 | 0.30 | B | A |
| | | | | acetate | | | | | | | | | | | |
| Example 12 | Substrate 1 | 1 | −5 | Butyl | 714 | MEK | 476 | C1 | 90 | C2 | 10 | 150 | 0.30 | B | A |
| | | | | acetate | | | | | | | | | | | |
| Example 13 | TG60 | 0 | 40 | Butyl | 714 | MEK | 476 | C1 | 90 | C2 | 10 | 150 | 0.30 | B | A |
| | (manufactured | | | acetate | | | | | | | | | | | |
| | by FUJIFILM | | | | | | | | | | | | | | |
| | Corporation) | | | | | | | | | | | | | | |
| Example 14 | Substrate 1 | 1 | −5 | Butyl | 714 | MEK | 476 | C1 | 90 | C2 | 10 | 150 | 0.30 | A | A |
| | | | | acetate | | | | | | | | | | | |
| Comparative | TG60 | 0 | 40 | Butyl | 952 | MEK | 238 | C2 | 100 | — | — | 90 | — | A | C |
| Example 1 | (manufactured | | | acetate | | | | | | | | | | | |
| | by FUJIFILM | | | | | | | | | | | | | | |
| | Corporation) | | | | | | | | | | | | | | |
| Comparative | Substrate same | 2 | −5 | Butyl | 952 | MEK | 238 | C1 | 100 | — | — | 90 | — | B | C |
| Example 2 | as Comparative | | | acetate | | | | | | | | | | | |
| | Example 1 of | | | | | | | | | | | | | | |
| | JP2014- | | | | | | | | | | | | | | |
| | 164169A | | | | | | | | | | | | | | |
| Comparative | Substrate same | 2 | −5 | Butyl | 357 | MEK | 833 | C1 | 100 | — | — | 600 | — | C | A |
| Example 3 | as Comparative | | | acetate | | | | | | | | | | | |
| | Example 1 of | | | | | | | | | | | | | | |
| | JP2014- | | | | | | | | | | | | | | |
| | 164169A | | | | | | | | | | | | | | |

The structure of the copolymer in the composition for forming an alignment film in Table 1 is shown below.

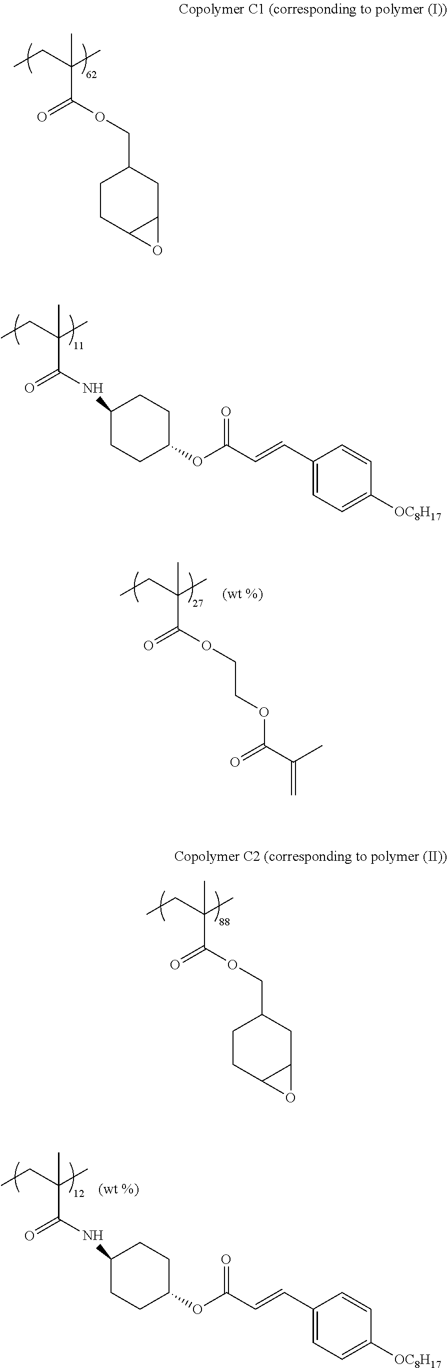

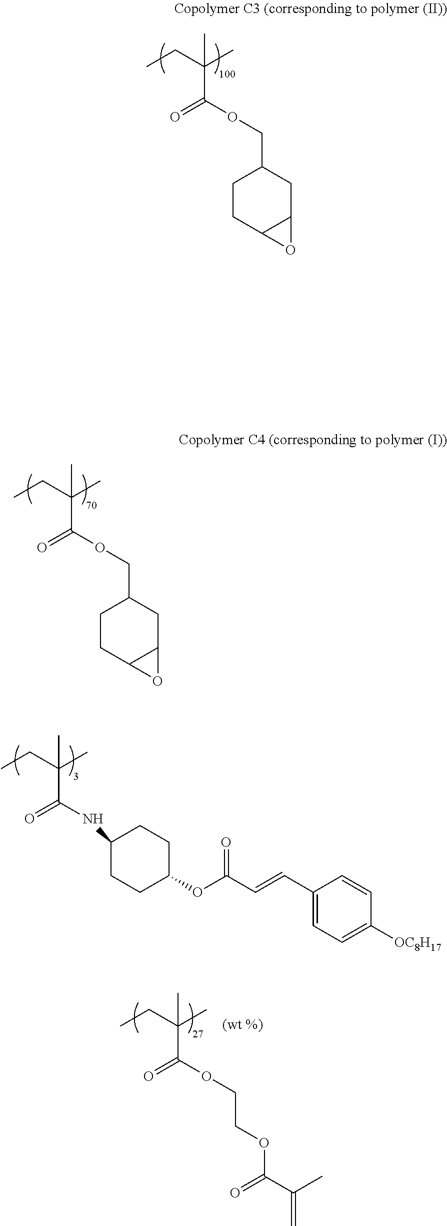

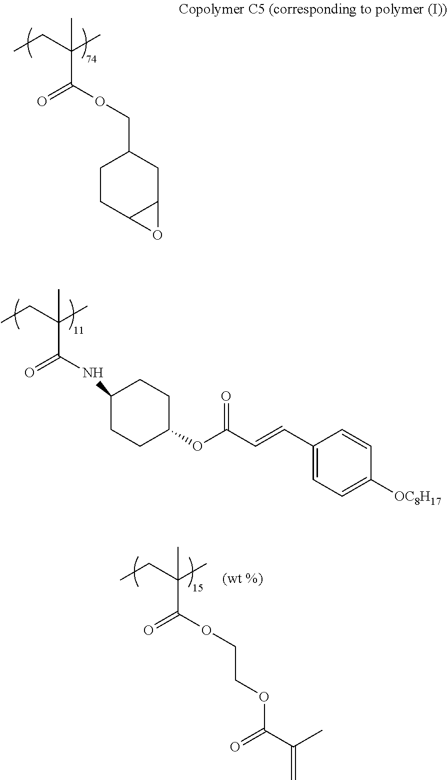

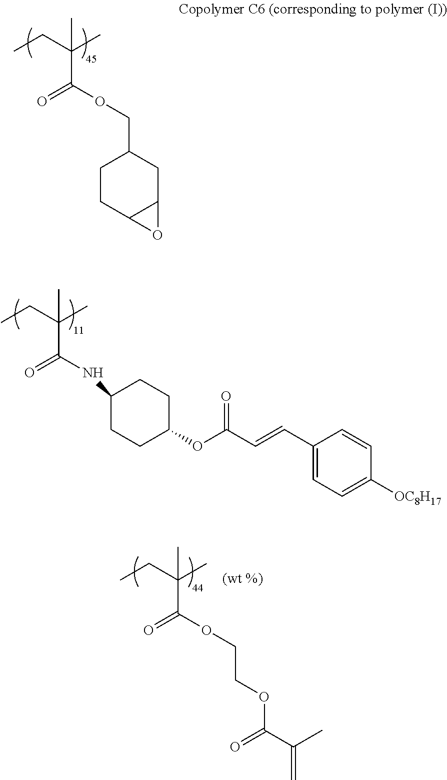

From the results shown in Table 1, it was found that, in a case where the thickness of the mixed region in the substrate was 100 nm or less, the adhesiveness between the substrate and the alignment film was deteriorated regardless of whether or not the polymer (I) was blended in the composition for forming an alignment film (Comparative Examples 1 and 2).

In addition, it was found that, in a case where the thickness of the mixed region in the substrate was 500 nm or more, the aligning properties of the liquid crystal cured layer were deteriorated even in a case where the polymer (I) was blended in the composition for forming an alignment film (Comparative Example 3).

On the other hand, it was found that, in a case where the thickness of the mixed region in the substrate was more than 100 nm and less than 500 nm and the polymer (I) was blended in the composition for forming an alignment film, the liquid crystal cured layer had excellent aligning properties and the adhesiveness between the substrate and the alignment film was favorable (Examples 1 to 14).

In particular, from the comparison of Examples 1 to 4, it was found that, in a case where the content a (% by mass) of the repeating unit A, the content b (% by mass) of the repeating unit B, and the content c (% by mass) of the repeating unit C in the polymer (I) satisfied 5≤a≤30, 20≤b≤45, and 50≤c≤75, respectively, the aligning properties of the liquid crystal cured layer were more favorable, and the adhesiveness between the substrate and the alignment film was also more favorable.

In addition, from the comparison of Examples 1 and 5, it was found that, in a case where the composition for forming an alignment film further contained the polymer (II), the aligning properties of the liquid crystal cured layer were more favorable.

In addition, from the comparison of Examples 1 and 6, it was found that, in a case where the polymer (I) and the polymer (II) satisfied Expression (α), the aligning properties of the liquid crystal cured layer were more favorable.

In addition, from the comparison of Examples 1, 7, and 8, it was found that, in a case where the content of the polymer (I) was 5% to 30% by mass with respect to the total mass of the polymer (I) and the polymer (II), the aligning properties of the liquid crystal cured layer were more favorable, and the adhesiveness between the substrate and the alignment film was also more favorable.

In addition, from the comparison of Examples 1 and 9, it was found that, in a case where the liquid crystal cured layer was a layer obtained by fixing a liquid crystalline state of a smectic phase, the aligning properties of the liquid crystal cured layer were more favorable.

In addition, from the comparison of Examples 1, 10, and 11, it was found that, in a case where the thickness of the mixed region in the substrate was more than 130 nm and less than 200 nm, the aligning properties of the liquid crystal cured layer were more favorable, and the adhesiveness between the substrate and the alignment film was also more favorable.

In addition, from the comparison of Examples 1 and 12, it was found that, in a case where the compound represented by Formula (III), in which Ar in Formula (III) represented any aromatic ring selected from the group consisting of groups represented by Formulae (Ar-1) to (Ar-5), was used as the liquid crystal compound used in the liquid crystal composition, the aligning properties of the liquid crystal cured layer were more favorable.

In addition, from the comparison of Examples 1 and 13, it was found that, in a case where the thickness-direction retardation of the substrate at a wavelength of 550 nm was more than −10 nm and less than 10 nm, the aligning properties of the liquid crystal cured layer were more favorable.

### EXPLANATION OF REFERENCES

1: substrate
2: alignment film
3: liquid crystal cured layer
4: mixed region
5: substrate region
10: optical film
d: thickness of mixed region
C1: result of secondary ion intensity derived from liquid crystal cured layer
C2: result of secondary ion intensity derived from polymer (I)
C3: result of secondary ion intensity derived from substrate

What is claimed is:

1. An optical film comprising:
a substrate;
an alignment film provided on the substrate; and
a liquid crystal cured layer provided on the alignment film,
wherein the alignment film is a photo-alignment film formed of a composition for forming an alignment film, which contains a polymer (I) having a photo-aligned group and two or more different polymerizable groups,
a mixed region containing a component derived from the polymer (I) is provided in a surface layer region of the substrate on an alignment film side, and
a thickness of the mixed region is more than 100 nm and less than 500 nm.

2. The optical film according to claim 1,
wherein the polymer (I) is a copolymer having a repeating unit A represented by Formula (A), a repeating unit B represented by Formula (B), and a repeating unit C represented by Formula (C), 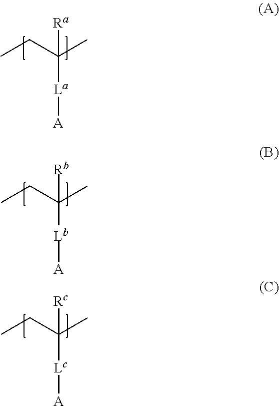
in Formulae (A) to (C),
R^{a} to R^{c} each independently represent a hydrogen atom or a substituent,
L^{a} to L^{c} each independently represent a divalent linking group,
A represents any one photo-aligned group selected from the group consisting of a polyene group, a stilbene group, a stilbazole group, a stilbazolium group, a chalcone group, a cinnamoyl group, an aromatic Schiff base, an aromatic hydrazone group, an azobenzene group, an azonaphthalene group, an aromatic heterocyclic azo group, a bisazo group, a formazan group, an azoxybenzene group, a coumarin group, and a maleimide group,
B represents any one polymerizable group represented by Formulae (PG-1) to (PG-3), and
C represents any one polymerizable group represented by Formulae (PG-4) to (PG-9), 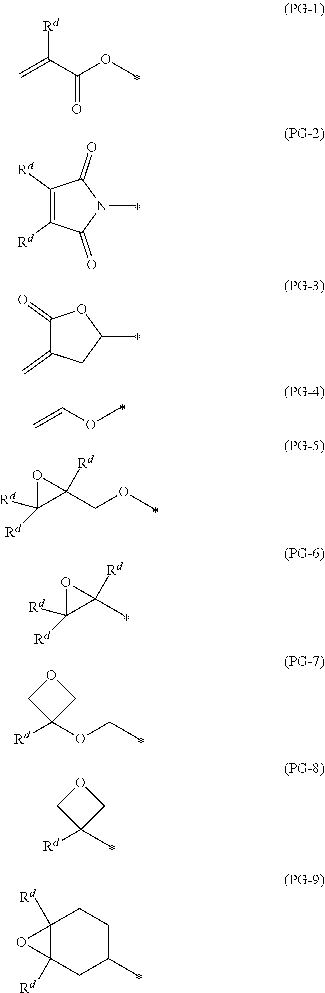
in Formulae (PG-1) to (PG-9),
* represents a bonding position to L^{b} or L^{c}, and
R^{d} represents a hydrogen atom, a halogen atom, a methyl group, an ethyl group, or a trifluoromethyl group, where a plurality of R^{d}'s in Formulae (PG-2), (PG-5), (PG-6), and (PG-9) may be the same or different from each other.

3. The optical film according to claim 2,
wherein each of a content a of the repeating unit A, a content b of the repeating unit B, and a content c of the repeating unit C with respect to a total mass of the polymer (I), in terms of % by mass, satisfies 5≤a≤30, 20≤b≤45, and 50≤c≤75.

4. The optical film according to claim 1,
wherein a content of the polymer (I) is 5% to 30% by mass with respect to a total mass of solid contents of the composition for forming an alignment film.

5. The optical film according to claim 1,
wherein the composition for forming an alignment film further contains a polymer (II) which is a polymer other than the polymer (I) and has a repeating unit B represented by Formula (B), 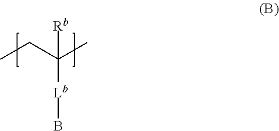
in Formula (B),
R^{b} represents a hydrogen atom or a substituent,
L^{b} represents a divalent linking group, and
B represents any one polymerizable group represented by Formulae (PG-1) to (PG-3), 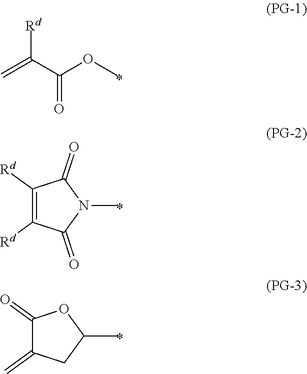
in Formulae (PG-1) to (PG-3),
* represents a bonding position to L^{b}, and
R^{d} represents a hydrogen atom, a halogen atom, a methyl group, an ethyl group, or a trifluoromethyl group, where a plurality of R^{d}'s in Formula (PG-2) may be the same or different from each other.

6. The optical film according to claim 5,
wherein, in a case where, with regard to Hansen solubility parameters in the polymer (I), a dispersion-force term is denoted by δD(I), a polarity term is denoted by δP(I), and a hydrogen-bonding term is denoted by δH(I), and with regard to Hansen solubility parameters in the polymer (II), a dispersion-force term is denoted by δD(II), a polarity term is denoted by δP(II), and a hydrogen-bonding term is denoted by δH(II), Expression (α) is satisfied,
$$\sqrt{( δ D ( I ) - δ {D ( II )}^{2} + {( δ P ( I ) - δ P ( I ) )}^{2} + {( δ H ( I ) - δ H ( II ) )}^{2}} < 0.35 . \qquad ( α )$$

7. The optical film according to claim 5,
wherein a content of the polymer (I) is 5% to 30% by mass with respect to a total mass of the polymer (I) and the polymer (II).

8. The optical film according to claim 1,
wherein the liquid crystal cured layer is a layer obtained by fixing a liquid crystalline state of a smectic phase.

9. The optical film according to claim 1,
wherein the thickness of the mixed region is more than 130 nm and less than 200 nm.

10. The optical film according to claim 1,
wherein the liquid crystal cured layer is a liquid crystal cured layer obtained by fixing an alignment state of a liquid crystal composition containing a liquid crystal compound,
the liquid crystal compound is a rod-like liquid crystal compound, and
a difference Δn in refractive index between a major axis direction and a minor axis direction of the rod-like liquid crystal compound satisfies Expression (β),
$$Δ n ( 450 ) / Δ n ( 550 ) < 1. , \qquad ( β )$$
in Expression (β), Δn(450) represents a difference in refractive index at 450 nm, and Δn(550) represents a difference in refractive index at 550 nm.

11. The optical film according to claim 1,
wherein the liquid crystal cured layer is a liquid crystal cured layer obtained by fixing an alignment state of a liquid crystal composition containing a liquid crystal compound, and
the liquid crystal compound is a compound represented by Formula (III), 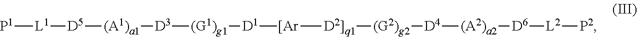
in Formula (III),
a1, a2, g1, and g2 each independently represent 0 or 1,
where at least one of a1 or g1 represents 1 and at least one of a2 or g2 represents 1,
q1 represents 1 or 2,
D¹, D², D³, D⁴, D⁵, and D⁶ each independently represent a single bond, —CO—, —O—, —S—, —C(═S)—, —CR¹R²—, —CR³—CR⁴—, —NR⁵—, or a divalent linking group consisting of a combination of two or more of these groups, where R¹ to R⁵ each independently represent a hydrogen atom, a fluorine atom, or an alkyl group having 1 to 12 carbon atoms, provided that, in a case where q1 is 2, a plurality of D²'s may be the same or different from each other,
G¹ and G² each independently represent an aromatic ring having 6 to 20 carbon atoms, which may have a substituent, or a divalent alicyclic hydrocarbon group having 5 to 20 carbon atoms, which may have a substituent, where one or more of —CH₂—'s constituting the alicyclic hydrocarbon group may be replaced with —O—, —S—, or —NH—,
A¹ and A² each independently represent an aromatic ring having 6 to 20 carbon atoms, which may have a substituent, or a divalent alicyclic hydrocarbon group having 5 to 20 carbon atoms, which may have a substituent, where one or more of —CH₂—'s constituting the alicyclic hydrocarbon group may be replaced with —O—, —S—, or —NH—,
L¹ and L² each independently represent a single bond or a divalent aliphatic hydrocarbon group having 1 to 20 carbon atoms, provided that one or more of —CH₂—'s constituting the aliphatic hydrocarbon group may be replaced with —O—, —S—, —NH—, —N(Q)-, or —CO—, Q represents a substituent,
P¹ and P² each independently represent a monovalent organic group, where at least one of P¹ or P² represents a polymerizable group, and
Ar represents an aromatic ring having 6 to 20 carbon atoms, which may have a substituent, or a divalent alicyclic hydrocarbon group having 5 to 20 carbon atoms, which may have a substituent, where one or more of —CH₂—'s constituting the alicyclic hydrocarbon group may be replaced with —O—, —S—, or —NH—, provided that, in a case where q1 is 2, a plurality of Ar's may be the same or different from each other.

12. The optical film according to claim 11,
wherein Ar in Formula (III) represents any aromatic ring selected from the group consisting of groups represented by Formulae (Ar-1) to (Ar-5), 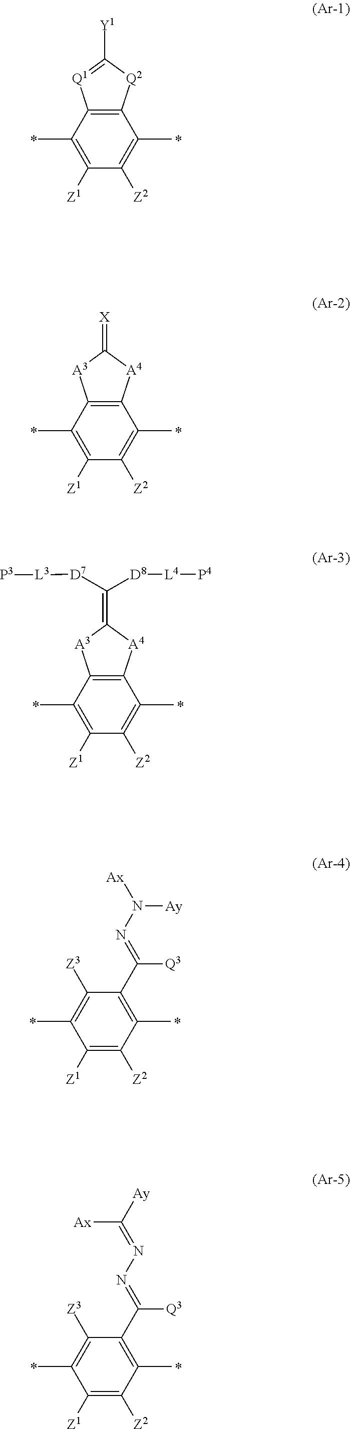
in Formulae (Ar-1) to (Ar-5),
* represents a bonding position,
Q¹ represents N or CH,
Q² represents —S—, —O—, or —N(R⁶)—, where R⁶ represents a hydrogen atom or an alkyl group having 1 to 6 carbon atoms,
Y¹ represents an aromatic hydrocarbon group having 6 to 12 carbon atoms, which may have a substituent, an aromatic heterocyclic group having 3 to 12 carbon atoms, which may have a substituent, or an alicyclic hydrocarbon group having 6 to 20 carbon atoms, which may have a substituent, where one or more of —CH₂—'s constituting the alicyclic hydrocarbon group may be replaced with —O—, —S—, or —NH—,
Z¹, Z², and Z³ each independently represent a hydrogen atom, a monovalent aliphatic hydrocarbon group having 1 to 20 carbon atoms, a monovalent alicyclic hydrocarbon group having 3 to 20 carbon atoms, a monovalent aromatic hydrocarbon group having 6 to 20 carbon atoms, a monovalent aromatic heterocyclic group having 6 to 20 carbon atoms, a halogen atom, a cyano group, a nitro group, —OR⁷, —NR⁸R⁹, —SR¹⁰, —COOR¹¹, or —COR¹², where R⁷ to R¹² each independently represent a hydrogen atom or an alkyl group having 1 to 6 carbon atoms and Z¹ and Z² may be bonded to each other to form an aromatic ring,
A³ and A⁴ each independently represent a group selected from the group consisting of —O—, —N(R¹³)—, —S—, and —CO—, where R¹³ represents a hydrogen atom or a substituent,
X represents a non-metal atom of Groups 14 to 16, where a hydrogen atom or a substituent may be bonded to the non-metal atom,
D⁷ and D⁸ each independently represent a single bond, —CO—, —O—, —S—, —C(═S)—, —CR¹R²—, —CR³═CR⁴—, —NR⁵—, or a divalent linking group consisting of a combination of two or more of these groups, where R¹ to R⁵ each independently represent a hydrogen atom, a fluorine atom, or an alkyl group having 1 to 12 carbon atoms,
L³ and L⁴ each independently represent a single bond or a divalent aliphatic hydrocarbon group having 1 to 20 carbon atoms, where one or more of —CH₂—'s constituting the aliphatic hydrocarbon group may be replaced with —O—, —S—, —NH—, —N(Q)-, or —CO—, Q represents a substituent,
P³ and P⁴ each independently represent a monovalent organic group, where at least one of P³ or P⁴ represents a polymerizable group,
Ax represents an organic group having 2 to 30 carbon atoms, which has at least one aromatic ring selected from the group consisting of an aromatic hydrocarbon ring and an aromatic heterocyclic ring,
Ay represents a hydrogen atom, an alkyl group having 1 to 12 carbon atoms, which may have a substituent, or an organic group having 2 to 30 carbon atoms, which has at least one aromatic ring selected from the group consisting of an aromatic hydrocarbon ring and an aromatic heterocyclic ring,
where the aromatic rings in Ax and Ay may have a substituent, and Ax and Ay may be bonded to each other to form a ring, and
Q³ represents a hydrogen atom or an alkyl group having 1 to 20 carbon atoms, which may have a substituent.

13. The optical film according to claim 1,
wherein a thickness-direction retardation of the substrate at a wavelength of 550 nm is more than −10 nm and less than 10 nm.

14. A polarizing plate comprising:
the optical film according to claim 1; and
a polarizer.

15. An image display device comprising:
the optical film according to claim 1.

16. The image display device according to claim 15,
wherein the image display device is a liquid crystal display device.

17. The image display device according to claim 15,
wherein the image display device is an organic EL display device.

18. The optical film according to claim 2,
wherein a content of the polymer (I) is 5% to 30% by mass with respect to a total mass of solid contents of the composition for forming an alignment film.

19. The optical film according to claim 2,
wherein the composition for forming an alignment film further contains a polymer (II) which is a polymer other than the polymer (I) and has a repeating unit B represented by Formula (B), 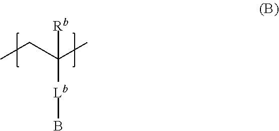
in Formula (B),
R^{b} represents a hydrogen atom or a substituent,
L^{b} represents a divalent linking group, and
B represents any one polymerizable group represented by Formulae (PG-1) to (PG-3), 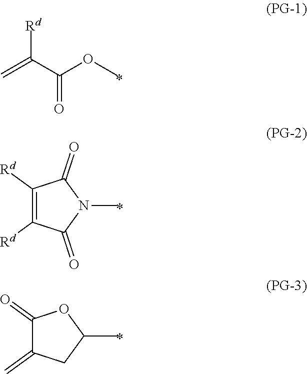
in Formulae (PG-1) to (PG-3),
* represents a bonding position to L^{b}, and
R^{d} represents a hydrogen atom, a halogen atom, a methyl group, an ethyl group, or a trifluoromethyl group, where a plurality of R^{d}'s in Formula (PG-2) may be the same or different from each other.

20. The optical film according to claim 19,
wherein, in a case where, with regard to Hansen solubility parameters in the polymer (I), a dispersion-force term is denoted by δD(I), a polarity term is denoted by δP(I), and a hydrogen-bonding term is denoted by δH(I), and with regard to Hansen solubility parameters in the polymer (II), a dispersion-force term is denoted by δD(II), a polarity term is denoted by δP(II), and a hydrogen-bonding term is denoted by δH(II), Expression (α) is satisfied,
$$\sqrt{( δ D ( I ) - δ {D ( II )}^{2} + {( δ P ( I ) - δ P ( I ) )}^{2} + {( δ H ( I ) - δ H ( II ) )}^{2}} < 0.35 . \qquad ( α )$$
